(19) United States
(12) Patent Application Publication
(10) Pub. No.: US 2002/0186144 A1
(43) Pub. Date: Dec. 12, 2002

(54) System and method for automating a vehicle rental process

(75) Inventor: Eric Meunier, Montreal (CA)

Correspondence Address: MERCHANT & GOULD PC, P.O. BOX 2903, MINNEAPOLIS, MN, 55402-0903, US

(73) Assignee: Zoop Mobility Network Inc., Montreal (CA)

(21) Appl. No.: 10/137,878

(22) Filed: May 1, 2002

(30) Foreign Application Priority Data
May 1, 2001 (CA) 2,345,857

(51) Int. Cl. H04Q 1/00

(52) U.S. Cl. 340/825.28; 340/901; 340/5.2

(57) ABSTRACT

The present invention concerns an automated vehicle rental system for a fleet of rental vehicles, where the vehicles are geographically distributed and normally locked when not rented. At least one of the vehicles, when not in use, is parked in an unguarded location. The system has a vehicle communications unit for enabling communication to and from the vehicle, user-carried electronic devices, or other readers, and for interfacing with the user. An on-board unit (OBU) is located on each of the vehicles for interfacing with the vehicle communications unit, and with a door unlocking mechanism. The system further has a central reservations, management and location system (CRMLS) in communication through a communications network with each OBU, the CRMLS performing all reservations and management functions, and being linked to a database containing a location and availability of each of thr vehicles and a rate for rental, the CRMLS also being provided with an allocation manager system for geographically allocating vehicles. In order to access the vehicle, the system also includes a key being borne by the user. The system minimizes the human intervention in the rental process, and is more user-friendly.

### 2. FIELD OF THE INVENTION

The present invention relates to the field of telematics systems applied to the movement of goods and people. More particularly, it relates to the automation of the vehicle rental process within a wide mobility network.

### 3. BACKGROUND OF THE INVENTION

From as far back as 1967 (GB 1208791), efforts have been made to automate the vehicle rental activity usually with an intent to provide better service, improve productivity and favor the emergence of new forms of urban mobility. However, the process of renting a vehicle from start to finish is relatively complex by nature: it involves assets of high value, complex behaviors on the part of users and significant safety or security issues. All of these factors contribute to the difficulty of automating the entire vehicle rental process reliably.

New Expectations for Vehicle Rental Consumers and Governments

Despite of these difficulties, users have shown a need to access vehicle rental services around the clock and in an ever-increasing number of locations throughout the world while hoping to encounter as little language barriers or service incompatibility as possible in the process. Users have also expressed a desire to come in and out of vehicle rental systems swiftly, effortlessly and often with little or no advance reservation. Furthermore, users have shown a growing need to access and return their rental vehicles closer to their community, workplace, transportation network or final destination; often wanting to drop-off vehicles in a different place than their departure point.

As a consequence, users are now expecting to rent vehicles almost on a daily basis but for very short periods of time or very short distances and to pay only for those hours of actual usage and/or actual traveled distances. Understandably, users of such short-term rental systems do not want to be burdened with time consuming refueling procedures every single time they rent a vehicle. Many users also look for ways to permanently free themselves from the costs and inconveniences that come with continuous ownership or leasing of private vehicles as the rise of carsharing clubs demonstrates.

Some users are looking at frequent and on-demand short-term rentals as an alternative to provide for their everyday mobility needs. This signals a departure from the prevalent mobility pattern exclusively centered on privately owned vehicles. Indeed, it is hoped that a new mobility model would enable the traveling public to combine more freely the various transportation modes during a single journey and to reduce the hassles related to parking and protecting vehicles when they are not in use. Users would then also be free to adapt the size or type of vehicle according to their travel and cargo needs through such emerging forms of individualized public transport.

Communities and governments have generally been very supportive of such emerging modes of vehicle rental—often called carsharing—because they can significantly reduce the impact of private vehicles on traffic congestion, the environment and transport infrastructures. Ultimately, widely available low-emission rental vehicles are considered by some as a means to encourage the combined use of public and private transportation, improve air quality, reduce parking space requirements and influence urbanization.

New Challenges for Providers of Rental Vehicles

However, from the vehicle rental service provider' point of view, the possibility of responding to this type of mobility revolution has been limited by several factors. Firstly, this form of vehicle rental generates shorter rental periods, the consequence of which are less revenue and higher transactional costs per contract. Furthermore, many locations where a need for service is currently expressed cannot be supported economically with the current art because of the combined requirements in manpower, occupancy and capital expenditures being disproportionate with the anticipated volume of activity. On-request urban mobility can also imply numerous widely dispersed service locations and unbalanced flows between those due to an increase in one-way itineraries. One-way itineraries are especially difficult to accommodate for service providers who do not have a service location at the desired destination or if vehicles from different service providers get mixed into the same fleet, a common occurrence within the road vehicle rental industry for instance.

Partial solutions to these difficulties have been proposed throughout the years and in particular with the advancement of telematics. For example, U.S. Pat. No. 6,006,148 proposes a method to accelerate the part of the rental process when a vehicle is returned. However valuable, such systems only apply to a relatively minor portion of the entire vehicle rental process and they are generally not designed to radically alter the cost structure or method in which vehicles are rented today.

Other more systemic solutions have proposed systems that rely on significant in-vehicle monitoring apparatuses. Although such methods can theoretically provide accurate measurements, it is believed that a high level of in-vehicle customization has discouraged the market acceptance of some systems.

In fact, it can generally be said that the prior art which relies on numerous in-vehicle sensors and customized circuitry to gather the necessary information to process a rental transaction poses significant difficulties for the majority of service providers. Indeed, the world's leading vehicle rental service providers typically hold their vehicles for less than a year. Thus, they are constantly buying and selling vehicles in order to adjust to user demand and to properly manage the quality and value of their fleet. Therefore, systems that require a great amount of cabling, calibration and skill to install generate unacceptable costs and delays to the majority of service providers. Furthermore, it is common for vehicle manufacturers to void their warranty if the electrical wiring within a vehicle has been tampered with, thus causing additional risks for the rental vehicles providers that use cabled systems.

Meanwhile, other solutions that have been proposed require people to radically alter their mobility habits. Some solutions also rely on an idealistic behavior of system users. These systems are attractive from a conceptual point of view but experts in transportation studies and many years of trial have amply documented the fact that most private vehicle users are reluctant to voluntarily trade off a fraction of their personal freedom in exchange for an improved collective transportation system.

It is also well known that within the vehicle rental industry hired vehicles are frequently subjected to abusive, negligent or criminal behaviors. Consequently, service providers have been reluctant to adopt systems that fail to properly address the liability, regulatory, security and safety issues associated with the vehicle rental process. For instance, some carsharing organizations have honor-based systems whereby the ignition keys for several road vehicles can be accessed at once by any of a multitude of registered members. It is a concern that within such systems, an act of theft, negligence or an equipment malfunction could have grave consequences. As a matter of fact, an increase in the level of security measures and legislation targeted at the vehicle rental activity has become noticeable over the past decade. As an example, some service providers are now installing remote tracking devices in their fleet to locate abandoned or stolen vehicles. Also, several legislatures are now requiring service providers to hold operating permits and follow mandatory procedures to reduce the risk of rental vehicles being used improperly.

It is also known in the road vehicle rental industry that a significant proportion of users do not report nor assume the notices for traffic violations that they receive. This in turn, results in a complicated and unaccountable rapport between vehicle rental service providers, users and the traffic violations issuing bodies.

It is also known within the vehicle rental industry that some users make reservations for a rental vehicle and fail to cancel them when their plans change or do not materialize. Often, some users also fail to bring rental vehicles back on due time. Additionally, it is generally believed that a minority of users causes the majority of damages on rental vehicles.

In all those cases, very significant costs are added to the vehicle rental activity because of many users' behavior being less than ideal. Particularly, the impact of unreliable reservations is exacerbated in short term rental systems since the same vehicle is scheduled to be rented out several times a day and since each different user is dependent on the adherence to the reservation schedule of all prior users on that day. In fact, it is very difficult for a vehicle rental service provider to accommodate such user behaviors with the prior art without being forced to reduce the utilization rates of its fleet, which in turns threatens the economic viability of short-term rental systems.

With the current art, most service providers also have no reliable method to encourage good behavior on the part of users apart from creating lists of unwanted users or charging penalties for lost revenue and damages at the risk of a dispute. This creates a difficult balancing act between fleet protection or utilization objectives and good customer service, the consequences of which are lower utilization rates or overbooking risks as well as higher costs in fleet maintenance and/or damage recovery disputes.

It is also known in the vehicle rental industry that last minute changes are often made with regards to the class of vehicle that users will actually get compared to the class of vehicle that was reserved; this is particularly the case in the road vehicle rental market. Sometimes, such change is encouraged by the service provider to obtain more revenue on upgraded rental vehicle classes or to compensate for a shortage in one class of vehicles against another. On other occasions, users request such change to accommodate revised travel and cargo needs or as a result of a preference for a particular vehicle model. This apparently simple operation is quite difficult to automate and has so far eluded the efforts of known prior art automated systems.

Some other telematics systems have also combined alternative energy management with automated vehicle rental. For example, some early patents call for a vehicle rental system that requires a dedicated infrastructure for electrical battery powered vehicles. However desirable from an environmental point of view, such systems are incompatible with already deployed distribution networks of vehicle energy, i.e. mostly petroleum fuel stations. Therefore, such exclusive systems are exposed to significant acceptance delays because they are unsuited for the vast majority of road vehicles currently available and require very large infrastructure investments in new energy distribution networks.

Many systems also require users to pay for fuel or energy refills by themselves, to take note of such expenses, then present physical receipts and further request a credit for the unused portion of fuel or other energy. Yet, other systems require users to always fill up the vehicle with energy before returning it. However simple and inexpensive from a technology standpoint, such systems reduce the freedom, speed and efficiency of the rental experience for a user, they create substantial opportunities for unaccountable mistakes, neglect or fraud and add a significant administrative or control workload for users, service providers and third parties. It is also known that most telematics systems will be subject during the course of their useful life to some form or another of network or connectivity problem, unauthorized system tampering, obsolescence, incompatibility or other forms of process-critical issue. It is also known that real time communications between central systems and vehicles can generate significant telecommunications costs and be subject to radio-frequency interference and bandwidth or geographical limitations. For these reasons, some prior art systems that have relied exclusively on centralized information structures and intensive real-time data transfers between vehicles and base for their core operations have experienced important difficulties in actual deployment.

Service providers have also noted that while users appreciate methods to improve the efficiency of their vehicle rental experience, they can also become uncomfortable if the human contact is entirely lost in the process, especially when unexpected problems arise. Users also have a tendency to prefer simple technologies that can be used across several service providers, makes of vehicles and transportation networks. Difficult situations have arisen in the past with some automated vehicle rental systems that did not sufficiently take into account such human behaviors and preferences.

Many prior unmanned vehicle rental systems also have no fully automated reservation methods. Yet, others use reservation systems that are not fully integrated with the actual physical moving assets; a situation which requires additional human iterations to match vehicles and which cannot provide an absolutely certain confirmation that the theoretical fleet count matches the true physical count at a given location. Others also use an automated reservation method that simply matches a reservation with a specific vehicle, indicating an available vehicle with a green light, a reserved one with a yellow light and unavailable vehicles with a red light for example. In some cases, users may have to walk from one vehicle to another in a trial and error manner or must deal with yet another equipment, such as a parking lot computer terminal or a key delivery mechanism to find a free vehicle and match it with its parked location. It is also common for many prior art systems to require users to report the parked location of a vehicle upon return, adding further delays and opportunities for errors to the rental experience. While it can be said that such systems are sufficient in locations with only a few vehicles; it is abundantly clear that they become almost impossible to administer in large rental locations where a great number of diverse vehicles are present. For example, if a user enters an unmanned location where 200 randomly parked vehicles are simultaneously present and if 199 of those vehicles are already reserved, it may become extremely frustrating to find the one available vehicle within the fleet.

Furthermore, it has been noted that most users feel isolated and uncertain while attempting to gain automated access to vehicles on unmanned premises. In fact, there is typically little information or no information communicated from vehicles to users while users are standing outside a vehicle and awaiting access during the initial period of the rental process.

In some cases, users are left wondering during several seconds if their access requests has been received, denied or is in the process of being treated while standing outside a vehicle. Such situation can lead users to abandon a first vehicle while their access request is still being processed and to try accessing another vehicle. Additionally, there has been no reliable method for users to determine with certitude which vehicles actually correspond to the class of vehicle that they have reserved when entering an unmanned rental location with a multitude of randomly-parked vehicles of various sizes and features. For example in the road vehicle rental industry, the difference between a sub-compact car and a compact car may not be obvious to the average user, causing uncertainty, delays and possible misunderstandings in the process.

It is also common for consumers and vehicle rental service providers to rely on a variety of worldwide, national or local automated information networks to generate or facilitate transactions between themselves. Examples of those public and private automated information networks are provided by Internet travel portals or corporate websites, travel agent networks or global distribution systems (GDS), central reservations systems (CRS), vehicle maintenance or sales networks, insurance claims processing or mass transit traveler information systems. It is also known that many public records such as motor vehicle registers are gradually becoming remotely accessible by way of computers. Prior art systems that do not provide for a sufficient interface with the above-mentioned networks are in effect disconnecting vehicle rental service providers from established information networks that are already responsible for processing billions of reservations and information updates annually.

It is also known that the United States of America Government has announced that it will not interfere anymore with the Global Positioning System (GPS) signal emitted by its satellites, a decision which results in a significant improvement of the accuracy of the GPS measures. It is also known that vehicle and telecommunication equipment manufacturers have begun developing standards such as IDB, Bluetooth, LIN, Most and AMI-C that will bring about compatibility between various equipment on board vehicles regardless of their makes or functions.

It is also known that people who rent cars frequently need directions, up-to-date information on traffic conditions and are also big consumers of tourism and telecommunication-related services. Furthermore, it is time consuming and rather inefficient for rental vehicle providers to administer the distribution of information that is not directly relevant to the actual rental process.

It is also known that some of the vehicle rental automation solutions currently offered to the public require users to hold a wide variety of cards, club memberships and personal electronic devices that are subject to added costs, theft, losses and delays.

It is also a fact that a large proportion of users do not read the actual detailed rental agreements before signing it and accumulate a fair amount of documents, receipts and contracts through the rental process, most of which ending up as waste.

Thus what is needed is an integrated, universal and reliable automated vehicle rental system which can optimize the entire vehicle rental process; which is easily understandable and accessible by users; which encourages responsible behaviors and yet is not over-dependent on new infrastructure or in-vehicle investments.

### 4. SUMMARY OF THE INVENTION

It is therefore a main object of the present invention to bring together logical intellectual processes and practical means to enable the entire rental process to take place easily between users, vehicle rental service providers and third parties in less time, with less cost and more reliability. Third parties may include other transportation, travel, vehicle rental or information networks, regulatory entities, credit or payment facilitators or any regular participant in the vehicle rental activity.

It is an advantage of the present invention in that it eliminates much of the labor costs and delays throughout the entire vehicle rental process in 3 ways:

1) by removing the need for some tasks to be performed,

2) by delegating some tasks to unmanned systems and

3) by delegating other tasks onto users.

Especially, it enables the delegation of those tasks within the rental process that typically do not require human judgement, fail to motivate human operators, cause delays or abrupt workload fluctuations, are repetitive, are prone to error or more efficiently performed by information systems or users themselves. Therefore, it is an advantage of the invention in that it provides access to rental vehicles almost instantaneously, 24 hours a day, 7 days a week and in an economically viable manner for even the briefest of rental periods.

It is also an advantage of the present invention in that it eliminates much of the occupancy costs and infrastructure investments currently required to hold a vehicle rental activity such as on-site customer service facilities, expensive retail space, fenced lots, key delivery areas and so on. Therefore, it is an advantage of the present invention in that it lowers the threshold at which a rental location is economically viable and enables service providers to bring rental vehicles much closer to users in more numerous, smaller and widely dispersed locations.

It is also an advantage of the present invention in that it enables an automated vehicle rental process to be held in a legally compliant, financially secure and insurable manner whereby all parties are protected from the most common forms of abusive, negligent or criminal behaviors.

It is also an advantage of the present invention in that it provides users with a quasi-instantaneous method to reserve, enter and exit a rental vehicle without the need for physical document manipulation, yet, still creating a legally binding rental agreement. It is also an advantage of the invention in that it provides users with clear and universal means to quickly identify available vehicles, understand the status of their vehicle access requests and identify those vehicles that belong to their preferred vehicle class. Additionally, the invention eliminates the need for vehicle allocation systems such as key delivery mechanisms and parking coordination methods to be put in place at rental locations.

It is an advantage of the present invention in that it does not require intensive and customized in-vehicle circuitry to derive its information on the traveled distance, energy consumption and vehicle behavior. Therefore, it is an advantage of the present invention in that it can be installed into a vehicle or transferred from one vehicle to another in little time and at minimal cost.

It is also an advantage of the present invention in that it provides users and vehicle rental service providers with the ability to compatibly exchange information with third party systems such as departments of motor vehicles, travel networks, credit organizations and others.

It is also an advantage of the present invention in that it delegates to users the task of refueling vehicles on an accountable and effortless basis. In particular, the invention can be used in most forms or makes of terrestrial, naval or airborne vehicles regardless of their energy source.

It is also an advantage of the present invention in that it enables the use of one single means to identify the user, access the vehicle and pay for the fuel or energy refills in rental vehicles. Moreover, the invention eliminates the risk of error or loss as well as the additional workload that come with manual handling of receipts for energy expenses made by users.

It is also an advantage of the invention in that it considerably speeds up, documents and prioritizes the dispatching of field or repair technicians as well as the subsequent treatment of vehicle problems and insurance claims.

It is also an advantage of the present invention in that it delegates the responsibility of summary vehicle inspection to the user and provides for a clear transfer of responsibility between the vehicle rental service provider and the user.

It is also an advantage of the present invention in that traffic fines are matched automatically with responsible users, documented and collected in an automated and defensible manner.

It is an advantage of the invention in that it adapts automatically to the language of the user in most circumstances and applications, providing added comfort and safety throughout the rental process.

It is also an advantage of the invention in that it provides for the rapid detection, tracking and resolution of problems that may have arisen with a particular user, vehicle or rental operation. The invention also enables service providers and users to efficiently communicate with each other in a multilingual and documented manner to resolve complaints or problems.

It is also an advantage of the present invention in that it recognizes the existence of imperfect user behavior and provides users with incentives to act responsibly and disincentives to act fraudulently or irresponsibly.

It is also an advantage of the present invention in that it provides users and vehicle rental service providers with the incentive and control means to balance vehicle inventories between distant locations.

It is also an advantage of the present invention in that it enables rental vehicles with different ownership or coming from different but compatible rental systems to mix freely within a same location as a result of one-way rental itineraries. Yet, this apparent chaos is conducted in a highly organized, legally-compliant and accountable manner with each moving asset carefully controlled and maintained throughout its migration outside its original zone of service.

It is also an advantage of the present invention in that it provides users and vehicle rental service providers with the means for last minute changes in reserved vehicle class without human intervention.

It is also an advantage of the present invention in that it enables complex telematics operations and remote software updates as well as vehicle-reservations to be conducted in a less expensive, more reliable and priority sensitive manner.

It is an advantage of the invention in that it provides rental vehicle providers with the ability to monitor the condition of use of their vehicles and especially, to detect risky behaviors such as speeding.

It is an advantage of the invention in that it eases and automates the process of finding parking spaces for rental vehicles as they travel to and from rental locations.

It is also an advantage of the present invention in that each vehicle's on-board unit has substantial autonomy over its telematics network, providing the vehicle rental process with an increased reliability and effectively shielding the user from the most common forms of network failures.

It is also an advantage of the present invention in that a remote service provider's operator can take over the vehicle on-board processor when it is located within range and in case of unexpected circumstances.

In accordance with the invention, these and other objects are achieved with an automated vehicle rental system for a fleet of rental vehicles, said vehicles being geographically distributed, each of said vehicles being normally locked when not rented, at least one of said vehicles, when not in use, being parked in an unguarded location; said system comprising:

vehicle communications means for enabling communication to and from the vehicle, user-carried electronic devices, or other readers, and for interfacing with said user;

an on-board unit (OBU) located on each of said vehicles for interfacing with said vehicle communications, and with a door unlocking mechanism;

a central reservations, management and location system (CRMLS) in communication through a communications network with each of said OBU, said CRMLS performing all reservations and management functions, said CRMLS being linked to a database containing a location and availability of each of said vehicles and a rate for rental, said CRMLS also being provided with an allocation manager system for geographically allocating vehicles; and

a key for accessing said vehicle, said key being borne by said user.

### 5. BRIEF DESCRIPTION OF THE DRAWINGS

The present invention and its advantages will be more easily understood after reading the following non-restrictive description of preferred embodiments thereof, made with reference to the following drawings in which:

FIG. 1 is a schematic view of the major components of a system according to a preferred embodiment of the present invention;

FIG. 2 is a schematic representation of the access control means for accessing a vehicle according a preferred embodiment of the invention;

FIG. 3 shows the vehicle communications module and a variety of screen shots of interaction with a user;

FIG. 4 is a schematic representation of the data flow when a user approaches a vehicle;

FIGS. 5A and 5B are schematic representations of the system architecture according to a preferred embodiment of the invention;

FIG. 6A is a flow-chart of updating of information regarding rental location;

FIG. 6B shows the process when reversing the availability status of a vehicle class;

FIG. 7A is a view of an interface device for a field technician;

FIG. 7B is the variety of interface view for the field technician;

FIGS. 8A and 8B are flow-charts of the registration process;

FIGS. 9A and 9B are flow-charts for reservations process for unregistered users;

FIGS. 10A and 10B are flow-charts of obtaining availability and rates for a user;

FIGS. 11A, 11B and 11C are flow-charts of operational processes according to the present invention;

FIGS. 12A and 12B are flow-charts of a rental fleet monitoring process;

FIGS. 13A, 13B, 13C, 13D and 13E are flow-charts for billing and other transactions;

FIGS. 14A, 14B and 14C are flow-charts for in-vehicle dialogues;

FIGS. 15A and 15B are flow-charts of processes while the vehicle is in use;

FIG. 16A is a graph showing an intra-day forecast of inventory fluctuations in a 3-station location group with a total combined fleet of 50 vehicles; and

FIGS. 16B and 16C are flow-charts for a vehicle inventory control;

FIGS. 17A and 17B are flow-charts illustrating responses to special events;

FIGS. 18A, 18B and 18C are flow-charts for energy management;

FIG. 18D is a flow-chart for storage management; and

FIGS. 19A, 19B, 19C and 19D are flow-charts for fleet and parking management.

### 6. DESCRIPTION OF THE PREFERRED EMBODIMENTS

The invention is mostly related to the backbone process management of the rental activity and to some particularly avant-garde embodiments. Due to varying levels of technology acceptance, crime rates and communication capabilities throughout the world, the invention is meant to be used across various platforms and through a variety of embodiments in order to reach all users in any vehicle. In the text that follows, the invention is described using mostly road vehicles in areas with good cellular radio coverage and average crime prevalence.

6.1 Main Components and Enabling Conditions

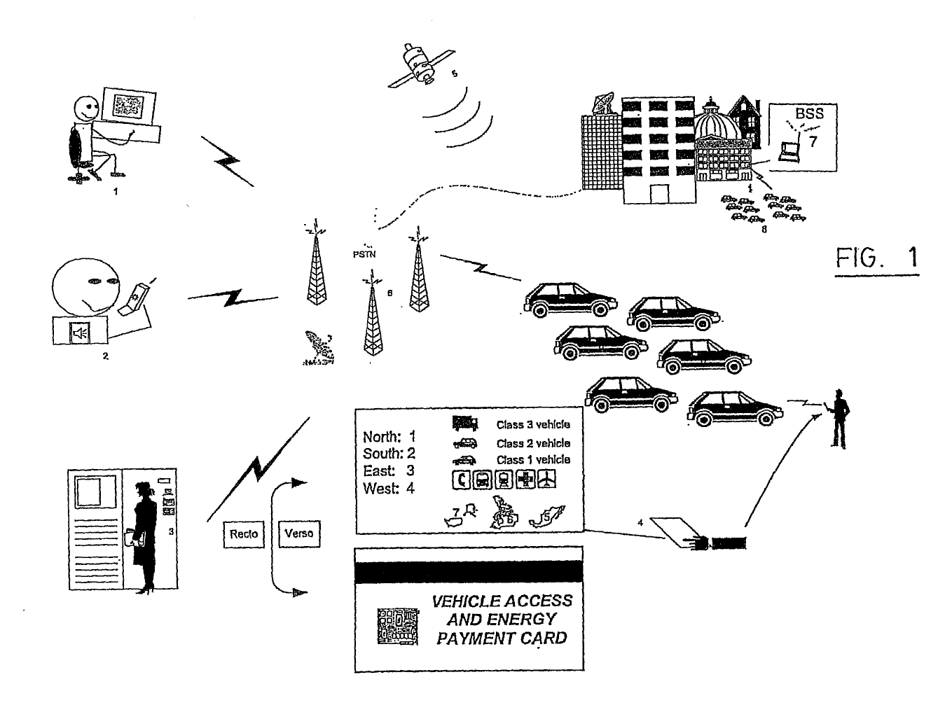

6.1.1 Enabling Conditions for the User (FIG. 1)

As will become clear further on, the following means are not vitally essential but should preferably be available to users in order to enjoy the full functionality of the invention:

Access to the Internet (1) (2) or to a dedicated computer terminal installed by a vehicle rental service provider (3) or some other similar form of data communication means.

An information card or a sticker, for example on the reverse of an access card (4) to explain the meaning of the various pictograms to users and in their language of choice.

Regular access to a telephone (2) to perform the most common reservations.

Credit card, debit card or any other forms of instantly verifiable means to establish a user's credit worthiness.

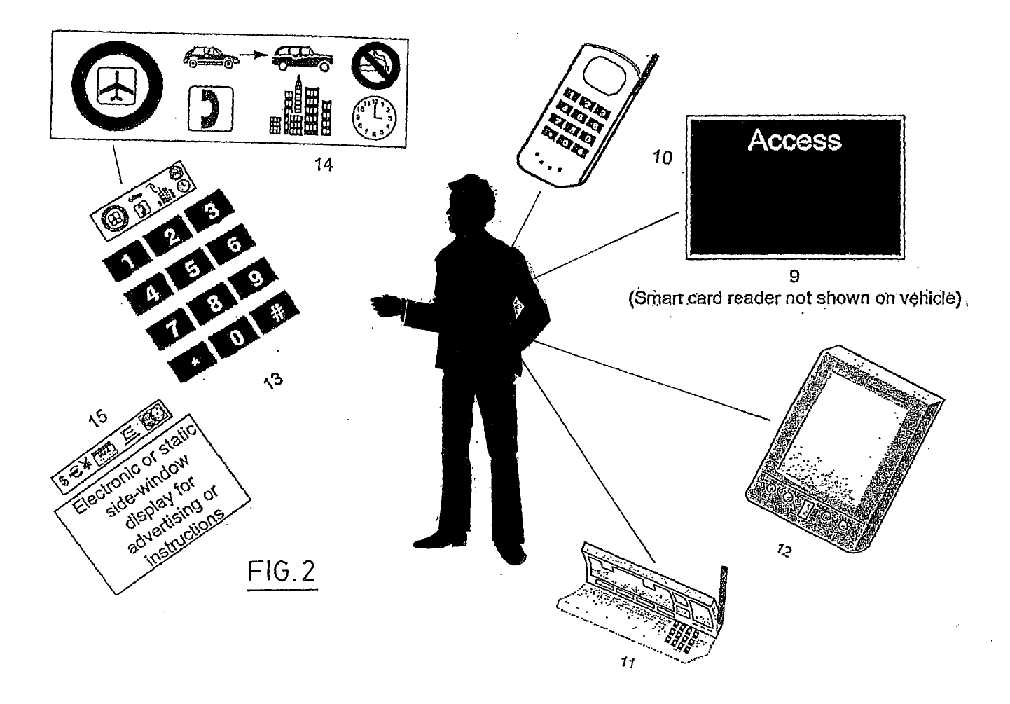

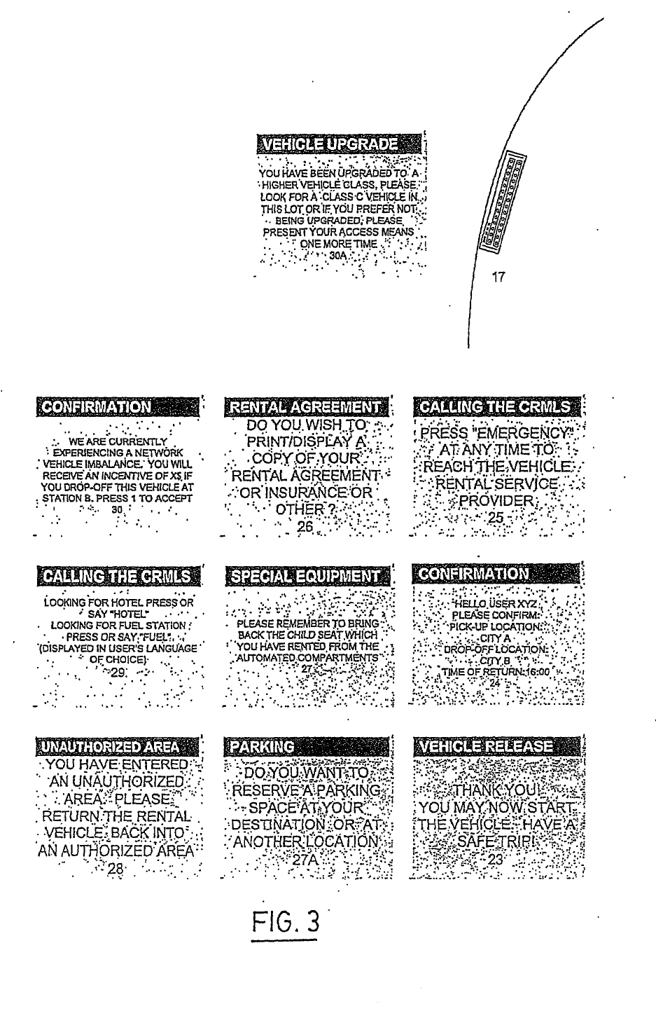

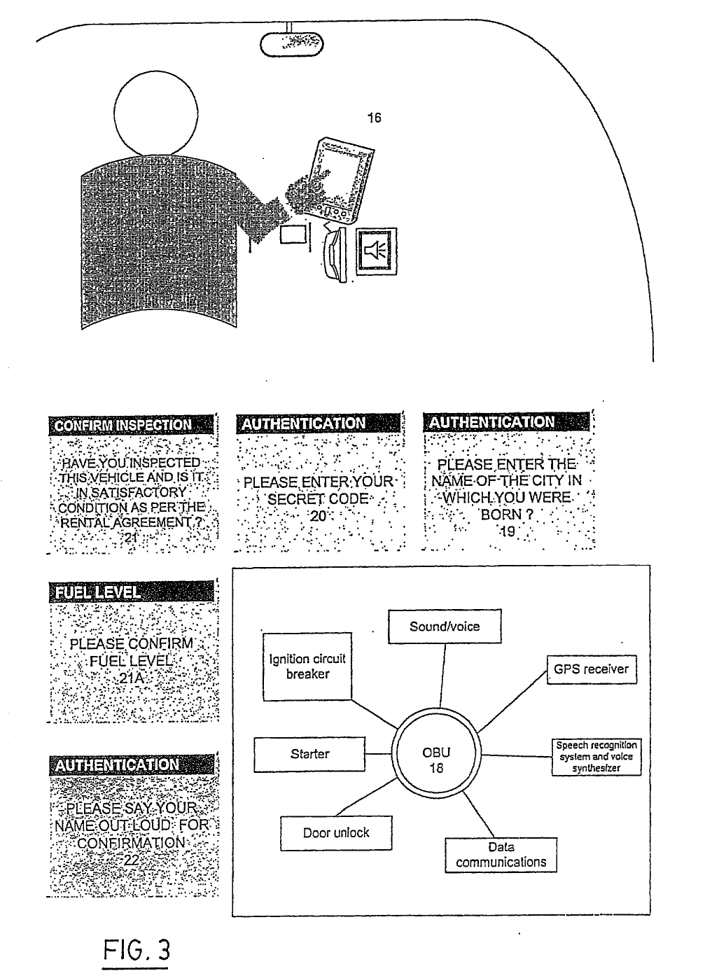

6.1.2 Access Control Means (FIG. 2)

Vehicles must be locked to deter unauthorized access. In the preferred embodiments of the invention, any one of the following user-carried means can be used to gain access to vehicles for hire:

An electronic microchip equipped card, often called smart card (4)(9), or any similar small personal electronic means that the user carries with him and where information such as secret code, names, allowed credit and preferred language or programs are stored and can be retrieved by a smart card reader or comparable apparatus. Such smart card means would typically be issued to a new user upon registration specifically for the vehicle rental activity or in other cases it may already be in the possession of a user after being issued, for example by a public transit or credit provider.

In a preferred embodiment, such smart card is contact-less and does not require any physical contact to be read by the card reader. In one preferred embodiment, said smart card is also used to perform other functions such as purchasing fuel for rental vehicles and in such case, the said smart card may also feature contact points or a magnetic stripe to be compatible with existing retail card reading devices (4).

A mobile phone (10), an Internet-enabled mobile phone and any similar or hybrid personal communication device (11).

An internet-enabled personal digital assistant (PDA) (12) or any similar computing device with personal wireless-communication capabilities.

In a preferred embodiment where personal electronic means may not be desired or compatible or widely available, the following means can be used to access vehicles for hire without the need for user-carried personal electronic means:

A numerical or alphanumerical keyboard may be affixed to a vehicle or to the inside of a vehicle window in a clearly visible manner and in a way that a user can enter an alphanumerical combination by simply touching or activating the relevant keys from the outside (13). Said keyboard being connected to the system in a wired or wireless manner to be explained further.

Other digital or access control means where users need not carry any personal electronic means may also be used such as fingerprint, signature, or voice recognition as well as other biometrics recognition means for special high security applications such as granting access to a restricted vehicle.

6.1.3 Vehicle Communications and Positioning Means

As will be described further in the preferred embodiments, all vehicles should be equipped with one or several of the following equipment or system to enable communications to and from the vehicle as well as to acquire the relevant signals from the available positioning systems or from user-carried electronic devices:

In-vehicle data/voice telecommunication system ideally equipped for hands free operation and linked to the vehicle positioning system in order to provide geographic location while communicating.

Software to enable and control the optional use of said data/voice telecommunication system by users wanting to rent it for their own use.

RF modem if required or infrared device.

On board display, side-window-display (15) and keyboard or so-called touch-screen (16) display for user and the service provider to exchange graphic and text information.

Electronic antenna (smart card reader) (17) to generate and read the data signal from embedded-chip contact less cards (smart cards).

Transponder or Dedicated short range communication device (DSRC) (31)

Antenna (33) and receiver system to acquire and treat the signal emitted by space-borne global positioning systems (5) such as the American Government's Global Positioning System (GPS) or from other sources such as mobile radio communication networks (6).

6.1.4 In-vehicle Equipment for Electrical, Physical and Control Operations

As mentioned earlier, the invention relies on as little cabling and customized circuitry as possible in its simpler forms and can be installed in a wide variety of applications and vehicles. In its preferred embodiments for road vehicles, it has no physical customized cabling for outputs our inputs to and from the vehicle in order to enable vehicle rental service providers to quickly transfer the devices from one vehicle to another. However, the following is a list of various components that may be required:

On-board unit or OBU (35). This is the central processing unit inside the vehicle. It captures and retrieves all information from the vehicle, the user or the network, processes it and delivers it to the appropriate device, platform or communication channel. In one embodiment, this OBU is installed as an after market component and takes its power from a readily accessible electrical source in the vehicle such as the lighter housing connection. In another embodiment, this OBU comes with the vehicle as original equipment by the manufacturer (OEM) and the processes described in this patent application are simply executed on the OEM's OBU. A “dock-in” system that enables a portable personal electronic device such as a mobile telephone or a PDA to be coupled to an in-vehicle station can also be combined into an integrated in-vehicle system to form an OBU and/or a telecommunications system.

Door unlocking mechanism. (18)

Vehicle ignition circuit breaker or any similar anti-theft device to immobilize a vehicle electronically. (18)

Control device to activate the engine starter. (18)

Alarm systems against intrusion.

Pictograms display visible from outside the vehicle (14)

Solar panel and battery pack to supply power to some of the equipment that may be installed in various parts of the vehicle. Such autonomous battery power can avoid the need for a time-consuming and warranty-voiding connection to the in-vehicle electrical system.

Camera (34). In some high security applications, cameras that take the picture or recognize the facial features of a given user can be installed.

Scanner (36). In jurisdictions where vehicle rental service providers are required to verify entitlement means such as drivers' licenses, it may be necessary to install an in-vehicle scanner for users to present and transmit their entitlement means to a remote customer response center.

Short range, high frequency wireless communication devices to enable data transfers between the various in-vehicle equipment or, in a less advantageous embodiment, cabled connections between said equipment.

Miniature radio-transmitter to trigger the door unlocking mechanism without the need for special cabling.

Map database or remote access to a map database.

Speech recognition/voice synthesizer system.

Biometrics equipment.

In-vehicle computer printer.

Motion, vibrations, heat detector, e.g. optoelectronic sensor.

6.1.5 CRMLS (Central Reservations, Management and Location System)

As will become clear in the description of the system processes, powerful and secure information processing means are required to manage all the past, present and future data generated by vehicles, users and third parties.

Central computer server where all reservations and management functions are performed.

Internet computer server.

Interactive Voice Response systems (IVR) and/or Dual Tone Multi-Frequency (DTMF) server (also known as touch-tone signal processing).

Base Station Systems (BSS) (may be required in some circumstances) (7)

6.1.6 Enabling Administrative, Technical and Commercial Conditions

In its preferred embodiments, the system is exploited within the framework of administrative or commercial agreements and uses common communication protocols with the following entities:

Energy distribution networks such as fuel stations (52).

Credit verification service providers or credit card providers (51).

Authorities responsible for issuing and controlling the entitlement means such as drivers' licenses (46).

Providers of insurance records or other types of public records to qualify users of the automated vehicle rental processes (51).

Providers of content to mobile customers such as travel, traffic, navigation or weather information (50).

Insurance, vehicle repair or other referring organizations that frequently direct users to vehicle rental service providers (49).

Global Distribution Systems (GDS) (44) such as Sabre, Amadeus or similar networks that are widely used for worldwide reservations of rental vehicles or similar connectivity to Internet-based travel portals such as Travelocity.com, Expedia.com and other similar information delivery organizations.

6.1.7 Other Special Equipment, Contracts and Procedures

Smart cards must be programmed before their issuance to each individual user and special equipment and security procedures are required for such operation to take place.

In order for vehicle rental service providers employees to inspect vehicles and confirm their odometer reading or fuel gauge levels, a master code or a specially programmed smart card must be issued to them to allow for certain operations to take place.

In order to ensure the proper allocation of legal responsibility when users take possession of rental vehicles in unmanned locations and through an electronic process, it is considered an enabling condition for service providers and users to agree and refer to a “general or master” rental agreement.

Throughout the processes that will be described further, encryption techniques or other comparable network security measures that are known to people skilled in the art of computer networking are used extensively.

To enable the system to retrieve and send users' electronic messages using their preferred email address, a registering user must have the relevant information concerning said user's Internet Service Provider. For example: user id, password, mail server address, DNS, etc. Alternatively, a user can authorize the vehicle rental service provider or system manager to obtain such information on said user's behalf.

In order to assure users of the integrity of a rental process involving average speed, elapsed time or distance determination based on various equipment and logical processes, it may be required to obtain an independent certification of the data accuracy or integrity from an independent and impartial third party in some jurisdictions.

6.2 Systems Architecture and Communication Methods

6.2.1 Data and Voice Communications between CRMLS and Vehicles

In order for activities such as vehicle reservations, usage billing and fleet management to take place, the invention relies on communications between 2 essential system components: the CRMLS (41) and an on-board unit (OBU) (35) which is installed in each and every vehicle of a fleet (8). As was seen previously, said CRMLS is comprised of one or several networked computer servers capable of rapidly processing a high volume of operations.

Depending on factors such as costs, location, radio spectrum availability and proximity of the Public Switched Telephone Network (PSTN) (6) in a given application, said communications between CRMLS and OBUs (35) may be advantageously carried out through an additional system component which is the local base station system (BSS) (7) (43). Said BSS can be connected to the PSTN and installed within radio frequency (RF) range of a rental location to communicate with vehicles when they are picked up or returned for example (8). A BSS is a semi-permanent apparatus comprised of a processing unit such as a portable computer connected to the CRMLS and a RF transceiver, which enables a BSS to communicate with OBUs within vehicles. It can be advantageously moved from one location to another as a vehicle rental service provider reacts to changes in its commercial environment.

The introduction of a BSS as an intermediary component can be advantageous where there is no reliable cellular radio coverage available or as a means of reducing telecommunications costs. A BSS would typically use a combination of the PSTN lines and inexpensive short-range wireless communications as an alternative to cellular radio networks (FIG. 1).

The BSS can also be used advantageously within a vehicle rental network to transfer large amounts of data such as when remotely transferring maps and updating the database or software within a particular vehicle's OBU.

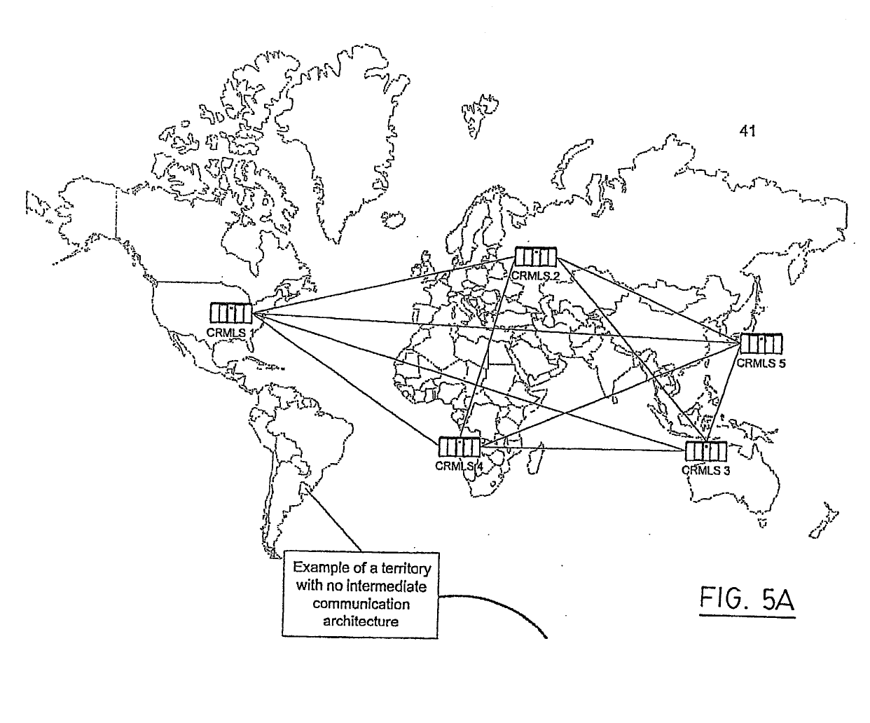

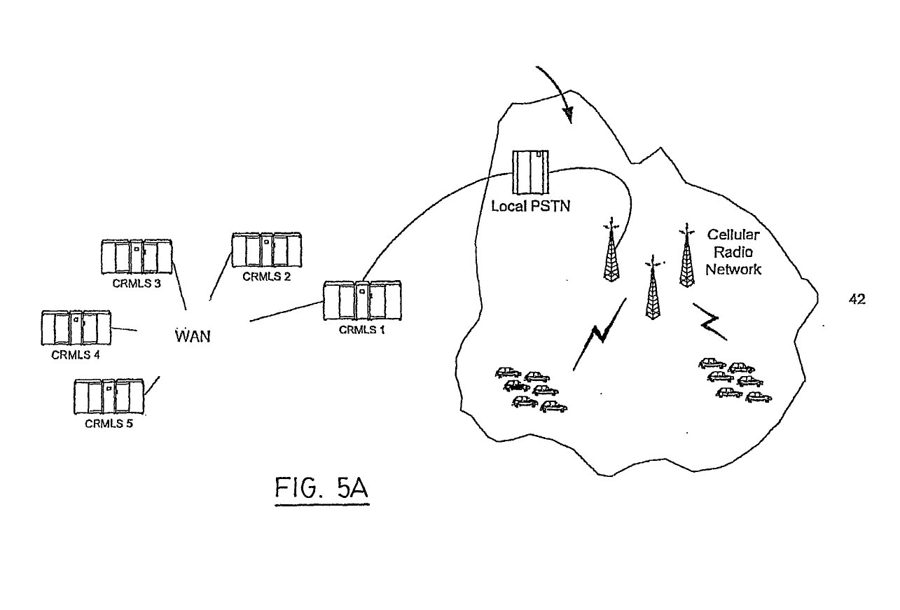

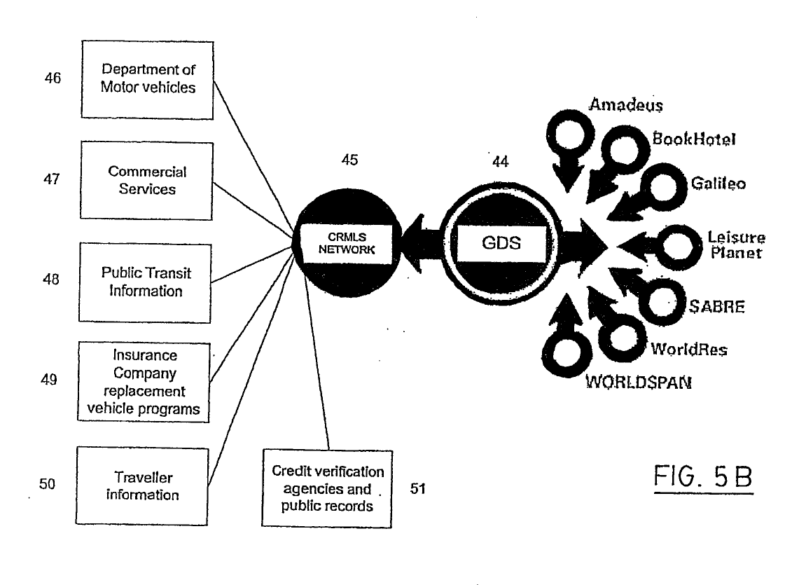

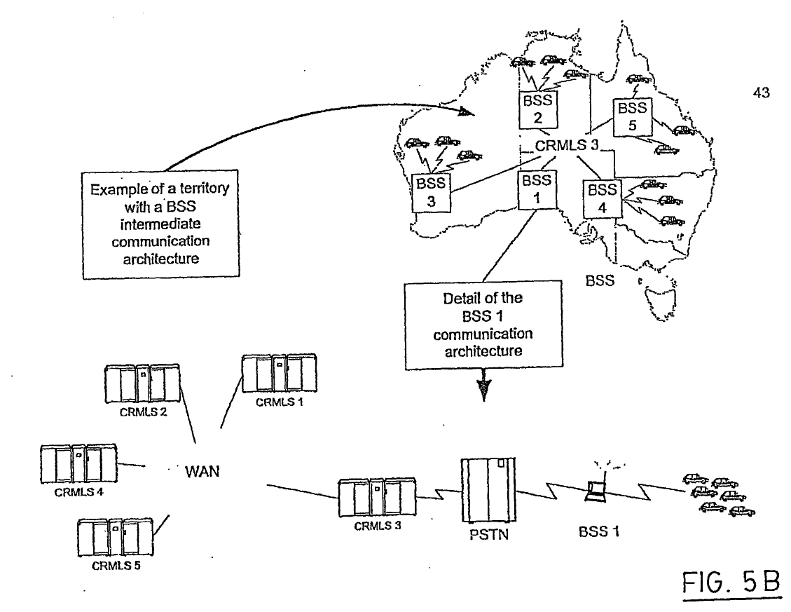

In fact and as can be seen on FIG. 5, the invention allows the CRMLS and OBUs to use a variety of communication architectures as long as they can exchange information between themselves. For instance, such methods can be as direct as having one or several worldwide CRMLS (41) entering in direct communications with any given vehicle anywhere in the world where there is a cellular radio network. In practice, it should be expected that each particular application would find its own balance between the advantages and disadvantages of a direct and centralized communication architecture by carefully analyzing the wireless communications environment.

To also accommodate the varying priority levels of communications between the CRMLS and the OBUs, the invention provides for a combination of data and voice transmission channels, techniques and protocols to be used. In an application where a service provider would use the invention for vehicle rental activities on 5 continents for example, then a CRMLS network could be formed with 5 similar continental CRMLS interconnected by methods such as an integrated services digital network (ISDN) (41). On each continent, CRMLS and vehicles could then communicate by combining instantaneous connections for high priority content and delayed Internet-supported data transfers through a BSS for low priority information exchanges such as updating software running on the OBU of a given vehicle. According to the volume of activity and the local conditions of a given rental location, components of the system will be programmed to use the most appropriate channel within such options as ISDN, BSS connected to the PSTN or third party cellular radio networks.

6.2.2 Connectivity Standards of In-vehicle Components

As telematics and other electronic systems become more prevalent in vehicles, initiatives have recently been taken by equipment suppliers, vehicle manufacturers and other organizations to agree on open and universal connectivity standards such as Bluetooth, LIN, MOST, AMI-C or IDB in order to facilitate the connectivity between said systems. In the preferred embodiments of the invention, the OBU and its related components make extensive use of such universal standards to reduce installation costs, improve performance and to take advantage of components already preinstalled by OEMs to measure the distance or speed pulse for instance.

In fact, it is considered likely that in future embodiments of the invention, many of the in-vehicle components described in sections 6.1.3 and 6.1.4 will be factory installed by OEMs and the invention will then mostly deliver its benefits at the process management level.

6.2.3 Third Party Access Gateways

With the simultaneous emergence of a wide variety of mobile communication devices and services for mobile customers, several organizations have recently been created to effectively act as gateways as well as telecommunication, application and billing intermediaries between providers and users. In one preferred embodiment, data and voice communications between CRMLS and vehicles as well as substantial elements of the processes to be described further can be contracted out to such organizations using a variety of different networks and communication methods to achieve the same objectives.

6.3 Registration-Related Processes

The invention provides new users with means to securely, autonomously and electronically register or update their personal information with a vehicle rental service provider, such as address, telephone number, special conditions, desired rate and incentive options, preferred vehicle class and information related to payment or entitlement means.

6.3.1 On-line or Internet-based User Registration or Profile Update

In a preferred embodiment, the registration is performed directly by the new user through one or several multilingual Internet sites controlled by a vehicle rental service provider or an interconnected third party. It should be noted that in its preferred embodiment, the invention does not require but still enables a human operator to intervene during the registration process. In the course of this process, the user will also be selecting a secret code and/or agreeing on some other security procedures, a cornerstone of the system protection.

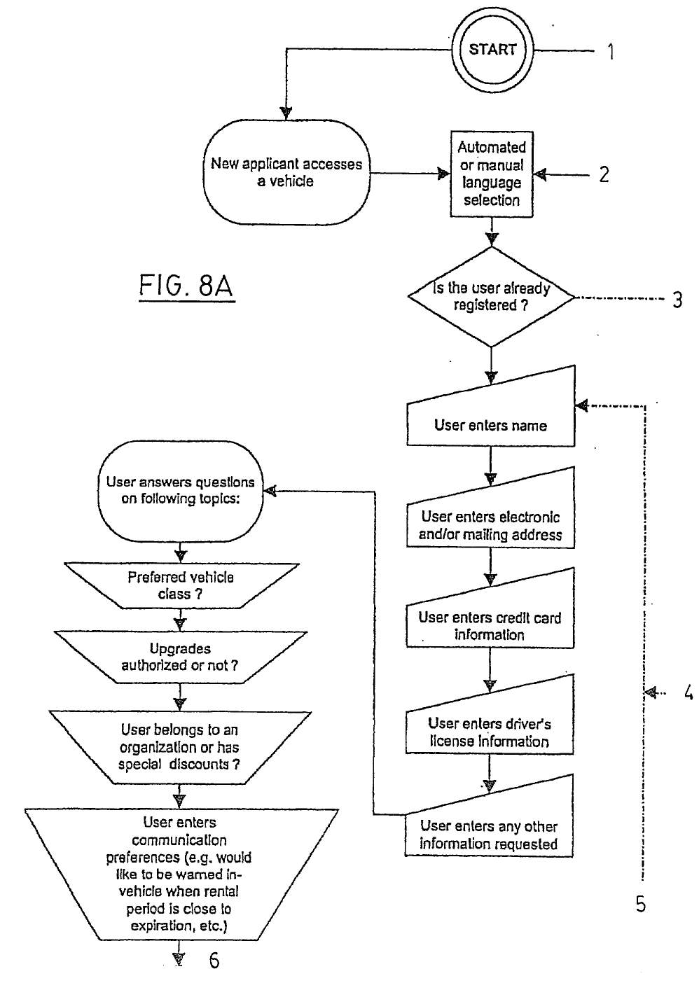

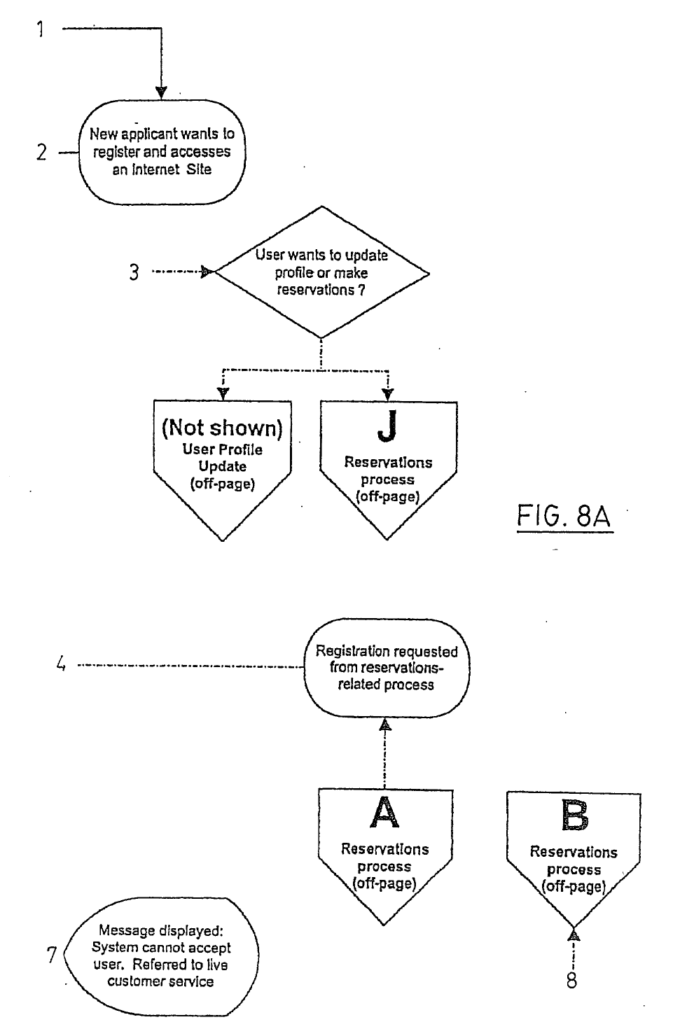

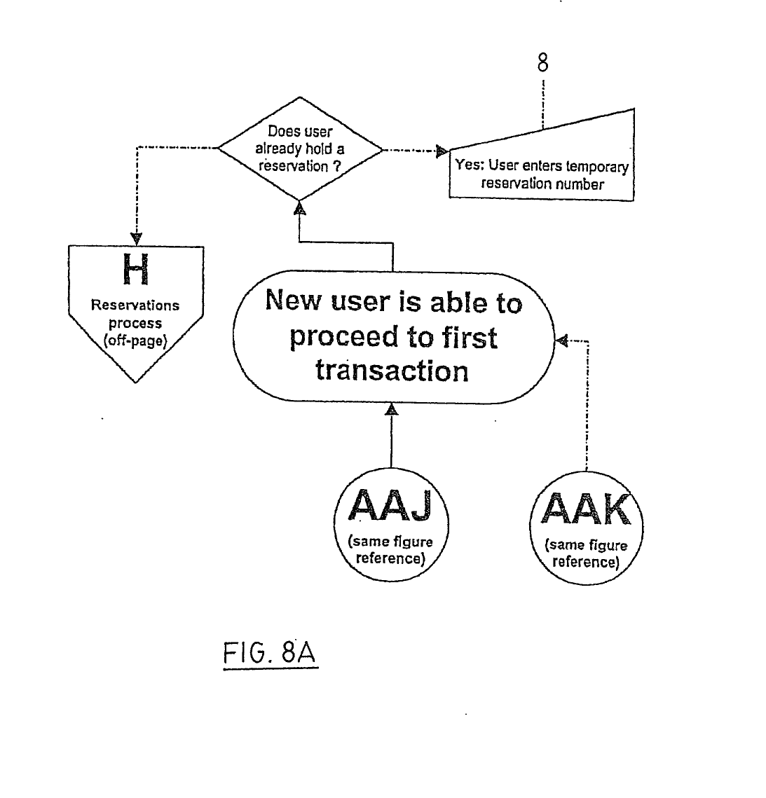

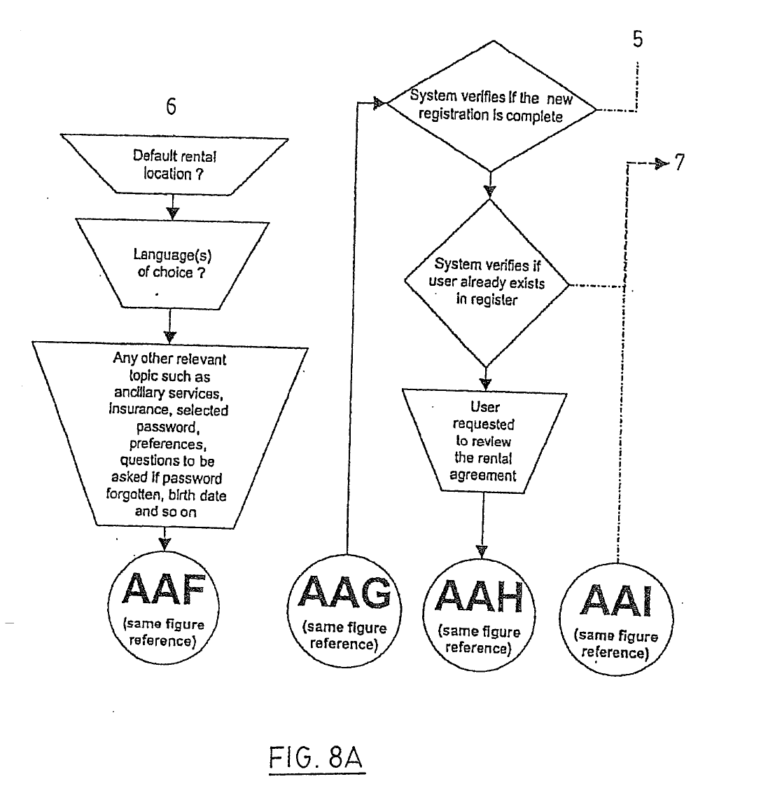

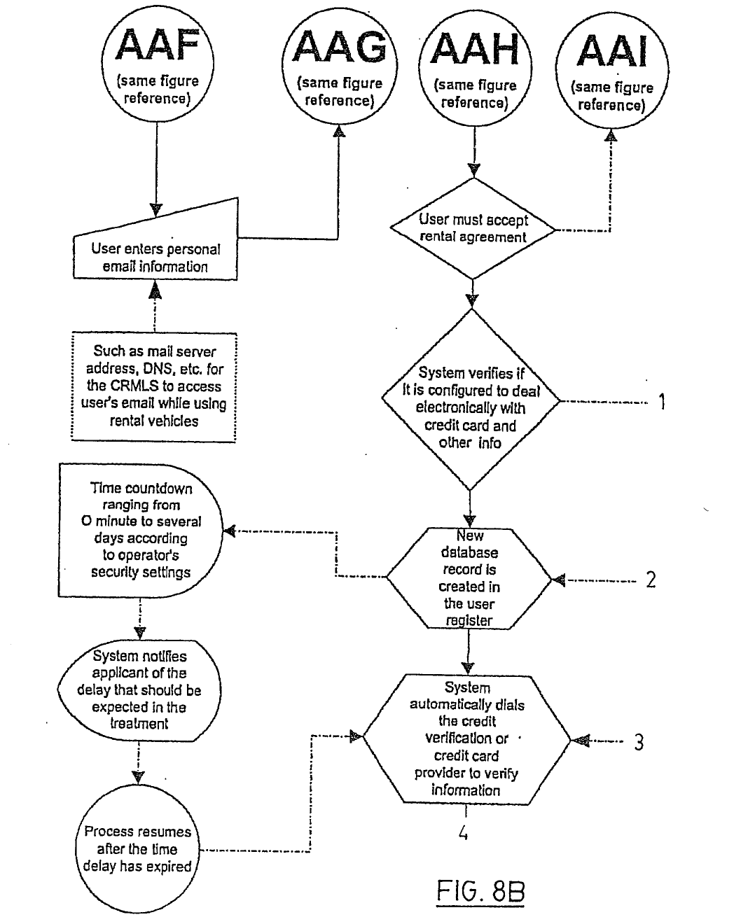

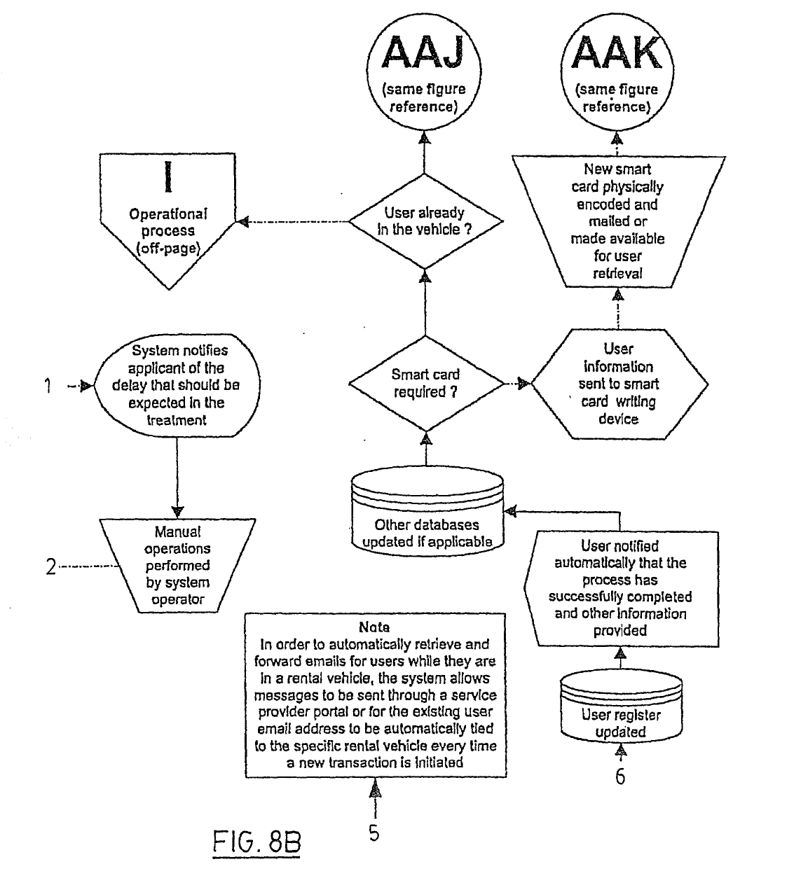

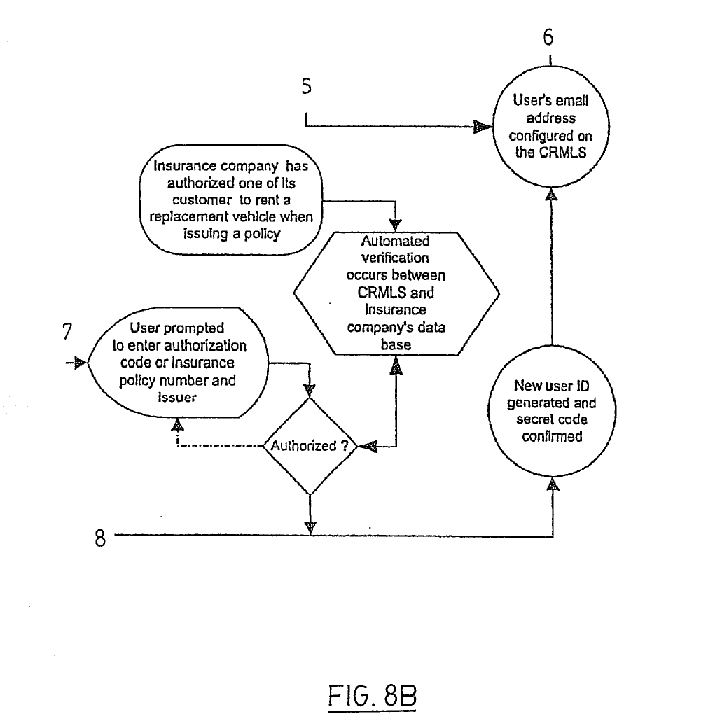

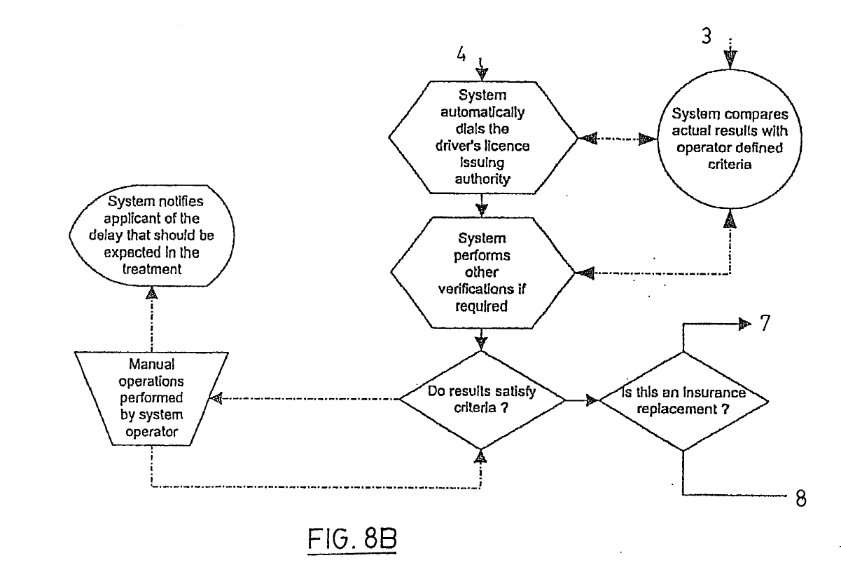

As can be seen in FIG. 8A, said registration can take place from any Internet enabled device in the world including the OBU of a rental vehicle itself through a regular remote-connection or wireless Internet session with the CRMLS.

6.3.2 Spontaneous Registration by Interfacing with Vehicle Equipment

In a preferred embodiment, the invention provides new users with means to register or open an account with a vehicle rental service provider with no advanced registration whatsoever and through an immediate and direct interface with the actual vehicle that they are wanting to rent.

As seen in section 6.1.2, said process can be enabled by having a side-window display (15) and a keyboard (13) affixed to the inside of a vehicle window in a way that a user can activate the relevant alphanumerical or symbol keys from the outside. In such embodiment, summarized user instructions or advertising means may be posted in a manner that can be read from outside the vehicle and in the main languages where the vehicle is offered (14) (15).

After assimilating said instructions, said new users would then be requested to go through a minimal security procedure before being granted access to the vehicle. This procedure could involve the user entering one verifiable personal information from outside the vehicle such as a driver's license number, a special code obtained in advance or a credit card number. After performing satisfactory verifications, the OBU unlocks the door. Using the vehicle communication means such as the display and keyboard, the new user is then able to continue the registration session, if required, in the comfort and relative privacy of the vehicle, directly entering the additional information required until the registration process is complete.

6.3.3 Spontaneous Registration Using a Personal Communication Device

In a preferred embodiment, the invention provides for new users to register with a vehicle rental service provider by simply dialing a special CRMLS number advertised on a vehicle from their personal communication device or from a public phone. Said new users would then be prompted to precisely identify the vehicle they are looking to rent by entering the selected vehicle's assigned number. Said new users would then be requested to go through a minimal security procedure such as entering one verifiable information over the phone and continuing the registration session in a manner much similar to the one described in section 6.3.2. Upon successful completion, the CRMLS would then instruct the OBU to unlock the doors.

6.3.4 Spontaneous Registration Using a General-purpose Smart Card

In yet another embodiment, the invention provides for users to spontaneously register by presenting a widely distributed personal electronic means already in their possession for other applications without the need to have any prior relationship with the vehicle rental service provider. Said electronic means can be a general-purpose electronic purse or a national social security smart card or a credit card equipped with a chip card for instance. After the information contained on said smart card has been verified, the new user would then be granted access to the vehicle in order to complete the registration process in a manner much similar to the one described in the previous sections.

6.3.5 Verification of the User-provided Information

As can be seen in FIG. 8A and before enabling a new user to actually use a rental vehicle, the system verifies that the information submitted by a particular user is correct and acceptable without or with minimal human intervention.

Depending on the level of security and credit verification desired, said verification could be more or less thorough. In a preferred embodiment, fully automated database queries are made from the CRMLS to the remote entity responsible for regulating the use of the appropriate category of vehicles in a given jurisdiction; e.g. drivers' license issuing office. Such automated verifications can confirm if the public records for a new user match or closely match the information that has been submitted and if a user is entitled to operate a given class or form of vehicle. The system then automatically verifies that the credit card information submitted matches the information registered with the credit card issuer and that the card is valid. Upon confirmation that all information given is correctly correlated in the queried databases and/or is acceptable in relation to the service providers' system criteria, the new user ID or account number is generated.

In one particularly secure embodiment where spontaneous registration methods are not allowed, the system can be programmed to voluntarily delay the moment when it verifies the information submitted by a new user in order to allow sufficient time for stolen credit or entitlement means to be reported. After the verification has completed and if a personal electronic access means such as a smart card is also used said means is then issued for mailing to a new user or for retrieval at a retail point. Therefore, in such secure embodiment a criminal would need to have unreported access to the secret code, the entitlement and credit means as well as physical possession of the personal electronic access means to register falsely and access the system. In practice, it is expected that operators of the system will balance the use of such security features with other commercial and legal requirements.

Yet, in an even more secure embodiment and when provided with confirmation of the appropriate legal or system manager authority, the system can also automatically verify a new user's standing with various reporting entities such as credit agencies, insurance bureaus or other relevant public records (51).

The system also provides for all above verifications to be repeated at selected intervals or occurrences according to defined criteria to ensure that registered users have maintained their good standing, entitlement or payment means, e.g. only upon registration or on an annual basis or for every single transaction.

In the case where automated queries have been unsuccessful, e.g. due to a denied access or incompatible connectivity with the concerned remote databases, it is provided that the present invention will produce a request for manual intervention to a human operator.

If this occurs during registration, the system will then withhold the authorization to activate a new user until such manual intervention has been completed and reported back to the system or until an authorized system manager overrules the holding pattern. It is also provided that each user registration is compared with the existing database to prevent double registration or registration attempts by past users with revoked access privileges. This explanation of the verification process is only provided as an example as several different security levels and embodiments are possible to achieve comparable goals. As per current vehicle rental practices, most service providers that operate through manned retail counters are usually satisfied with semi-automated telephone credit card verifications and a visual verification of their customers' entitlement means before granting access to a vehicle.

According to the invention, such human verification can replace or be combined with the above described automated processes in order to instantly deliver a secret code and the corresponding access means when such retail points are available and if such a security level is acceptable to a service provider.

6.3.6 Remote Visual Verification of the User Entitlement Means

In some jurisdictions and for some applications, the law requires that vehicle rental service providers make a visual verification of the driver's license presented by a user before granting them access to a rental vehicle. In a preferred embodiment to deal with said requirements the rental vehicle is additionally equipped with a scanner (36) and a camera (34). When a user is seated in the vehicle, he is prompted to insert a valid driver's license into the in-vehicle scanner. The picture file and the scanned document file are then sent to a customer service and response center for authorization. Said visual verification process can be added to the previously described registration processes in order to comply with said laws or to increase the security level of the rental system.

6.4 Reservations-Related Processes

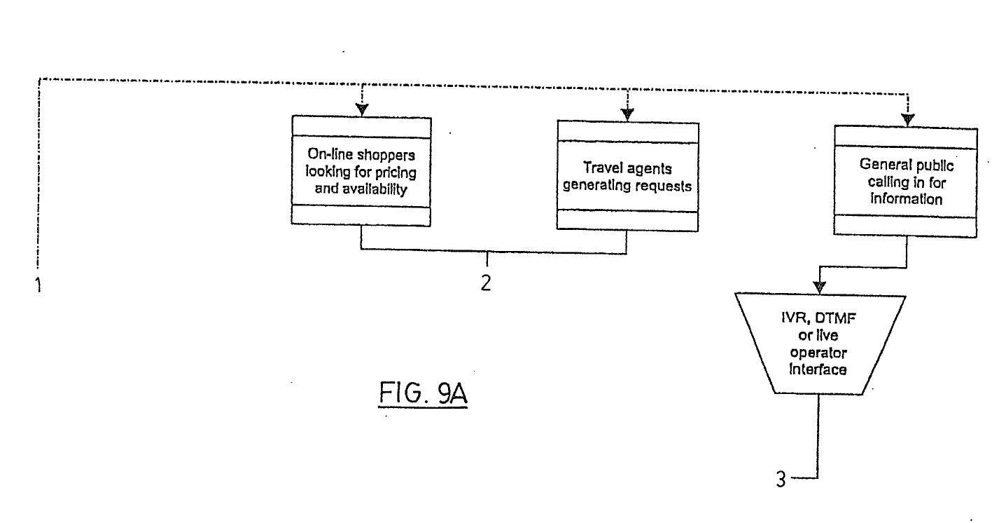

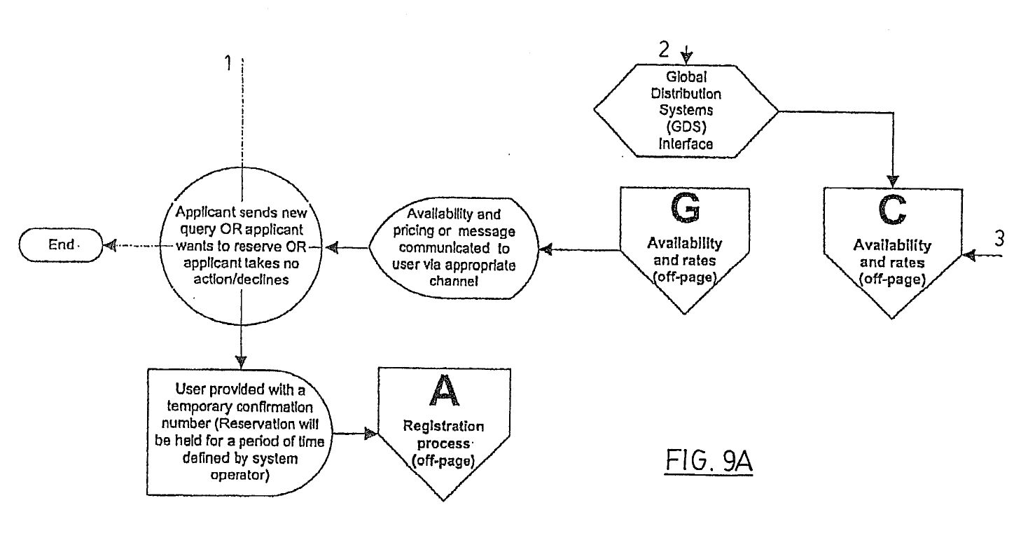

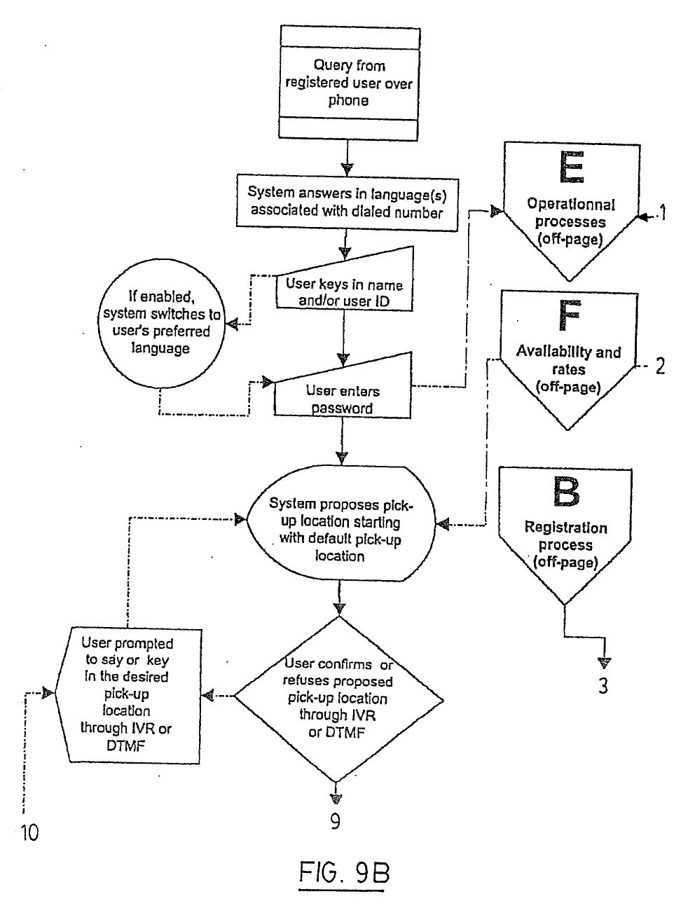

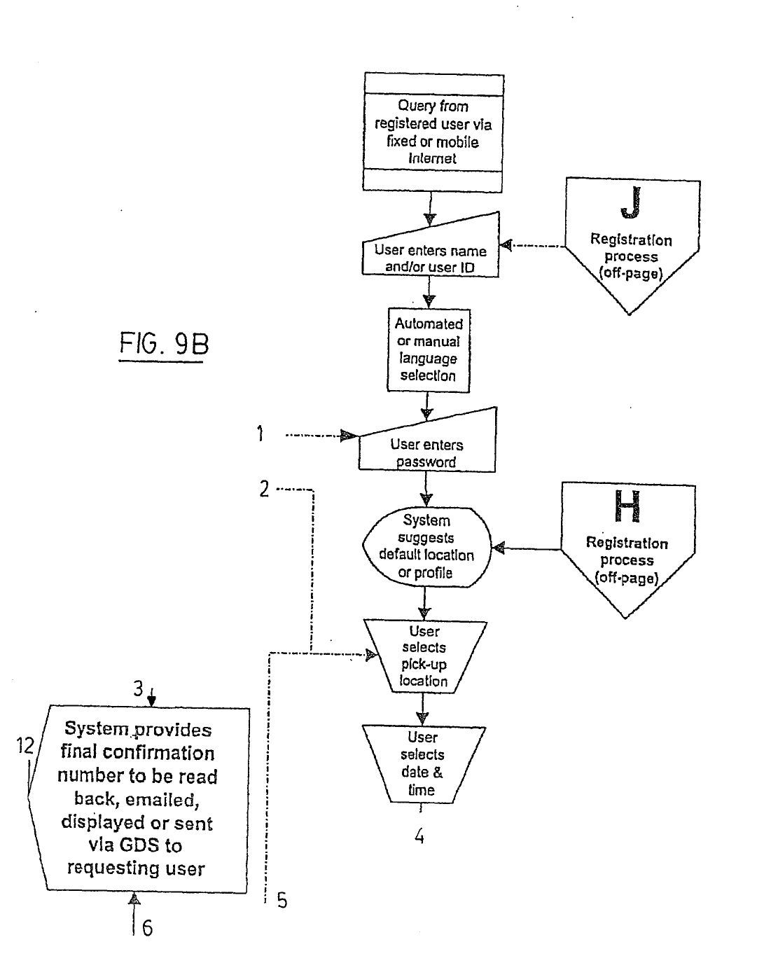

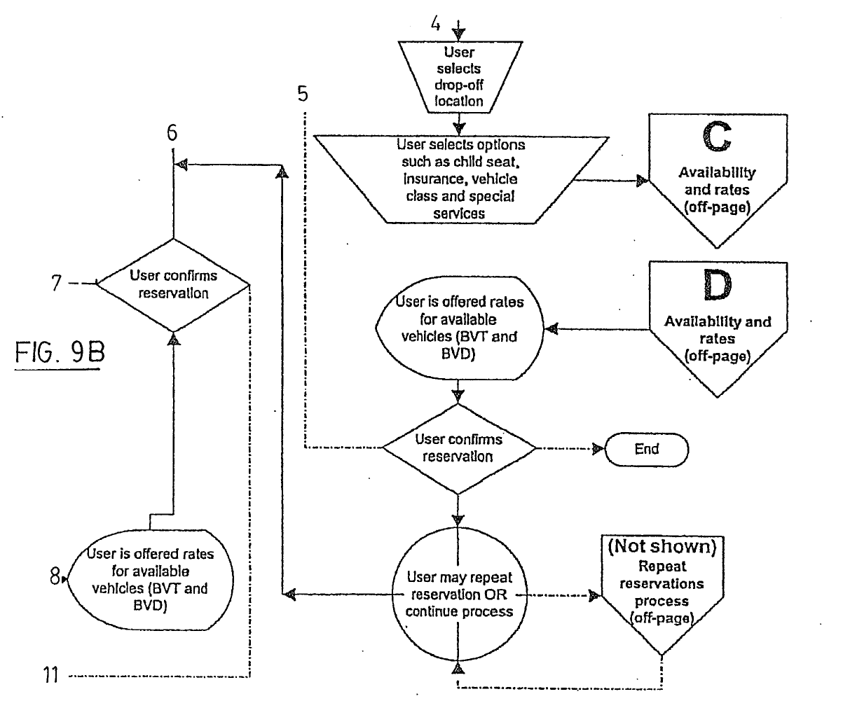

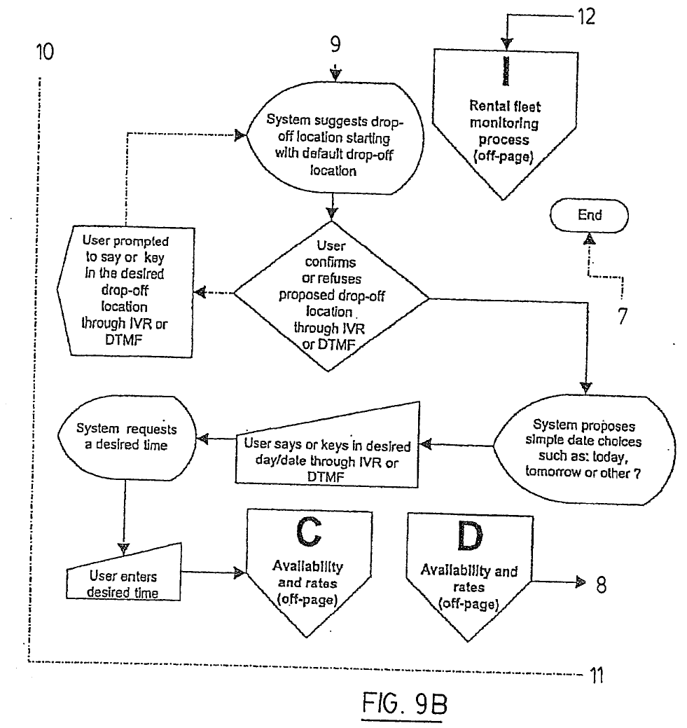

6.4.1 Querying the System for Availability and Pricing (FIG. 9A)

All updated information concerning the availability of vehicles and their pricing can be found within the CRMLS. In order to continuously and automatically answer queries, process reservations and distribute the relevant information to actual and potential users, the invention is able to use both an internal information network and an external information distribution system.

In a preferred embodiment, the internal information network is comprised of several computer servers dedicated to the vehicle rental service provider's Internet sites, DTMF (touch-tone) or interactive voice response systems (IVR) that are part of the CRMLS. Users can access said internal information network from any telephone, computer or Internet enabled device in the world including the OBU within rental vehicles.

External systems are made up of third party computer servers that are directly or indirectly linked to the CRMLS. In a preferred embodiment, such external systems are made up of Internet travel portals and Global Distribution Systems (GDS) (44) such as those used by travel agents and which can automatically query the CRMLS for availability, pricing and reservation confirmation numbers. Such external systems are known to people skilled in the art of networking computers in the travel and transportation industries and no further explanation is provided on the intricacies of such information networks.

6.4.2 Reserving a Vehicle for Future Use

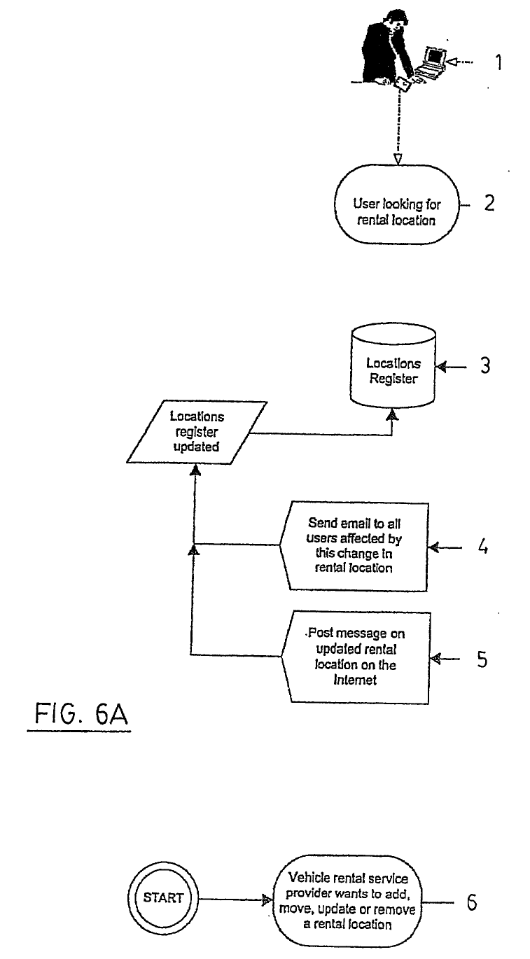

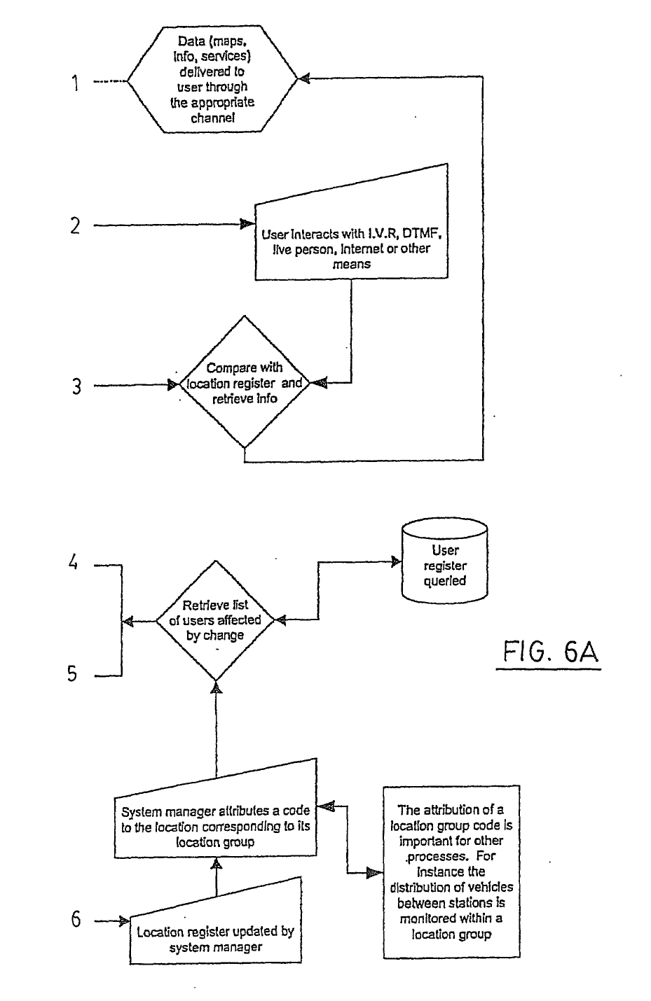

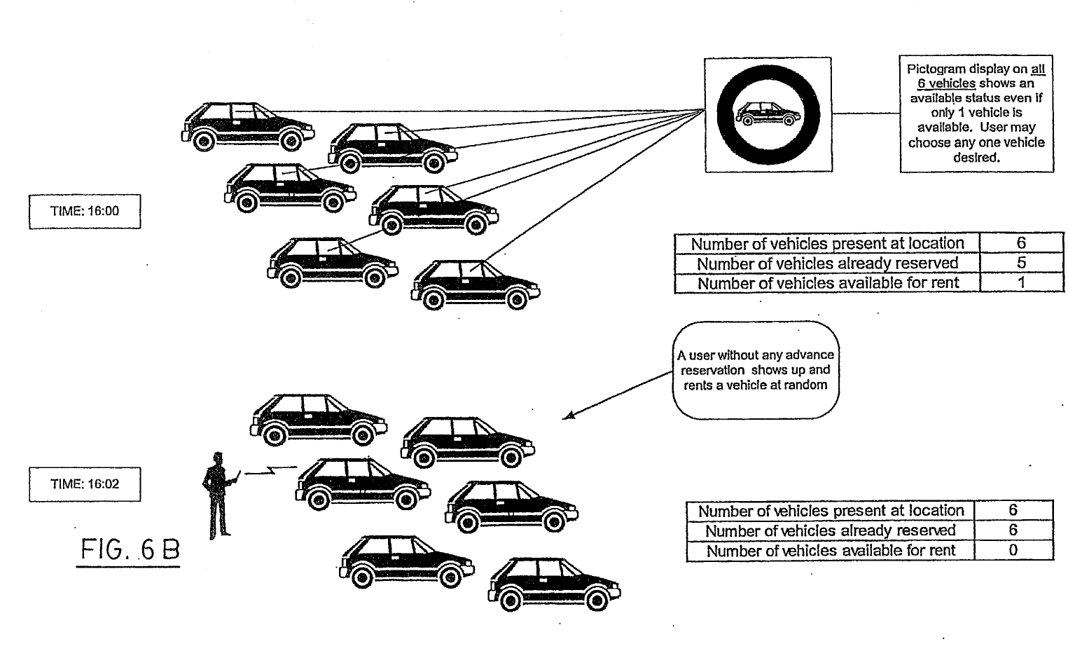

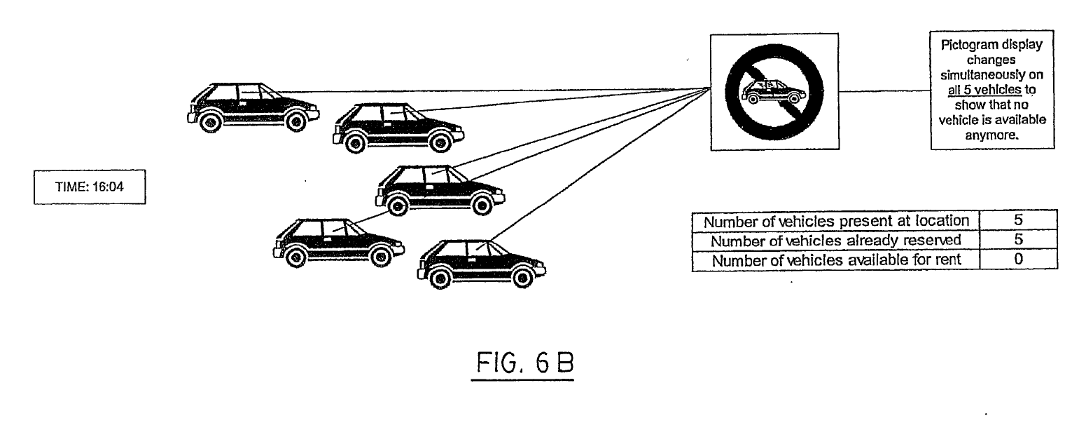

The invention provides for optional, multilingual and automated reservations to be made and confirmed around the clock and from/to any part of the world. In a preferred embodiment, the invention provides for registered and experienced users to make basic vehicle reservations on the IVR or DTMF system. The invention also provides for registered and unregistered users to make more complex reservations over the Internet. For instance, the Internet would be the preferred reservation mode for a user wanting to reserve a special vehicle at an international rental location and to obtain a geographical map at the same time (FIG. 6A).

6.4.3 Vehicle Allocation and Standard Rate Determination

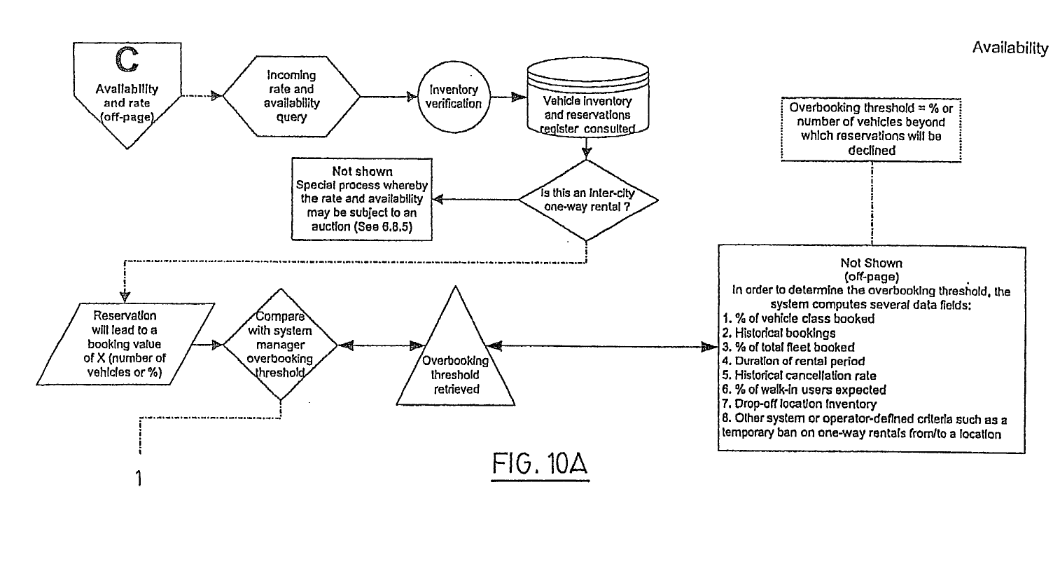

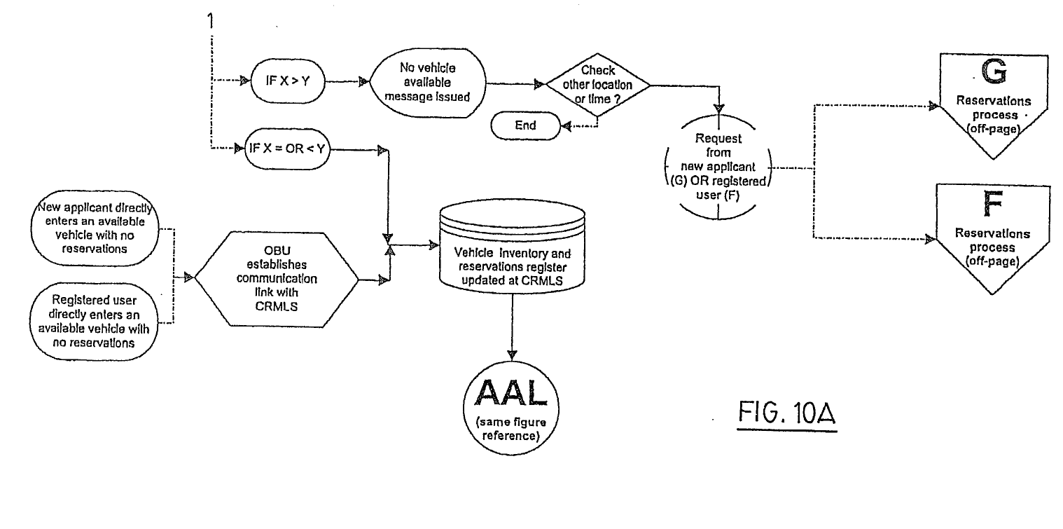

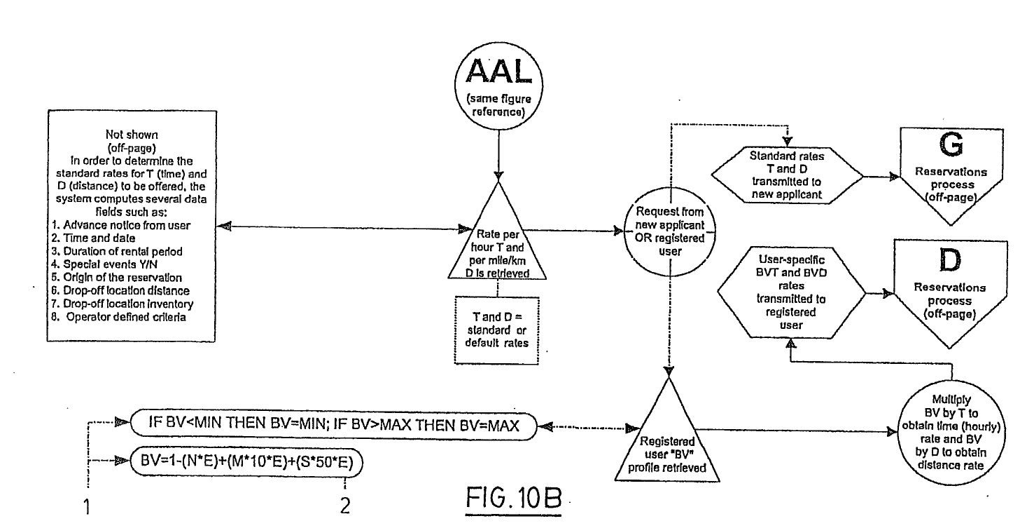

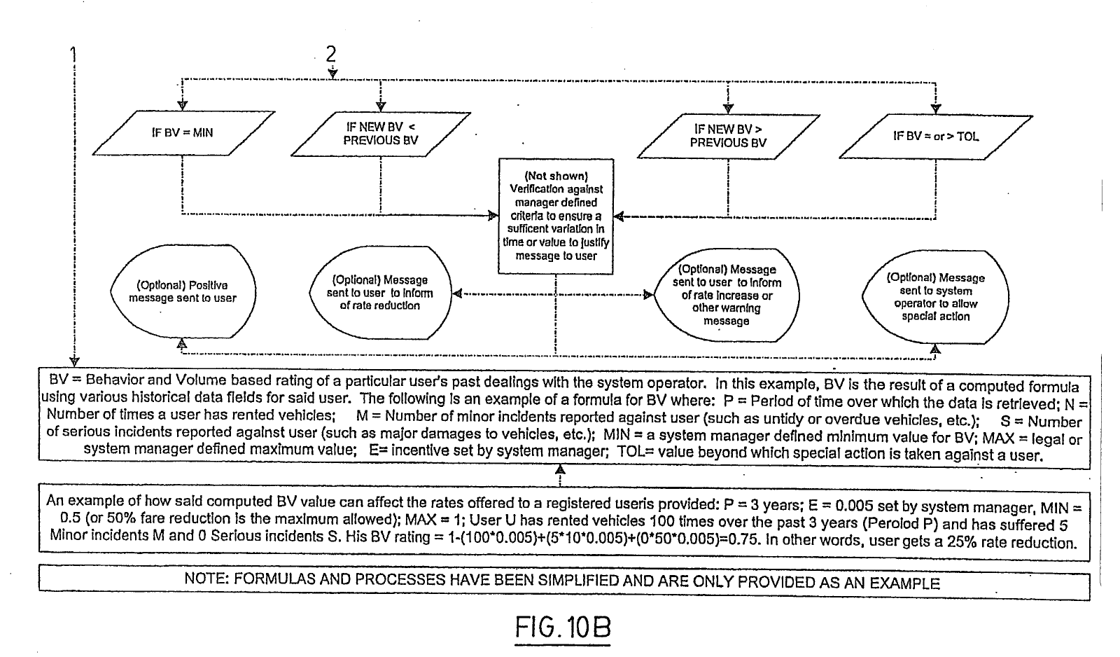

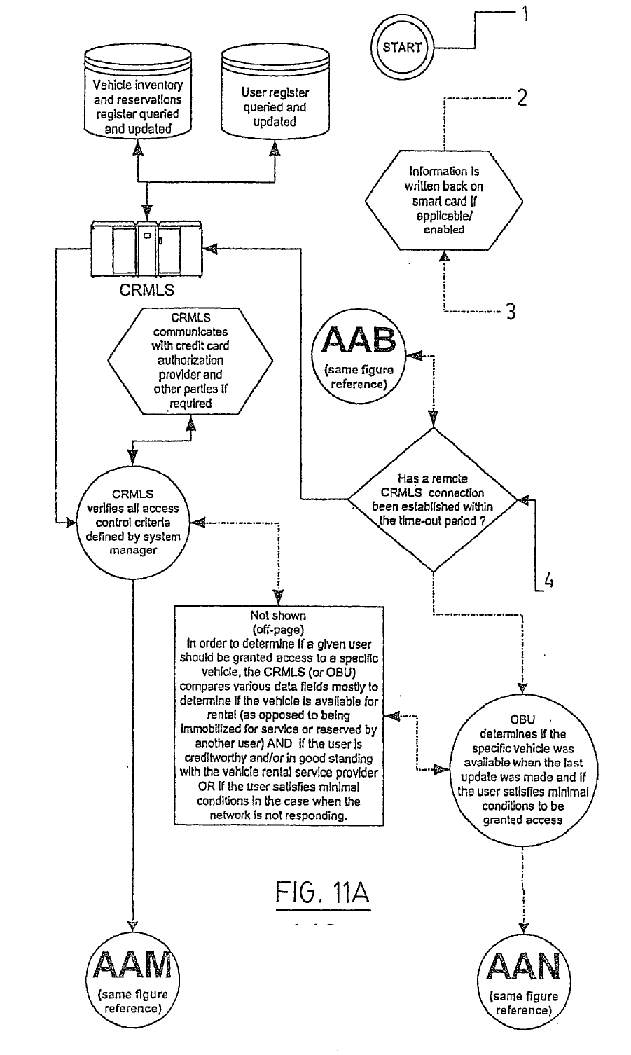

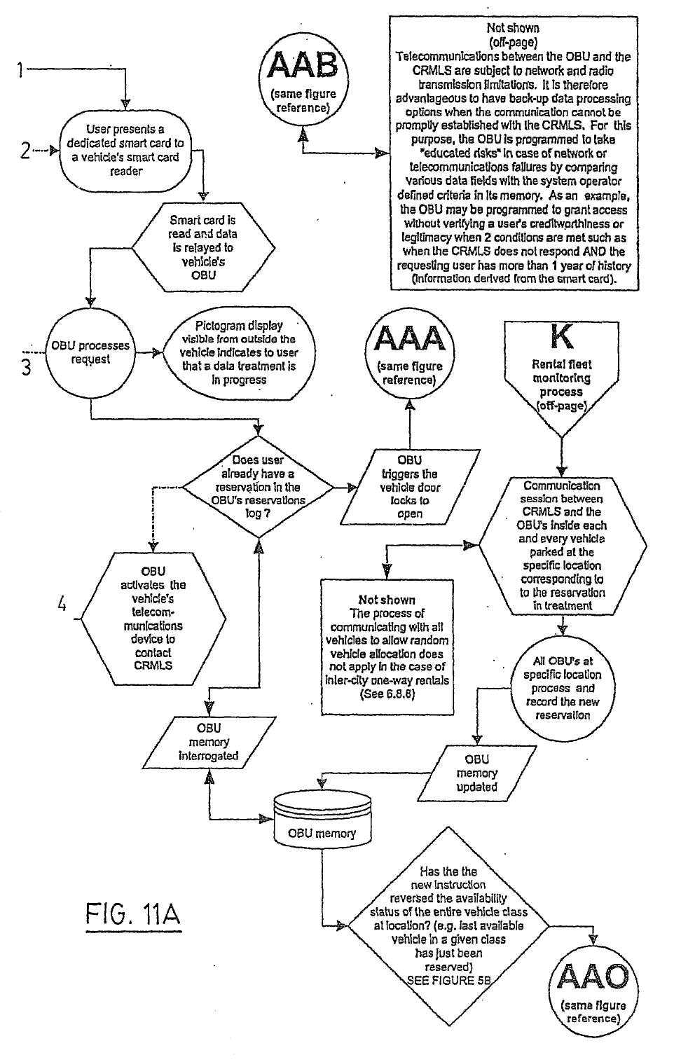

As can be seen in FIGS. 10A and 10B, the reservation process takes into account various elements such as user-provided duration (24), involved rental locations, vehicle class and bookings on-hand to determine if a rental vehicle can be reserved for a user. The system also provides for standard rates to be applied to rental transactions depending on the advance notice given by the user. For instance, reservations placed 24 hours before an actual rental may be billed at a different rate than reservations placed only 1 hour prior to rental.

It should also be noted that the system manager has the possibility to establish criteria beyond which reservations will be declined. As will be seen further, the system also employs special processes to modify said criteria in order to react to changing conditions such as an imminent vehicle shortage.

6.5 Special Reservations-Related Processes

Some already known issues in the daily or weekly vehicle rental industry become exacerbated in the context of repetitive hourly rentals and the invention provides for added functions to address those.

6.5.1 Repeat Reservations (FIG. 9B)

The system provides for quasi-permanent repeat reservations to be made in one operation. For example, frequent same location users may book a vehicle for every Monday morning for the next month and will be prompted to renew this on-going reservation before the end of the term.

This enables a user to rely on a vehicle always being available at the same location, at the same time and without time-consuming iterations.

6.5.2 Preferred Rate Determination and User Compliance Incentives

The invention provides the means to rate and encourage users' compliance with the rental agreement upon which the contract is formed between service providers and users. It also encourages users to utilize the rental system frequently. In a preferred embodiment, each user is rated against factual behavior/volume criteria (BV) which are determined from a formula taking into account the number and gravity of reported incidents against a user as well as the number of times said user has rented vehicles within the system (mainly FIG. 10B and as part of several other processes).

Examples of said incidents are

a) lack of punctuality against reserved vehicle access and return times

b) users returning rental vehicles in untidy or damaged conditions

c) users returning vehicles in a different location than originally booked

d) unreported traffic violations

e) failure to show up for or to cancel an active vehicle reservation

f) moving the rental vehicle outside an authorized radius (28)

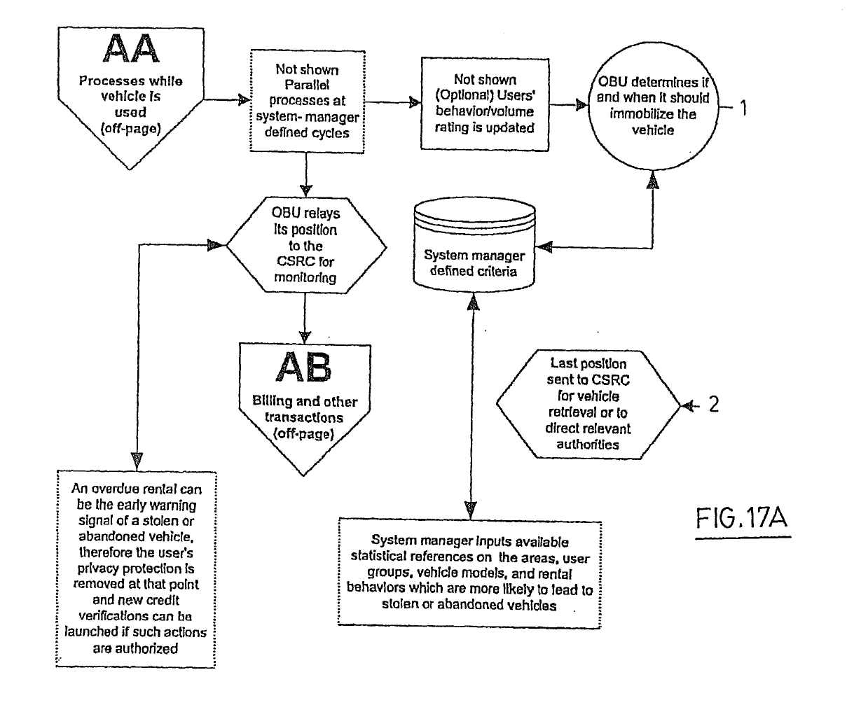

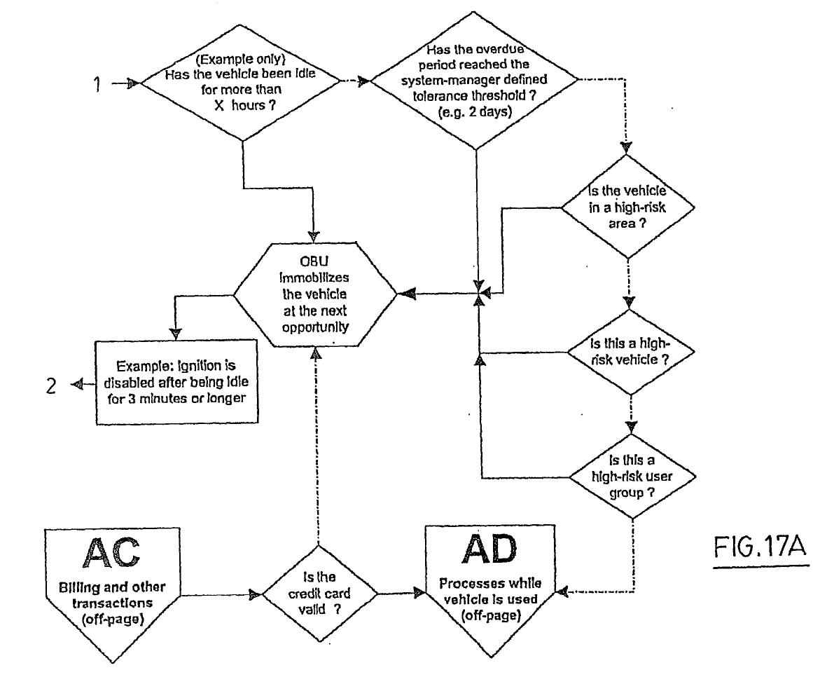

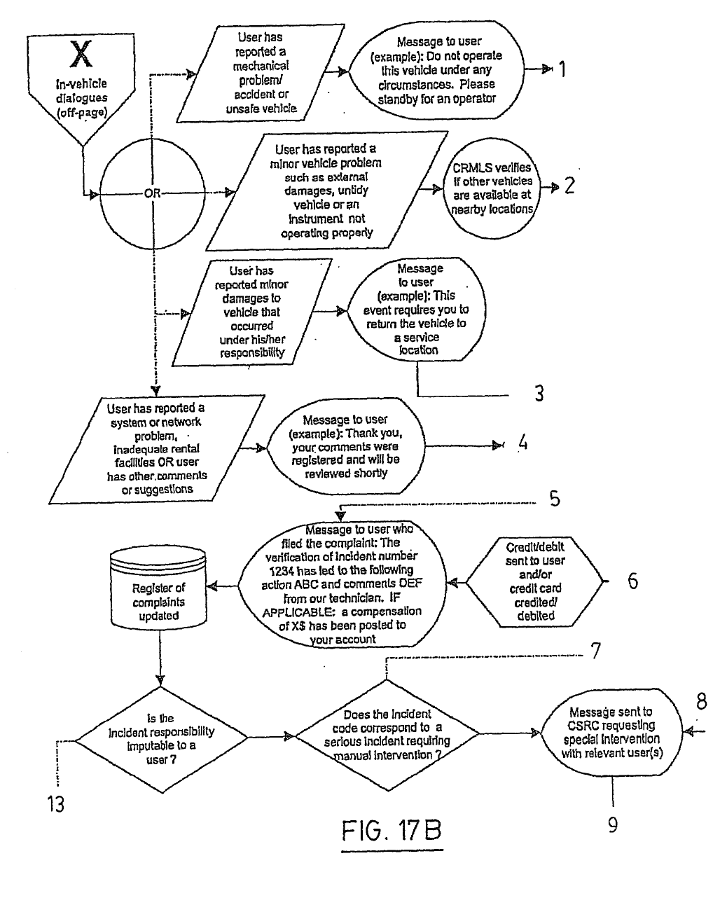

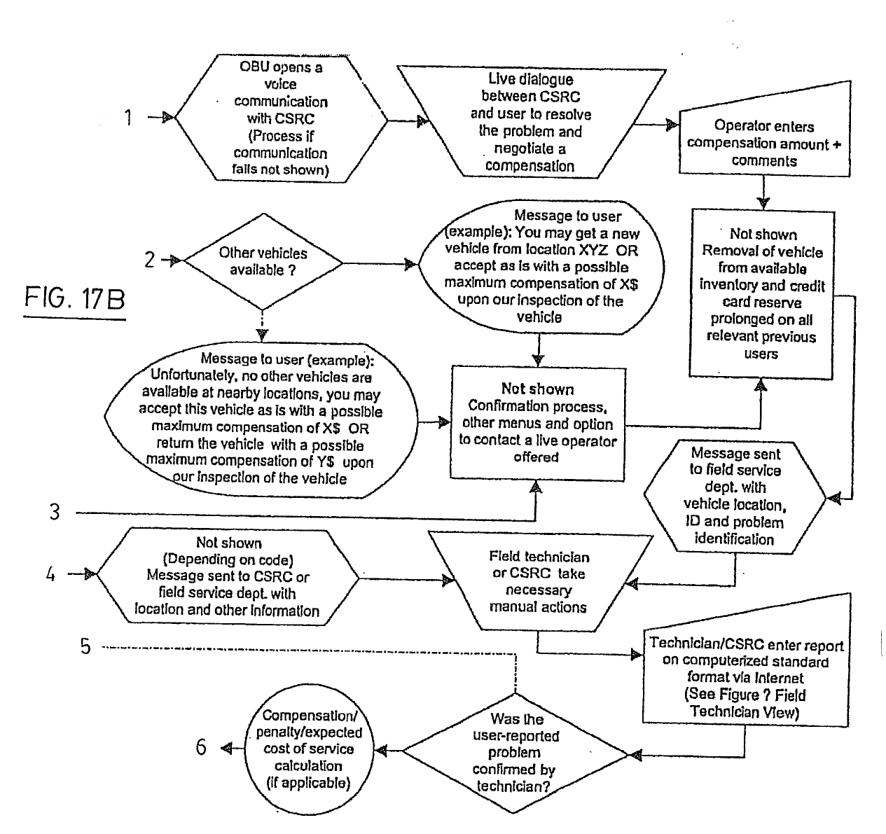

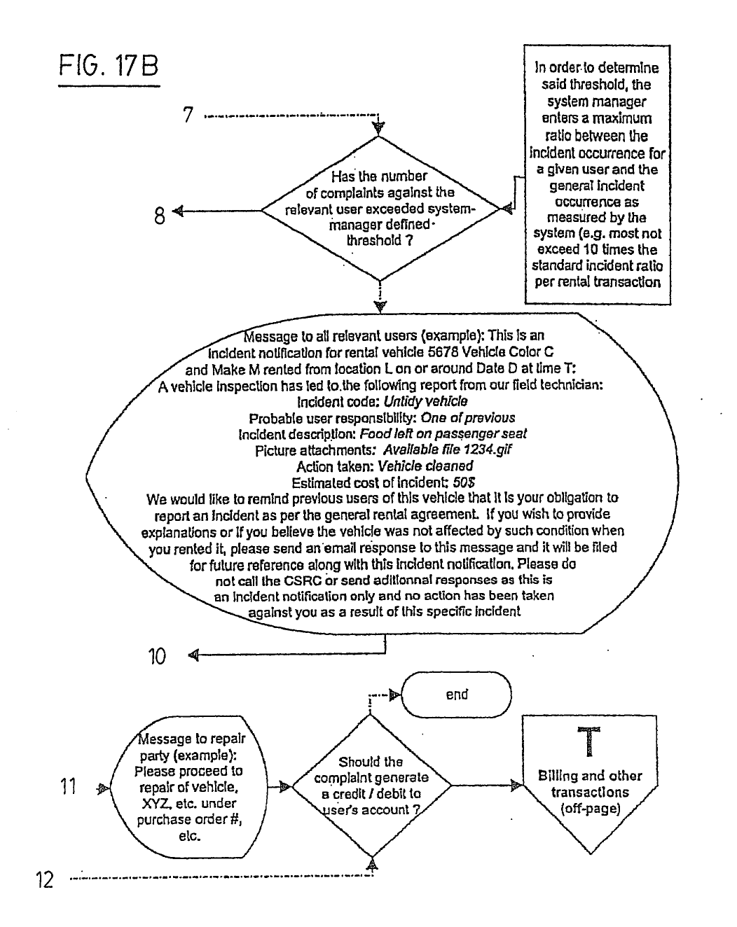

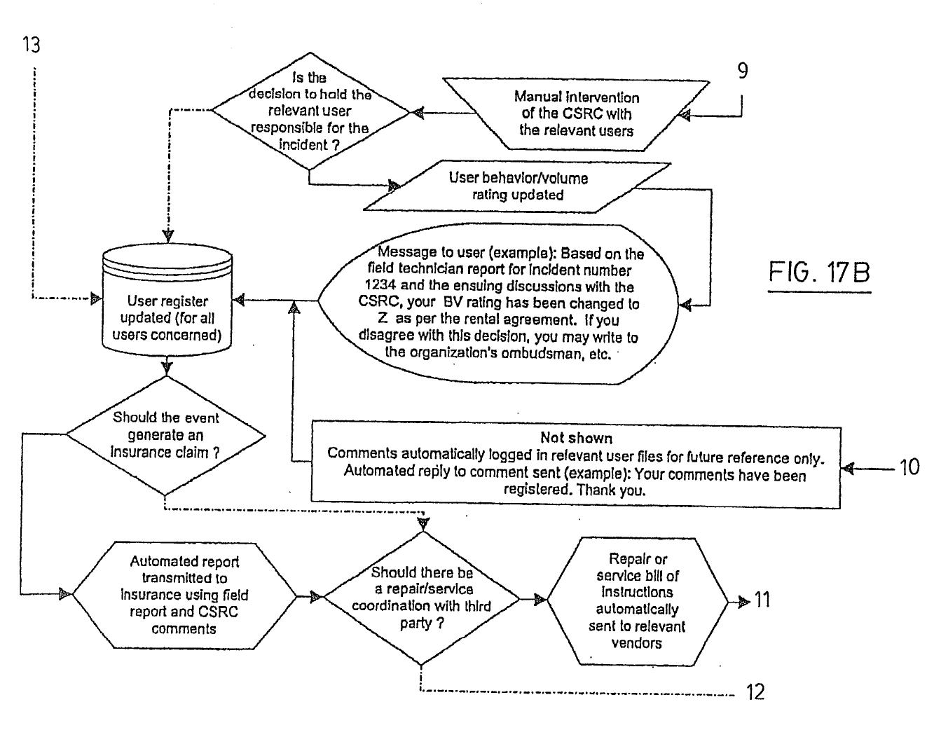

The invention provides for said incidents to be marked against a user up to a certain threshold (e.g. BV=1) beyond which penalties or rate increases are applied, messages are sent or other actions may be taken automatically or manually (FIGS. 10B and 17B). Inversely, users who consistently rent vehicles with low incident occurrence can automatically receive encouragement messages and reduced rates.

To understand the vital importance of such mechanisms in an automated short-term rental system it should be understood that vehicles will normally be rented out several times a day to different users and that there is usually no technicians to verify or correct the condition of vehicles in between rentals. It is known from economic models that even marginal improvements in user compliance with reserved times as well as reductions in vehicle downtime have a very significant impact on the economic viability of a rental system. For example, it is easy to understand that important utilization losses and poor fleet planning will result for the service provider if too many users exaggerate—even by half a day only—the length of their required rental period or fail to show up for a reserved vehicle. It is also obvious that important shortages, customer complaints and poor fleet planning will result if vehicles fail to return within the expected rental duration, if they are returned at the wrong location or unfit to be rented again as a result of careless behaviors.

6.5.3 Providing Users with Information on Rental Locations (FIG. 6A)

With the help of various means, such as voice instructions over IVR and/or DTMF systems and Internet sites, the user is able to find any rental location in the system register and obtain related maps, directions and link to services.

As was seen previously, said locations require no or very little infrastructure to enable vehicle rental service providers to create, modify or remove a rental location at very little cost in order to respond to varying market or seasonal conditions or other. In order to ensure that users affected by such changes are kept informed the invention provides for an automated diffusion of the information to relevant users when the location register is updated. As an example, relevant users may be defined as those having chosen the location being modified as their default location or users having used said location in the past.

As can be seen in FIG. 6A, it should also be noted that the system manager must allocate each new location to a group of locations. Such locations groups are used in various processes, including “Vehicle Inventory Control”.

6.5.4 Preventing Duplicate Reservations

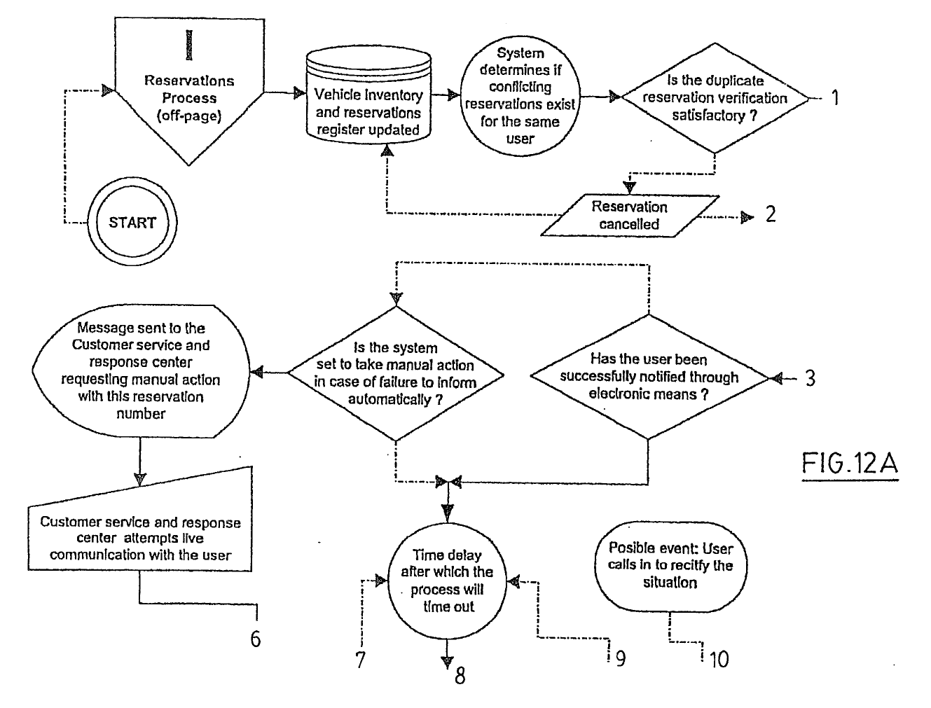

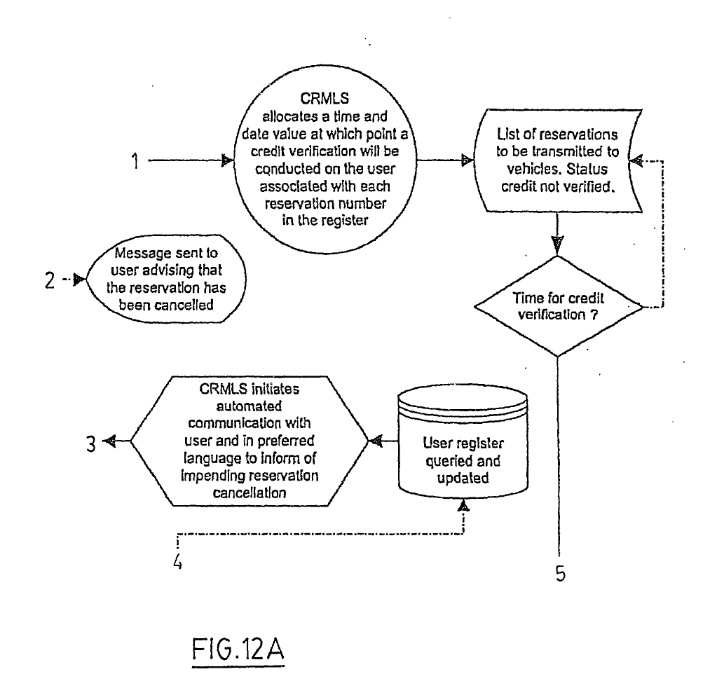

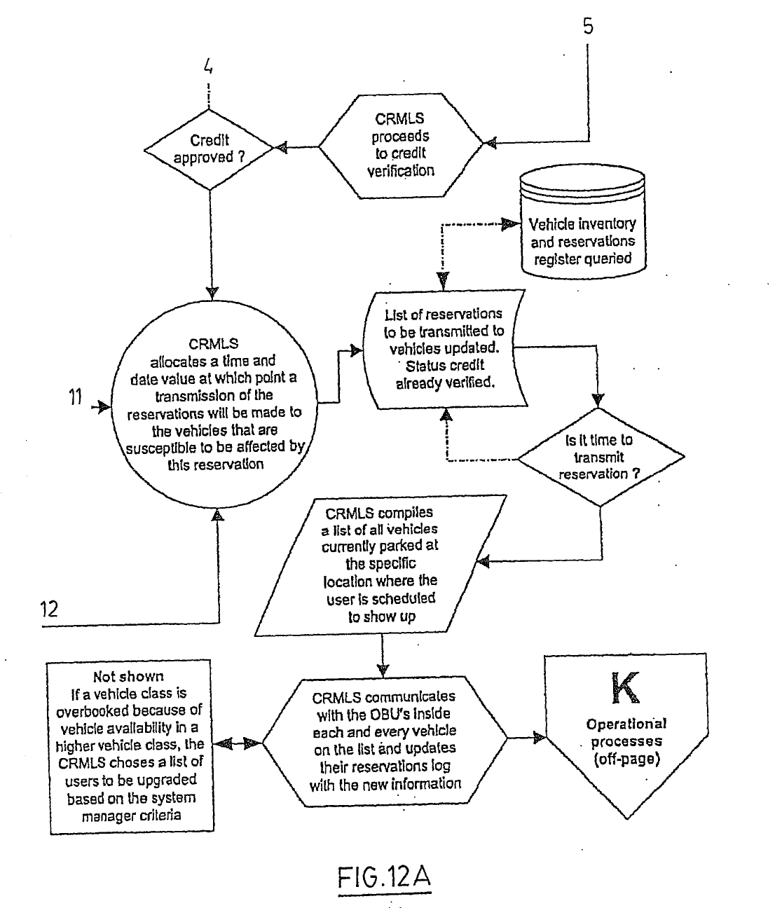

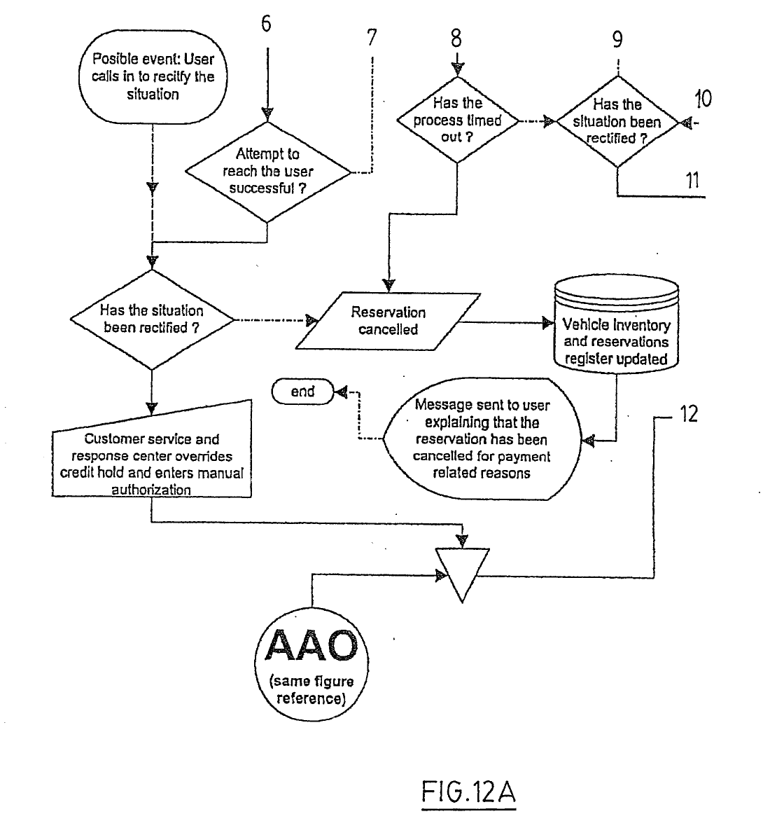

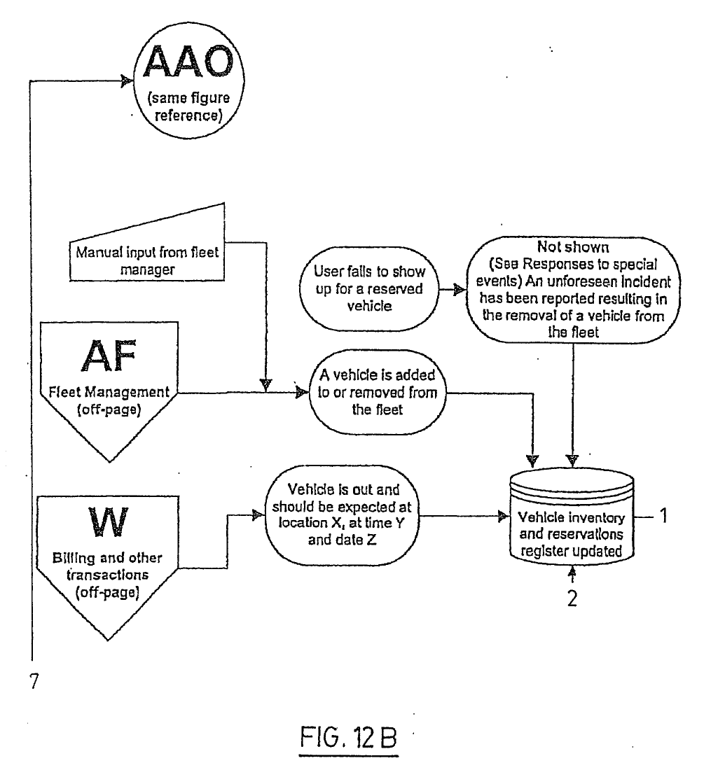

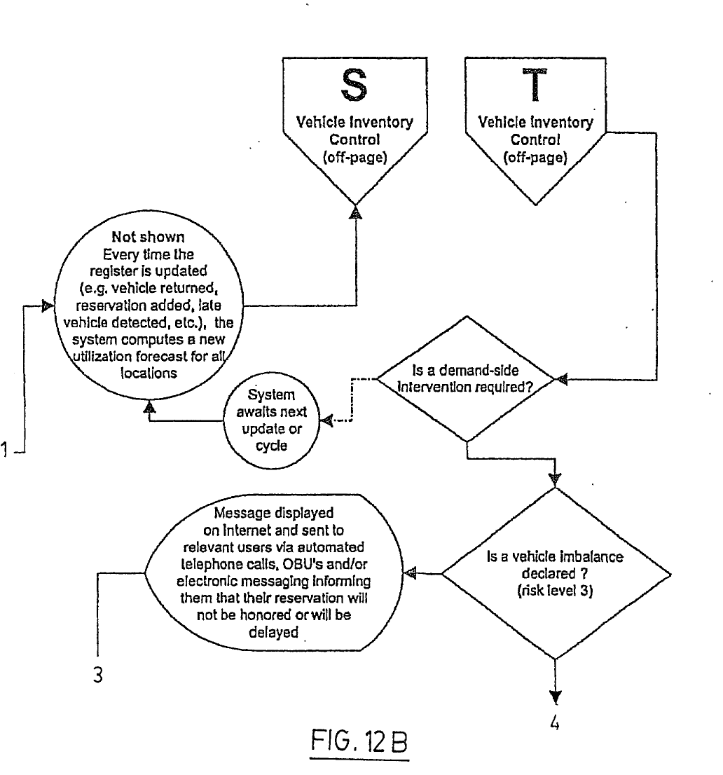

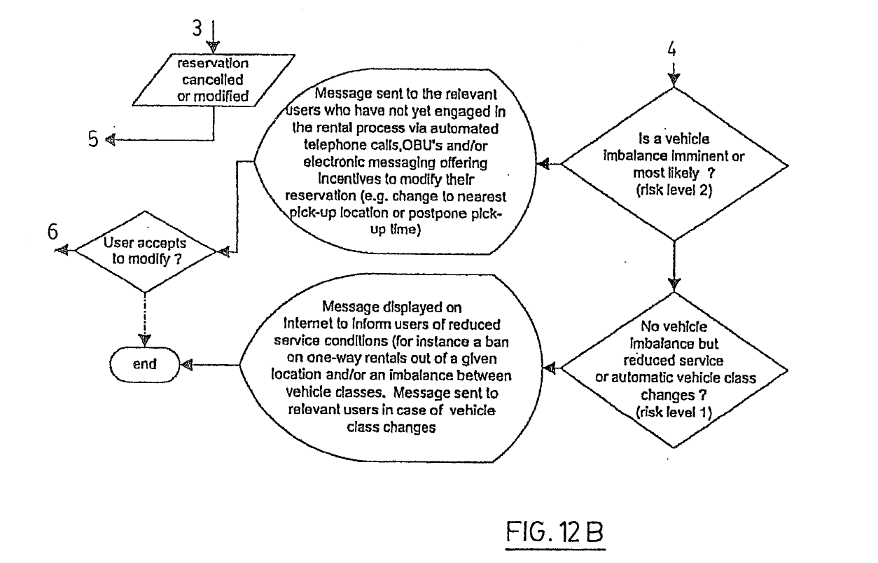

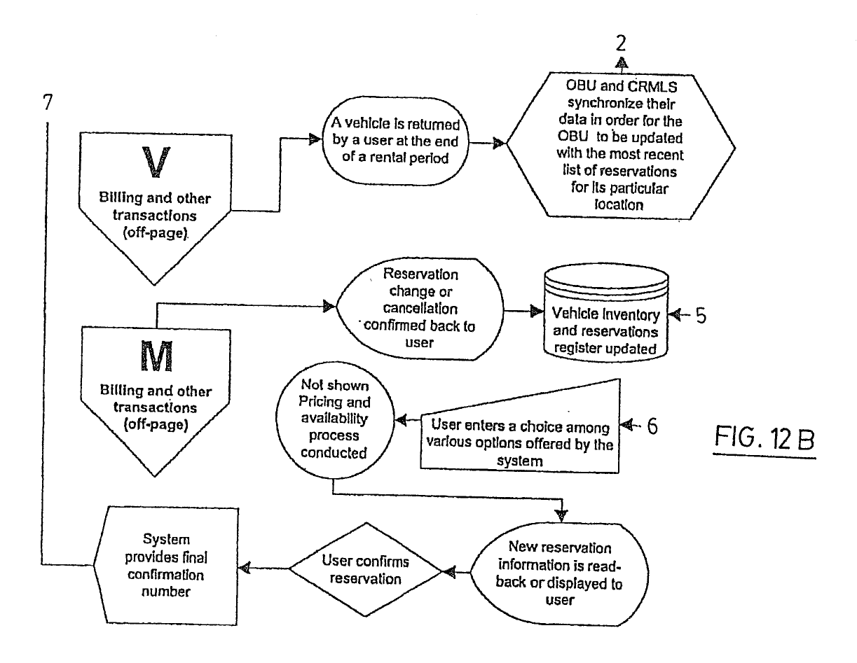

To prevent large scale-vehicle theft and invalid reservations, it is important to block users from placing multiple conflicting reservations. Therefore, it is provided that the system will compare new reservations made by a user with existing reservations previously made by same said user (See FIG. 12A). In the case where such duplications are detected, the user is automatically notified and the reservation is cancelled. Note that this rule does not apply for ancillary services as described in section 7.3.3.

6.5.5 Billing Users for Unused Reservations

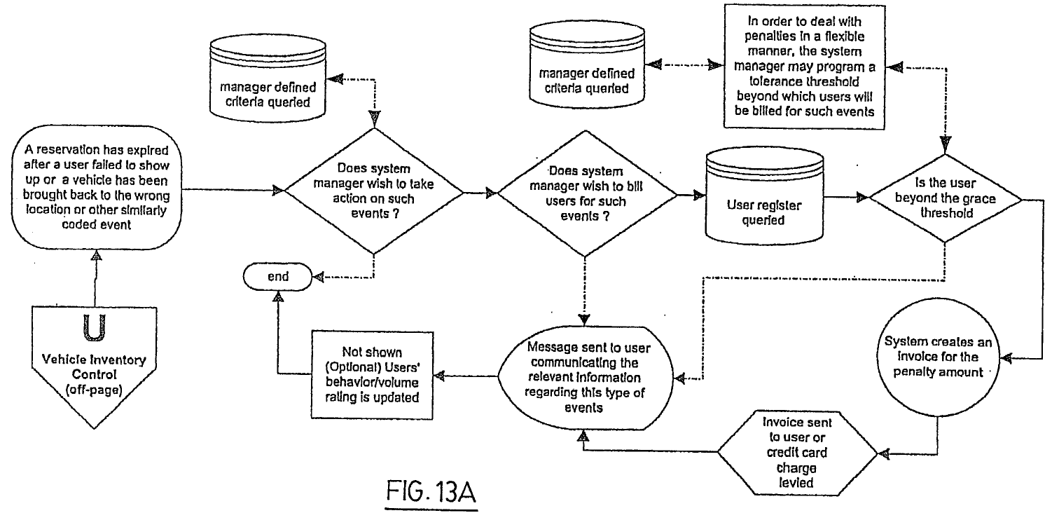

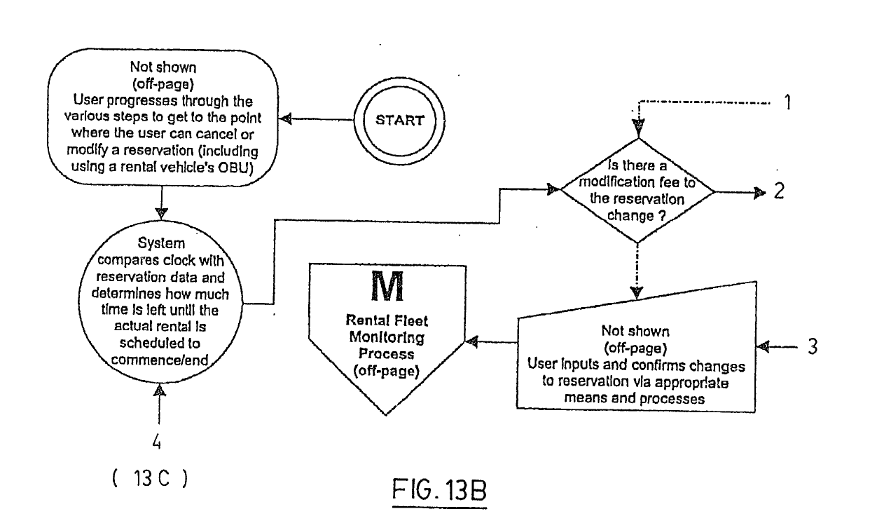

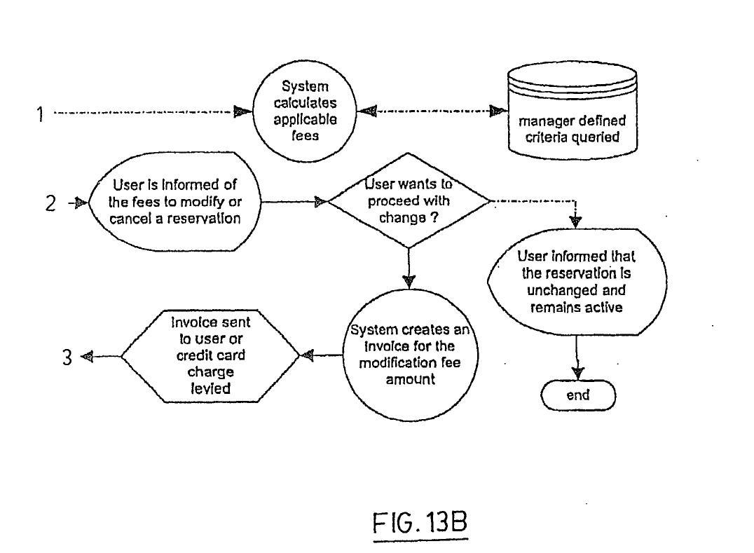

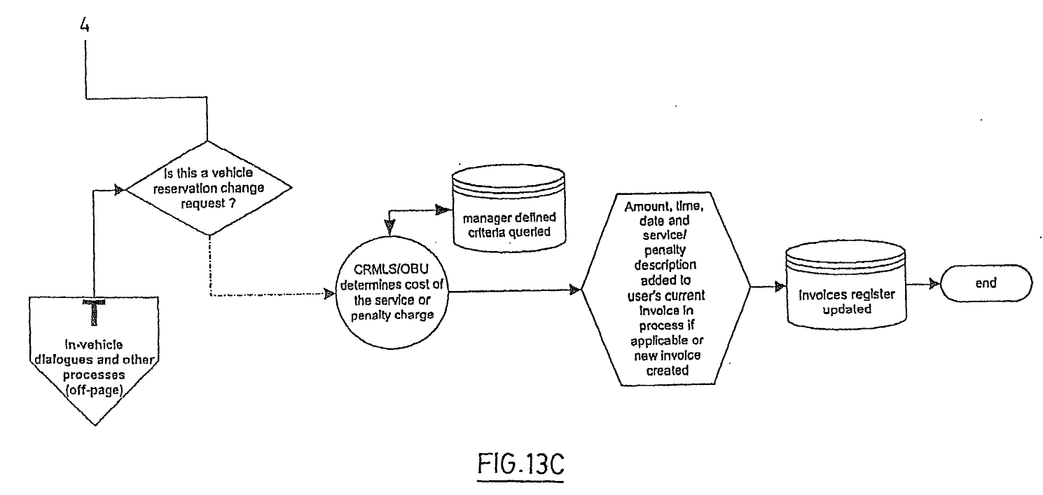

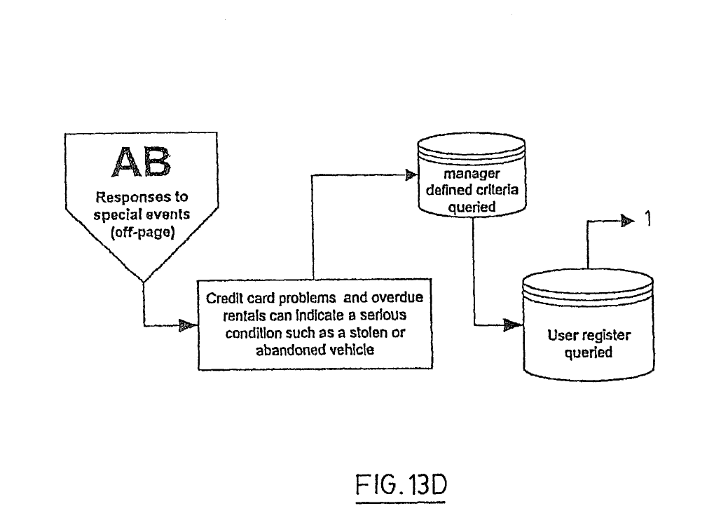

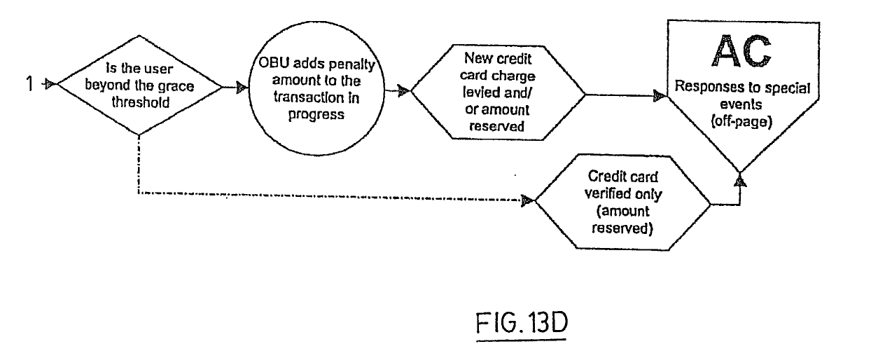

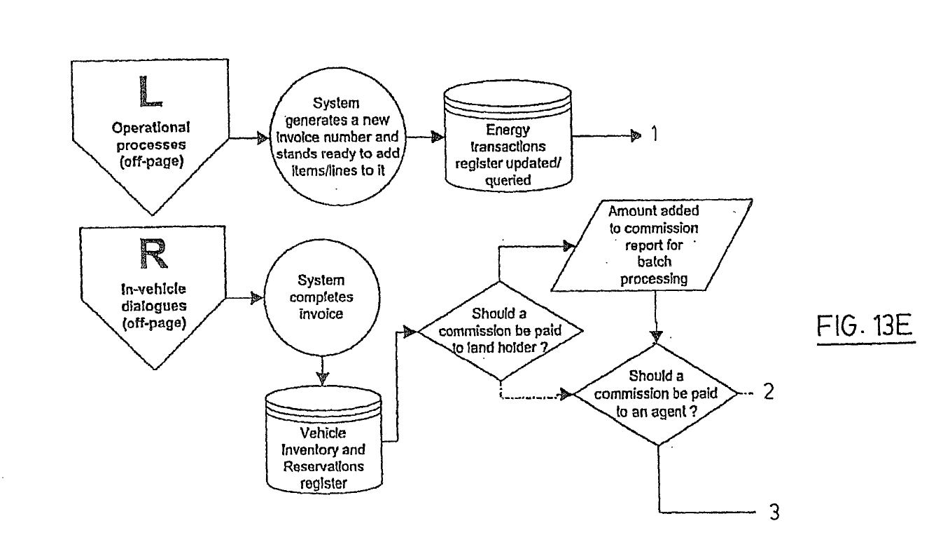

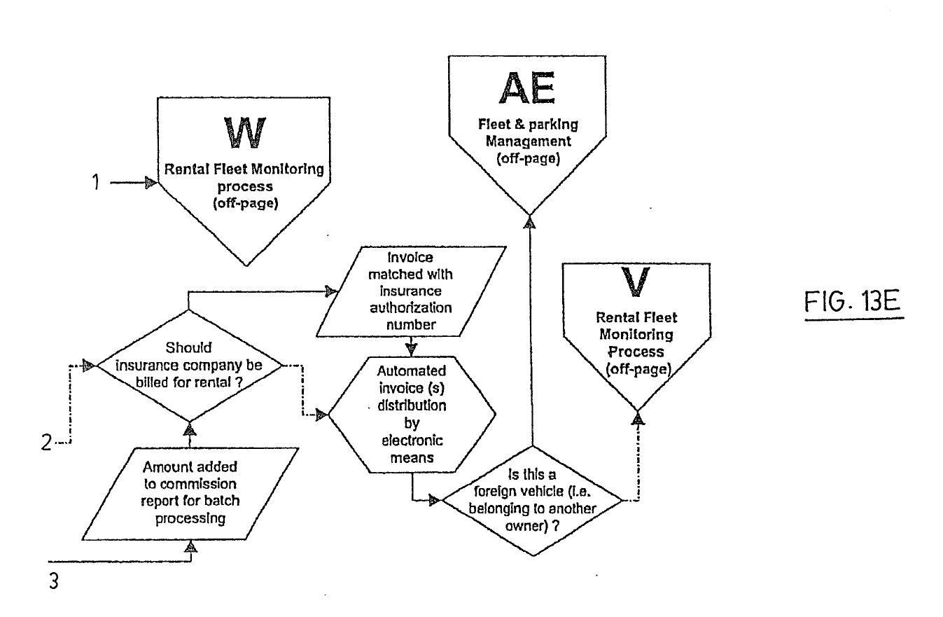

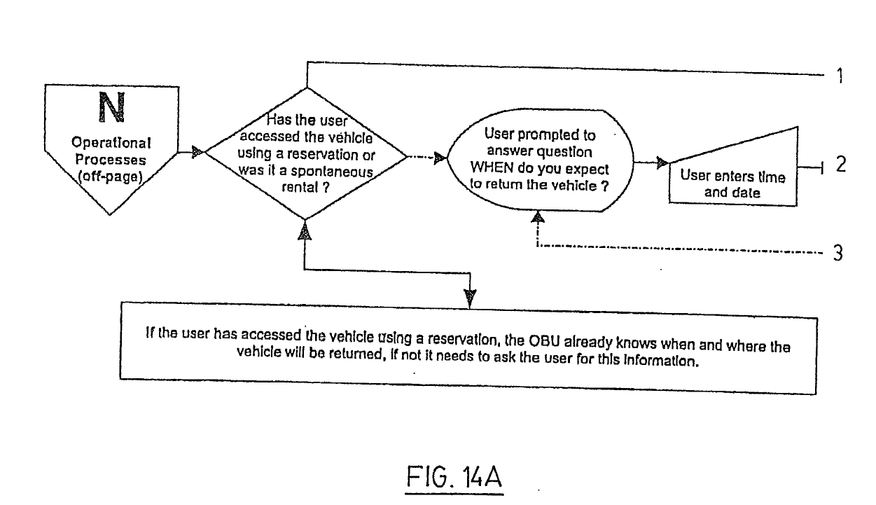

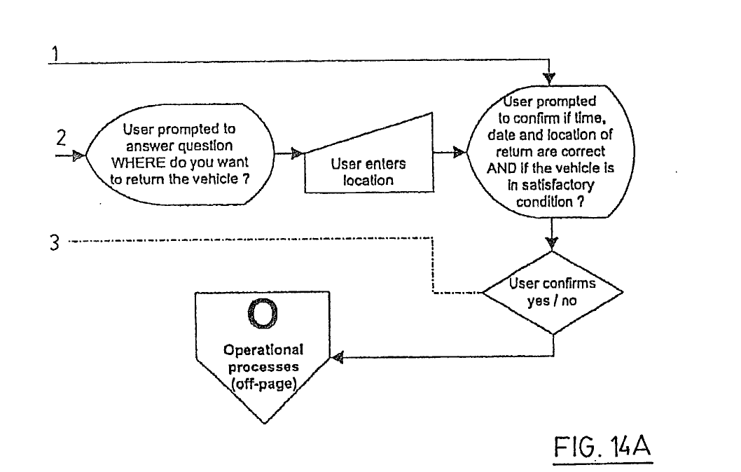

As can be seen from the various processes, a reservation made by a user can cause the system to refuse other reservations or proceed to vehicle relocations within the network. As a result, lost opportunities and unnecessary costs can be incurred when users fail to use their reservations and neglect to modify or cancel them. Therefore, the system can automatically bill and update behavior/volume ratings for users who have failed to use their reservations after a system manager defined grace period has expired. Said billing can be established based on past user track record as can be seen in FIG. 13A.

6.5.6 Allowing Users to Cancel or Modify Existing Reservations

It is provided that users may call or log into the system at any time to modify a reservation. For instance, such communication may be established directly from an OBU in a rental vehicle, an Internet-enabled device or a telephone. It is also provided that said modification can generate fees if it is made beyond a certain system-manager defined advance notice period and if the vehicle rental service provider chooses such option. FIG. 13B provides an example of such process.

6.6 Processes Prior to the Vehicle Rental

6.6.1 Random Allocation of Rental Vehicles (FIG. 6B)

In a preferred embodiment, vehicles are allowed to park at random to maximize the utilization of space and a pictogram (14) or message display (15) visible from outside the vehicle informs the user or passerby if a vehicle is available. No specific vehicle is allocated to a given reservation and reservations are treated on the basis of the vehicle class (see sections 6.8 and 7.1 for exceptions to this rule). Therefore, all vehicles within a same class at a given location are shown as available as long as there is still at least 1 vehicle available for rent (See FIG. 6B). In this manner, users can enter a parking area in no particular order and choose the vehicle that is most conveniently located or that best corresponds to their taste of the moment.

Said pictogram (14) or side-window display (15) can also be used to communicate various other information before a user accesses a vehicle such as applicable rental conditions, available services, maximum rental period allowed, one-way trip availability, equipment on board and so on.

It should be noted that the above-described allocation process does not apply to one-way inter-city rentals (6.8.8) or automated inspection scheduling of vehicles on sale (7.1.5) and that in such particular cases, a specific vehicle may be allocated to a specific user.

6.6.2 Securing Payment Before Granting the Use of Vehicles

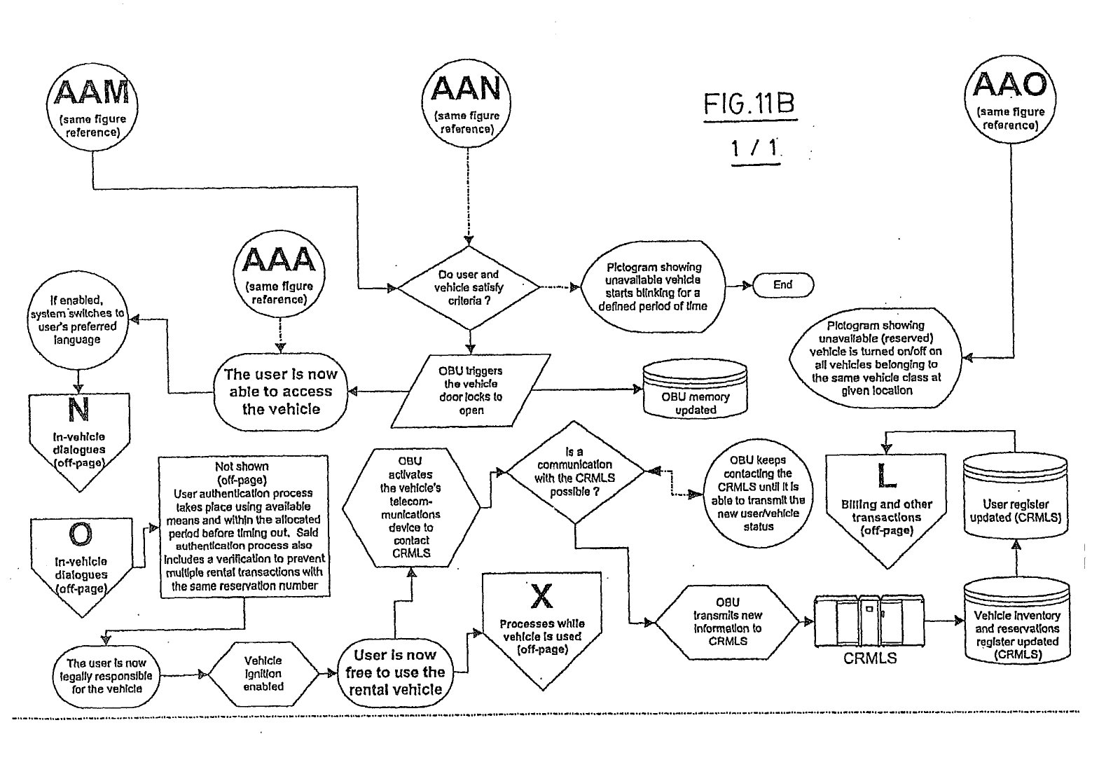

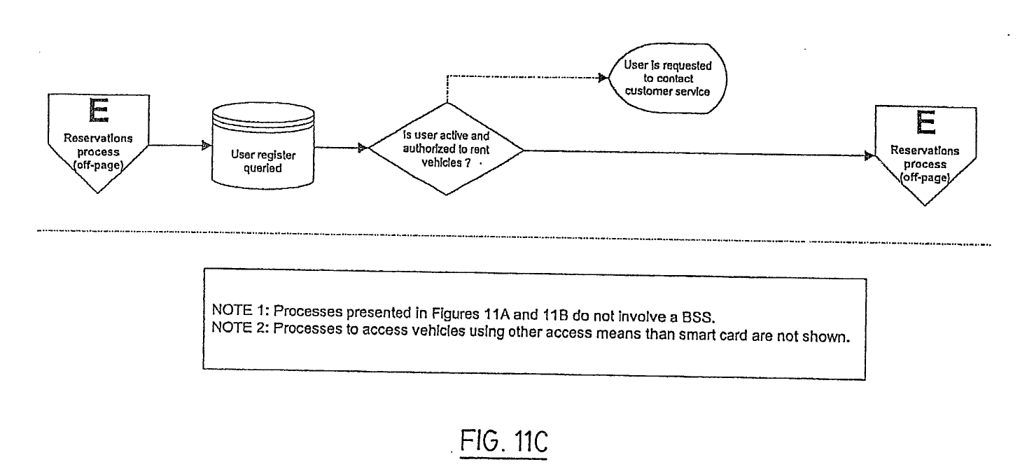

In most applications, the system deals with numerous retail users of varying creditworthiness and from which payment must be secured before granting access to a vehicle in order to protect vehicle rental service providers. Also, instruments such as credit cards and access cards can be stolen from users and it is important to prevent vehicles from being entered by illegitimate card bearers. FIG. 12A shows how such verification is made when users have an advance booking or FIG. 11A in the case of a spontaneous rental. As can be seen from FIG. 12A and in the case when the system is unable to secure payment from a user holding a reservation, said user will be notified in advance and will have an opportunity to rectify the situation.

6.6.3 System-prompted Modifications to the Demand for Rental Vehicles

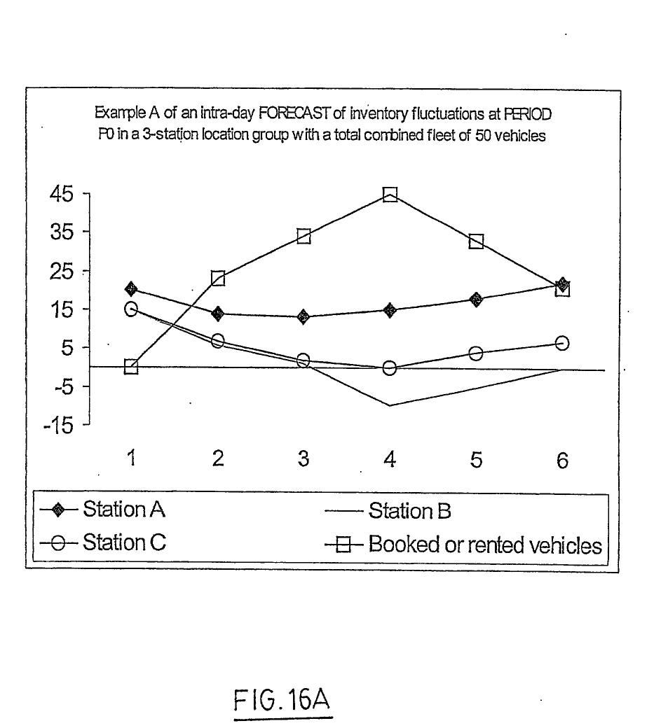

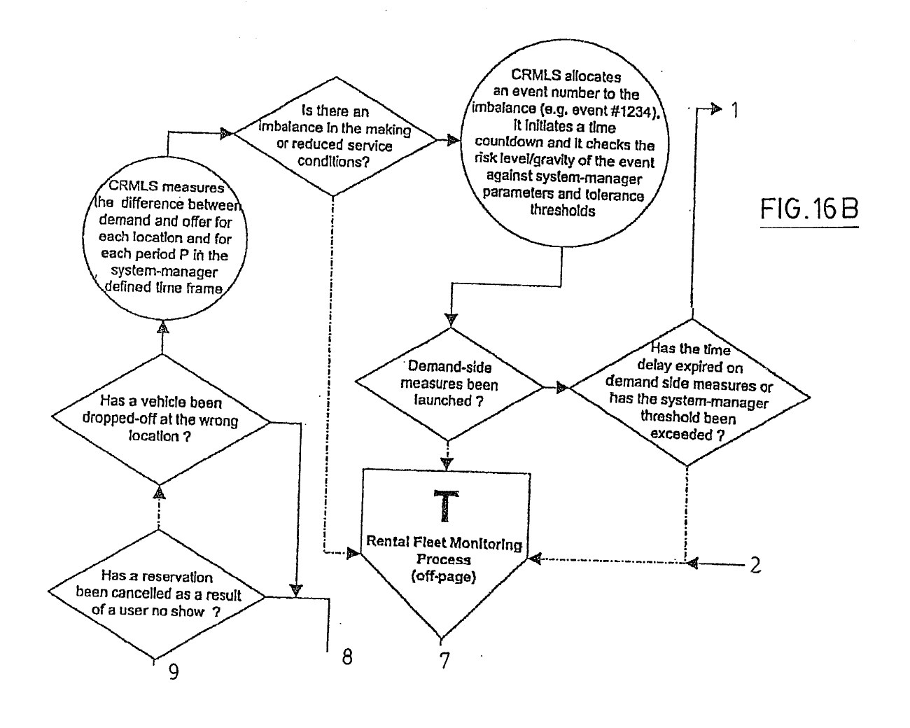

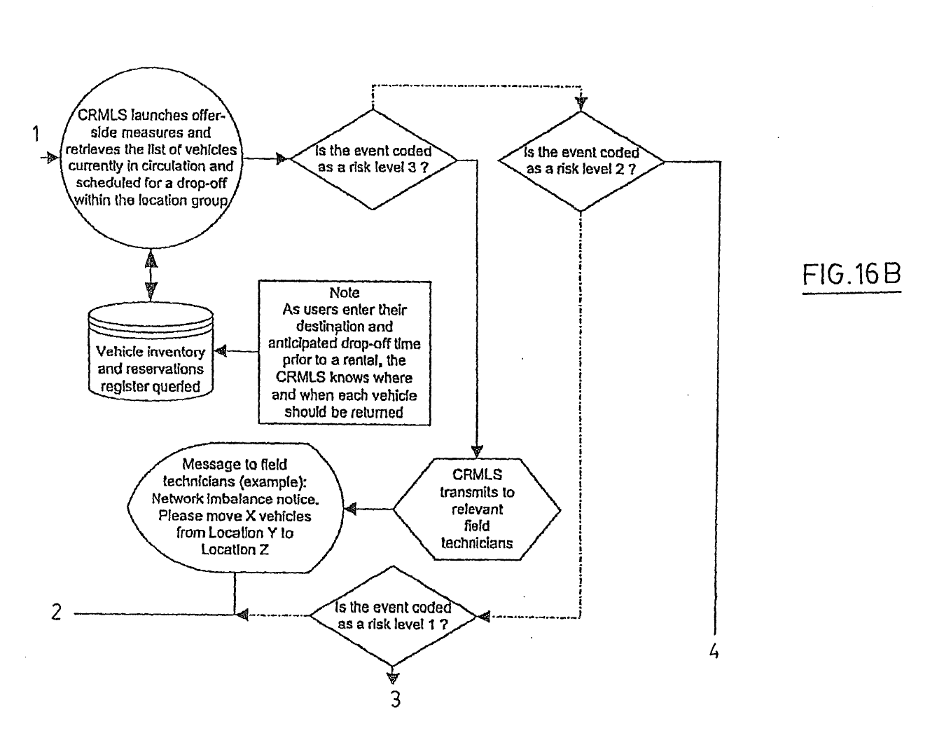

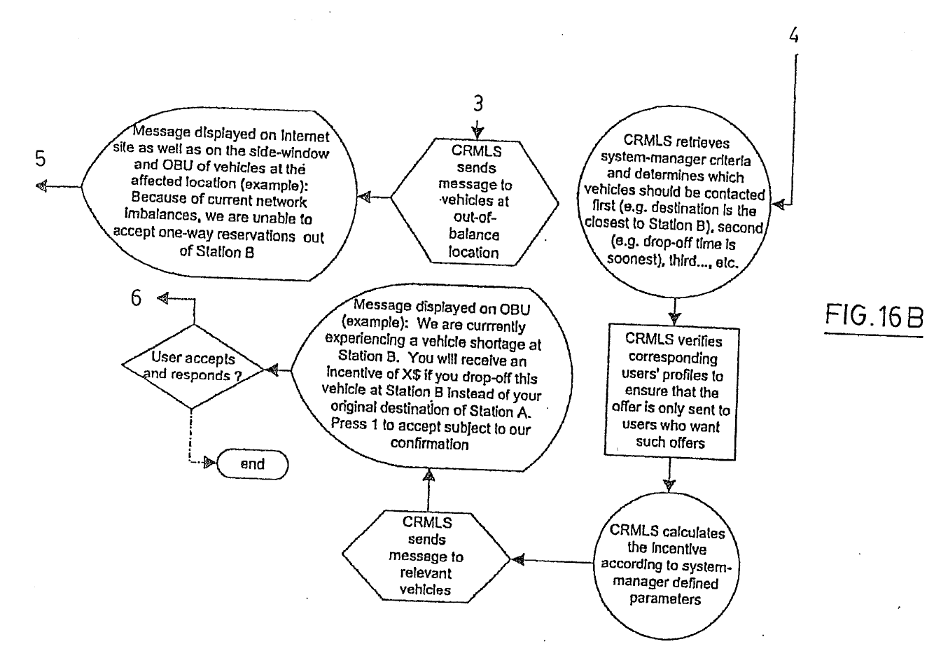

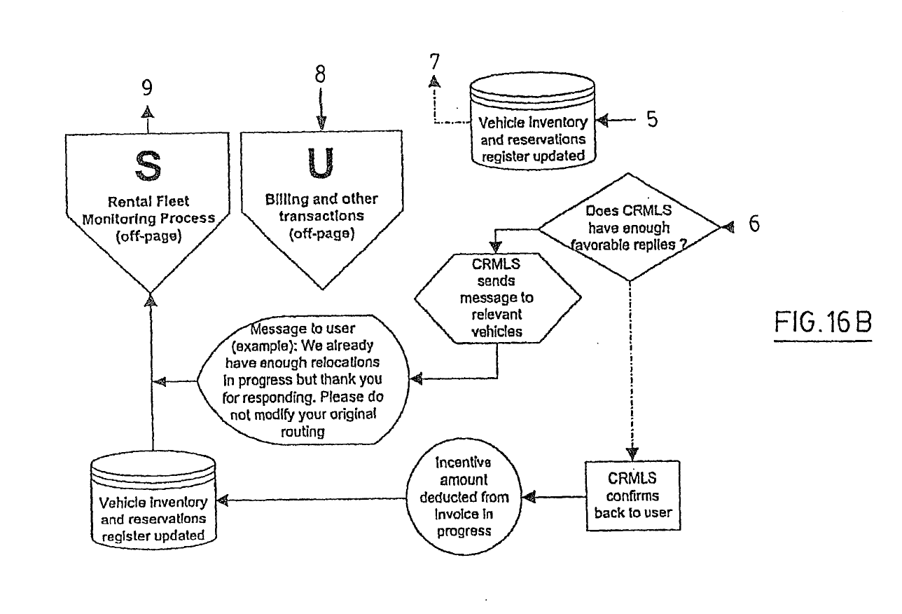

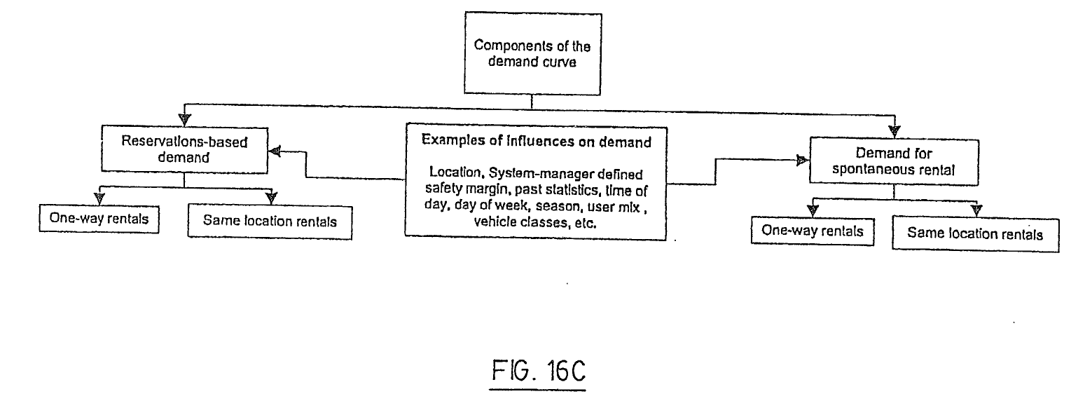

As indicated, vehicle rental systems are subject to sudden peaks in demand. As can be seen in FIG. 16A, shortages may easily occur at one rental station (Station B at period 4 in this example) even if there are several unused vehicles elsewhere in the network.

Since users come to depend very much on said rental systems, they may suffer significant consequences when a reservation is not honored or when a vehicle cannot be rented spontaneously at their preferred location. Thus, there is a benefit in optimizing the management of this process.

As will be seen further, many vehicle inventory imbalances can be avoided by taking early corrective actions but for those that cannot be avoided, there is also a benefit in informing users about the problem as early as possible.

Therefore, it is provided that the CRMLS constantly monitors the rental fleet and automatically communicates with the relevant group of users in order to provide advance warning and modify the demand for vehicles when facing an actual or imminent vehicle imbalance in the network. FIG. 12B provides an illustration of the following examples:

a) If a location is likely to experience a shortage in a particular vehicle class but has a surplus in a superior vehicle class, the user may automatically be upgraded to the next vehicle class and be notified of such minor change (30A).

b) If a location is likely to experience a shortage of vehicles in all vehicle classes, the system will post a message on the Internet to influence future reservations. Furthermore, it will send a message to the group of users already holding reservations at the affected location to offer them an incentive to postpone or modify their existing reservations.

c) If a location is positively experiencing a vehicle shortage, the system will automatically cancel the reservations it cannot honor and attempt to contact the relevant users to provide them with as much advance notice of the problem as possible.

The system-prompted modifications here described can be summarized as an attempt to reduce the gap between demand and offer by making modifications in the demand pattern for rental vehicles. As will be seen further, other methods are also used to reduce said gap by making modifications in the offer pattern for rental vehicles. Although voluntary modifications to reservations represent an inconvenience to most users, it is believed that an incentive-based method which provides alternative options is an acceptable compromise which can substantially contribute to rental fleet optimization and overall user satisfaction.

6.7 Processes During Vehicle Rental

6.7.1 Granting Access

Depending on the technology and communications network that are prevalent where the invention is deployed, users may access vehicles with any of the access means described in 6.1.2 and illustrated in FIG. 2.

It is also provided for the OBU and the CRMLS to open a communication link when a user is requesting access to a rental vehicle. This is for 2 reasons: a) to reduce the risk of illegitimate users accessing a rental vehicle and b) in order to inform the CRMLS that said rental vehicle will become engaged into a rental transaction.

FIG. 11A shows an example of the process in the case of a smart card access means.

6.7.2 Advance Verification and Instant Access for Users Bearing Reservations

Because users are often exposed to the elements while attempting to access rental vehicles and since the absence of human assistance can be intimidating at times, there is a benefit to unlock the doors of a rental vehicle as quickly as possible for legitimate users. Also, in the case where a user has already made a reservation, it is useful to spare the user from having to reenter again the information related to the rental transaction such as the drop-off time and location. Such benefits are achieved by moving most of the reservation information from the CRMLS down to the vehicle level (FIG. 11A).

As will be seen later, every time a vehicle returns to a rental location, its OBU enters into a dialogue with the CRMLS and it is provided that the system take opportunity of this communication to update both the OBU and the CRMLS. During said communication session, the CRMLS communicates the updated list of approved reservations to the relevant OBU. For example, the list of reservations for the next 24 hours at the relevant location can be stored in the OBU at that moment. As was seen in section 6.6.1, all vehicles within the same class at a given rental location should receive such reservation information since all are likely to be chosen by a reservation bearer.

In those circumstances where a reservation is already stored on the OBU's memory, the doors can be unlocked instantly to provide an improved service to the user (FIG. 11A). In those circumstances however, it should be noted that the OBU still simultaneously verifies with the CRMLS to ensure that the same reservation number is not being used twice. That would be the case for instance if a user walked from one vehicle to another and presented a smart card access means to several vehicles.

6.7.3 Access Control for Spontaneous Rental

In the case of spontaneous rental requests without prior reservations and by presenting access means such as smart cards, it is provided that the system will immediately query the CRMLS to obtain an authorization prior to granting access to a user. As explained previously, it is important for users to be kept informed of the status of their access requests during the few seconds while they wait outside a vehicle and for this reason, a pictogram display (14) or side-window display (15) will acknowledge the request in process for users' added comfort. Once the authorization has been received from the CRMLS, the doors are unlocked by the OBU (FIG. 11B).

In the case of spontaneous rental requests by using access wireless communications access means such as a mobile telephone, it is provided that the CRMLS will first conduct the verifications and then instruct the OBU of the concerned vehicle to grant access to the requesting user. During this process, the CRMLS will keep users informed as to the status of their access request via the IVR, DTMF, Internet or live operator mode that is being used.

6.7.4 Graceful Degradation of the Access Control Mode

As can be seen in FIG. 11A and in case of a network failure, it is provided that most access requests triggered by an autonomous access means such as a smart card can still be processed to prevent users from being stranded next to an inoperative rental vehicle.

In the case of access requests coming from access means that are dependent on a wireless network such as a mobile phone, a network failure or overload would effectively prevent a user from accessing a vehicle. However, it is provided that a BSS telecommunications structure can be used in areas where communications are subject to more interference or less reliable networks. As can be seen from FIG. 5B, a BSS is a semi-autonomous unit that does not depend on a third party wireless network. In most cases, it uses a combination of the PSTN and a vehicle service provider's own independent communication method such as short-range radio, effectively shielding the process from public wireless network difficulties. A simplified user register is also stored on the BSSs memories to enable the BSS to carry out the authentication process in case of a CRMLS network failure.

6.7.5 Moving Users to a Different Vehicle Class at the Rental Location

As was seen in section 6.6.3, it is sometimes required to move users to a different vehicle class (generally higher). As users may not be reached on time by the CRMLS, it is also provided for users to be informed of this change through the side-window (15) and/or pictogram display (14) from any vehicle at the relevant location. As can be seen in FIG. 12A, all vehicles within a location are always informed of all outstanding reservations and they can also display a specific message to said upgraded users to direct them to the appropriate vehicle and in their preferred language (30A).

6.7.6 Vehicle Inspection

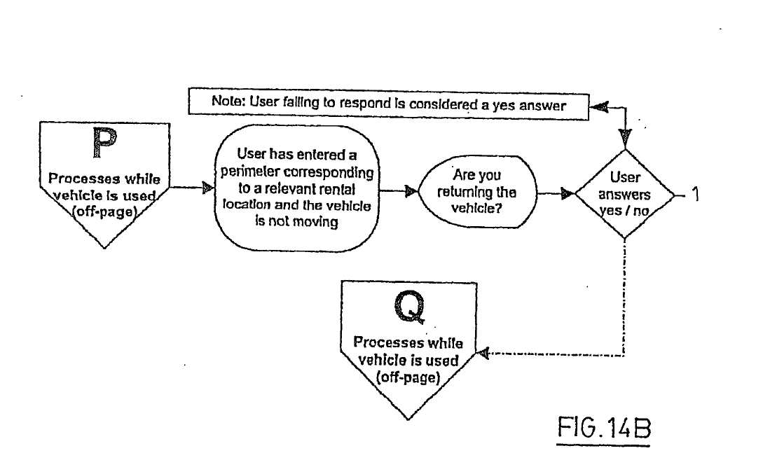

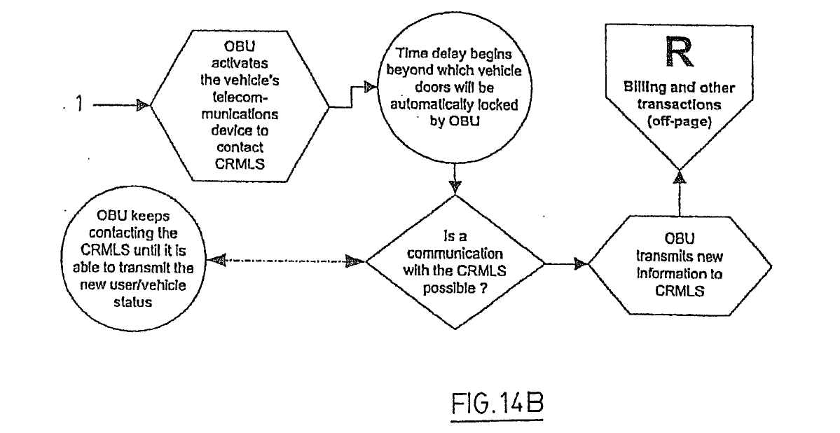

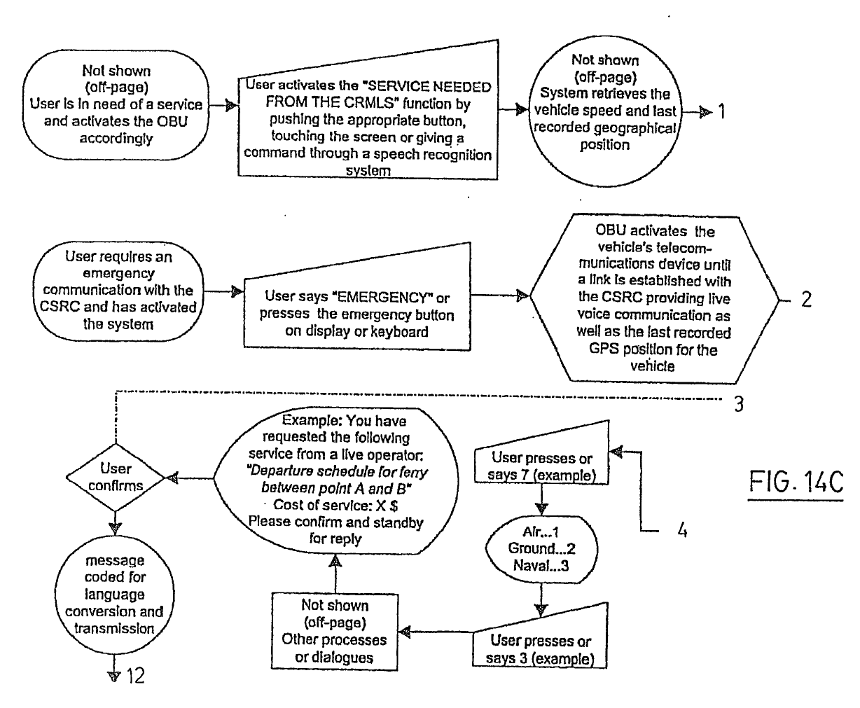

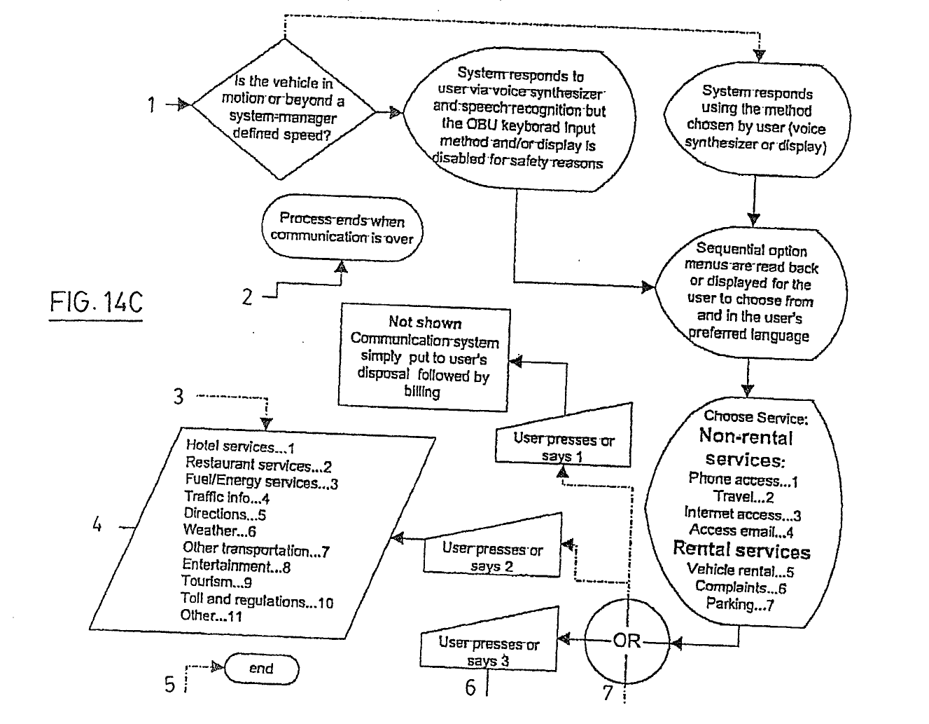

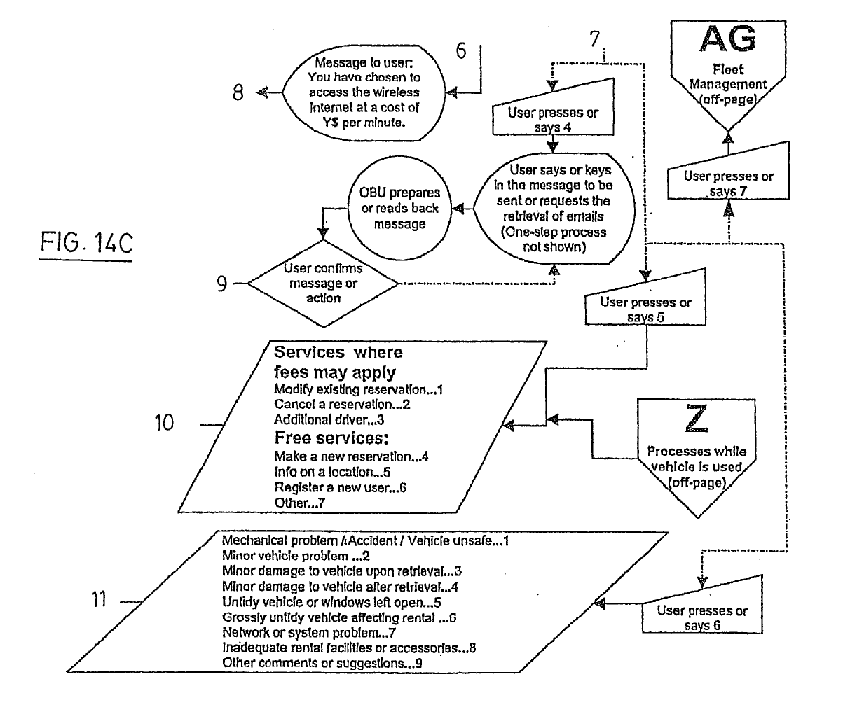

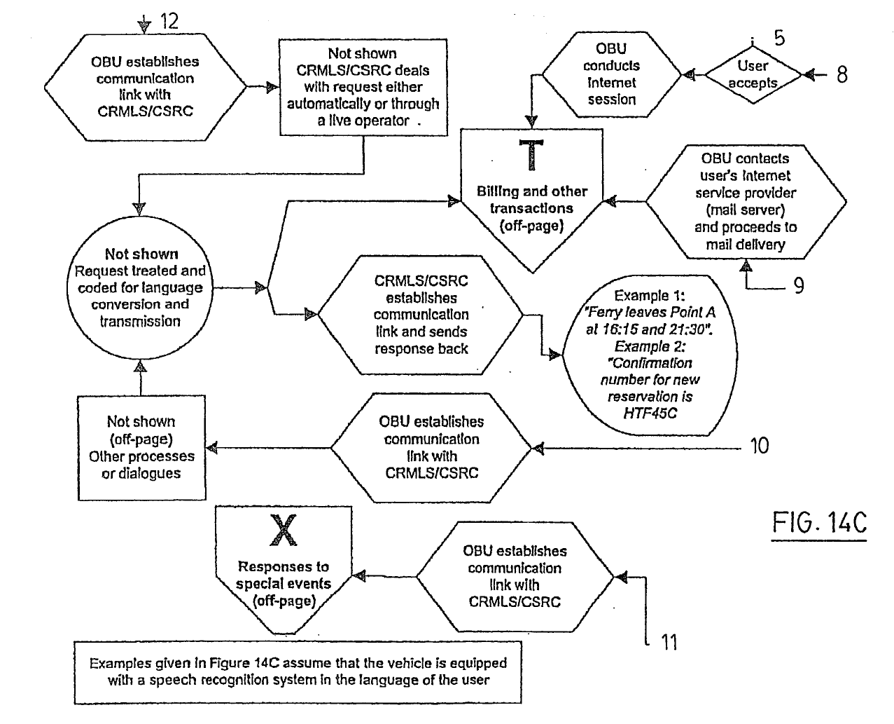

Prior to entering the vehicle and within the conditions of the general rental agreement, it is provided that the user is responsible for making a superficial inspection of the rental vehicle's condition. Such inspection is confirmed by the user (21) prior to transferring the legal responsibility of the vehicle. See FIG. 14A for process.

6.7.7 Confirming Fuel Level and Odometer Reading

As will be seen further, the system may often use reckoning methods to determine the fuel level if a universal connection with the vehicle instruments is not available. Thus and in relevant applications, the OBU requests users to enter or confirm the fuel level and odometer reading prior to the rental vehicle being released as a verification procedure (21A). As will be seen further, such confirmation is helpful in tracking down energy-related fraud (e.g. fuel theft) and in providing a proof of the user's acceptance of the fuel quantities and distance-related charges.

6.7.8 Language Adaptation for International Users

Rental vehicle users are often foreign travelers who are not familiar with the language in use within a national rental system. Because users' convenience and safety very much depend on their ability to understand the rental process, get directions, abide by local regulations or obtain services while traveling, there is a great benefit to customize any user interface to their preferred language. Therefore, it is provided that the system will request users to enter their preferred language upon registration See FIG. 8A. Due to translation costs and other legal aspects, it is also provided for users to enter a second language of choice for those circumstances where delivering the service in the preferred language is not possible. Upon registration, the system will attribute a permanent language code that will always follow the user anywhere in the world thereafter. Following the system acquisition of said language code it is provided that a language code verification routine be part of any process running on any platform, system or device in order to ensure that the system always communicates with a user in his/her preferred language. See examples of said routine in FIG. 9B, FIG. 11B or FIG. 12A.

6.7.9 Confirmation of the Rental Agreement Prior to Releasing the Vehicle

Once a user has gained access to a vehicle, it is provided that the system will prompt said user to input and/or confirm the parameters on which the rental agreement will be based such as drop-off time and location (24). Also see FIG. 14A for an example of the process.

6.7.10 User Authentication Prior to Releasing a Vehicle

It is advantageous from a security standpoint to confirm that a user's identity is genuine before finally releasing the vehicle for hire. In a preferred embodiment, the system requests that a user enters a secret code (20) or follows a personal identification process such as answering personal questions to confirm said user's identity (19). Alternatively, voice recognition (22) or fingerprint, signature or any other authentication means may be used. Upon positive authentication, the OBU (18) releases the ignition of the vehicle (23). Also see FIG. 11A.

It should also be noted that if a vehicle was accessed instantly and without a remote verification of the user and reservation with the CRMLS (See AAA in FIG. 11B), the OBU must have completed its verification with the CRMLS before releasing the ignition. The purpose of such verification is to prevent users from generating multiple transactions (starting multiple vehicles) with a single reservation, a situation that could potentially lead to confusion or large-scale theft of vehicles.

6.7.11 Securing a Credit Card Reserve

It is standard practice for vehicle rental providers to reserve a certain monetary amount on users' credit card accounts when opening a rental agreement. Such practice serves to encourage users' compliance with the rental agreement and to avoid costly procedures to recover small amounts in the case of damages to the vehicle or other disputes. Thus, it is provided for the system to make such reserve prior to the vehicle being released and to reverse it only when the vehicle used by a given user has met certain conditions. For instance, when the vehicle provider has inspected the relevant vehicle or when said vehicle has been rented again a certain number of times or for a certain period of time with no incident being reported.

6.7.12 Transfer of Responsibility and CRMLS/OBU Handshake

It is provided that once a reliable authentication method has been used that the user associated with said exclusive authentication becomes responsible for the vehicle (within the limits of the rental agreement) until the user has been discharged of this responsibility by another user or by the system manager. As can be seen in FIG. 11B, once a vehicle ignition has been released the OBU will establish a communication link with the CRMLS in order to update the Vehicle Inventory and Reservations register and launch the Rental Fleet Monitoring Process for the relevant vehicle.

6.7.13 Rental Agreement on Board

Although the vast majority of users very seldom read or use rental agreements in the normal course of their rental transactions, there are circumstances where said agreements need to be produced. As an example, some jurisdictions require drivers of rented road vehicles to hold a copy of their rental agreements in case they would need to demonstrate to authorities that they have legitimate use of the rental vehicle in their possession.

In the prior art, it is most common to prepare, manipulate, print and exchange paper documents for every single transaction regardless of the fact that those documents will usually not be used and be discarded. To avoid such waste of resources, it is provided that rental agreements can be viewed on request (26) either on the OBU's display (16) or on the side-window display (15) or on a local printer within rental vehicles if appropriately equipped. To enable such localized display or printing, the CRMLS remotely downloads a template of the rental agreement into the OBU's memory and the OBU need only merge said template with the specific information concerning the relevant user when prompted to print or display.

6.7.14 Vehicle Documents on Board

There are also circumstances where vehicle insurance and registration documents need to be accessed. In the prior art, it is common for such documents to be left in the rental vehicle or manipulated at every single rental transaction. To avoid such an opportunity for theft or loss, it is provided that vehicle documents can be viewed on request either on the OBU's display (16) or on the side-window display (15) or on a local printer within rental vehicles if appropriately equipped. To enable such localized display or printing, the CRMLS remotely downloads a template or image of the documents into the OBU's memory and the documents can be electronically retrieved at will (26).

6.7.15 Direct Voice/Data Communication and Automated Vehicle Location

There are circumstances such as emergencies when instant voice or data communication is required or desirable between the user and the Customer Service and Response Center (CSRC) (25). For this reason and if desired by the system manager, it is provided that a communication link may be established instantly with the CRMLS by pressing a single button on the OBU keyboard or display (16) or by following the complaint process as will be seen further. Upon establishing such link, the OBU transmits along the last recorded GPS position so that the CSRC may instantly and precisely locate the vehicle without the user's participation.

6.7.16 Exchanging Geo-referenced and Translated Text Messages

As the radio-communication bandwidth, personnel requirements and telecommunications costs are much greater to hold live conversations between users and CSRC than to exchange standardized short text messages, a system manager may limit the use of direct voice communications to emergencies and deal with other requests via a short message system. Furthermore, there may also be circumstances where some users are not fluent in the language(s) spoken by the Customer Service and Response Center representatives (CSRC) within a national rental system. For those reasons, it is provided that users and CSRC may exchange pre-configured text messages and that said messages be automatically converted in the relevant language so that parties may communicate more easily.

Such exchanges may be particularly useful to users who request travel information (29) or as will be seen further, for those who wish to modify and place a reservation or forward complaints to the CSRC.

It is also provided for some selected services to be automatically billed to users through this type of exchange as illustrated in FIG. 13C.

For safety and convenience reasons, it is also provided that all communications exchanges between OBU and CRMLS/CSRC are accompanied with the geographic position such as the last GPS reading in order to improve the relevance and accuracy of the exchanged information (FIG. 14C).

It should also be noted that the above-mentioned communications are made safer and greatly facilitated by the use of an optional speech recognition/voice synthesizer system as can be seen in FIG. 14C.

6.7.17 Internet Access on Board

In many circumstances, users know where to find the information they are looking for and the wireless Internet is well suited for their searches.

In those circumstances and as can be seen from FIG. 14C, it is provided that the OBU can give access to the wireless Internet by digital or voice activation.

6.7.18 Renting Air Time on the Communication System

As can be seen from FIG. 14C, users may use the communication system within rental vehicles for their own personal use and be billed for it.

6.7.19 Electronic Mail Capability

As can be seen from FIG. 8B and as mentioned in section 6.1.7, users are prompted to provide their preferred electronic mail (email) address upon registration along with the relevant connection details. Thereafter and during the use of any equipped rental vehicle anywhere in the world, it is provided that a user may automatically retrieve emails from his own preferred email address by simply requesting such service through a one-step digital or voice command. This is made possible by the CRMLS and/or the OBU having stored the user's mail server address and access methodology upon registration.

As can also be seen in FIGS. 14C and 13C, the system enables vehicle rental service providers to bill users for such electronic messaging service.

6.7.20 Registering Additional Users/Drivers on Board

A user may occasionally want to share the burden of driving a rental vehicle with one or more traveling companion(s) (in the case of a road vehicle for example). In order to allow said additional driver(s) to operate legally the rental vehicle and in cases when a full registration of the additional driver is not convenient, it is only required that minimal information be entered by said additional user/driver. Said information may comprise name and driving license number provision for past record verification or insurance purposes. To do that, the OBU enters into a dialogue with the additional driver to capture and retransmit the relevant data to the CRMLS, which in turn verifies and communicates back its authorization.

6.7.21 Showing Accruing Mental Costs During the Rental Transaction

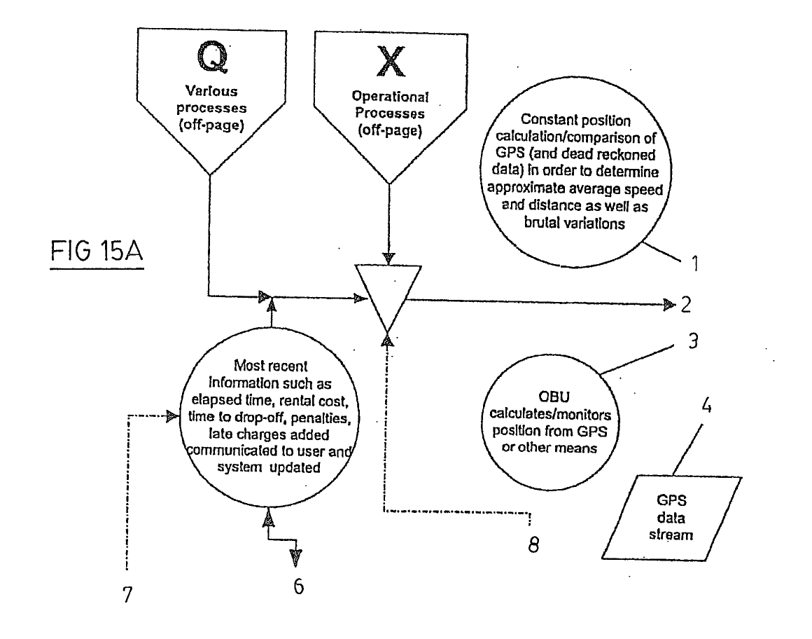

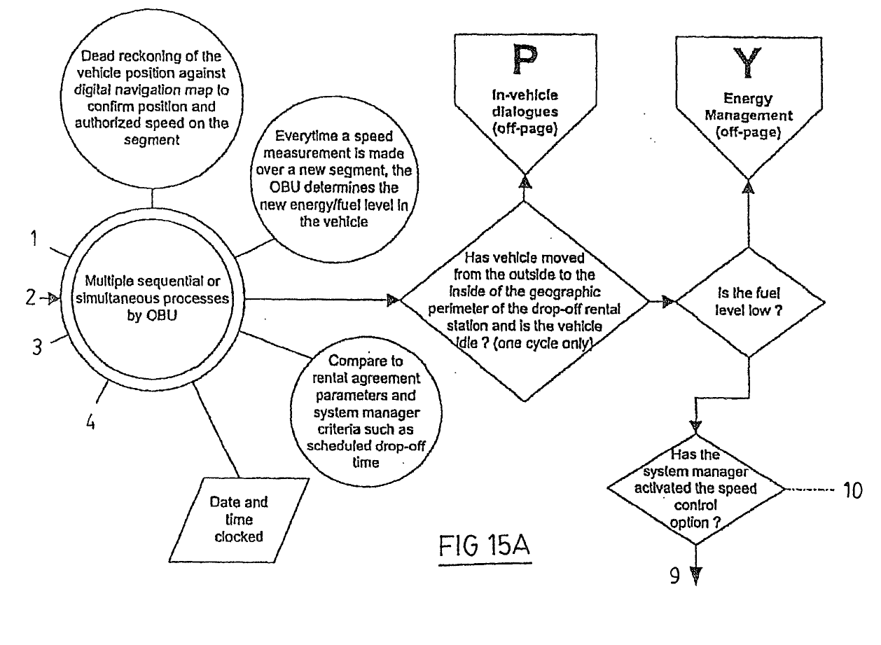

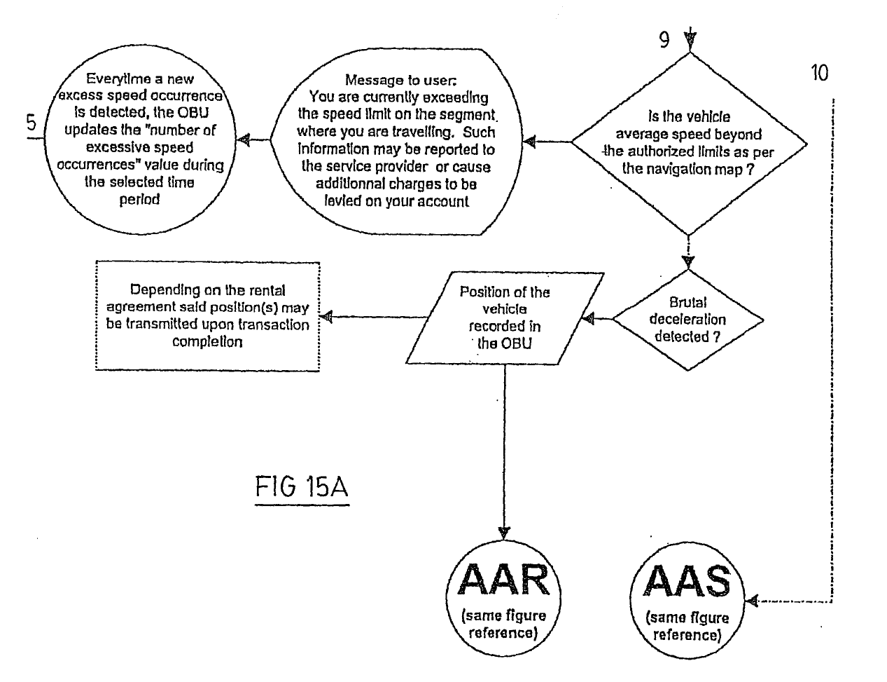

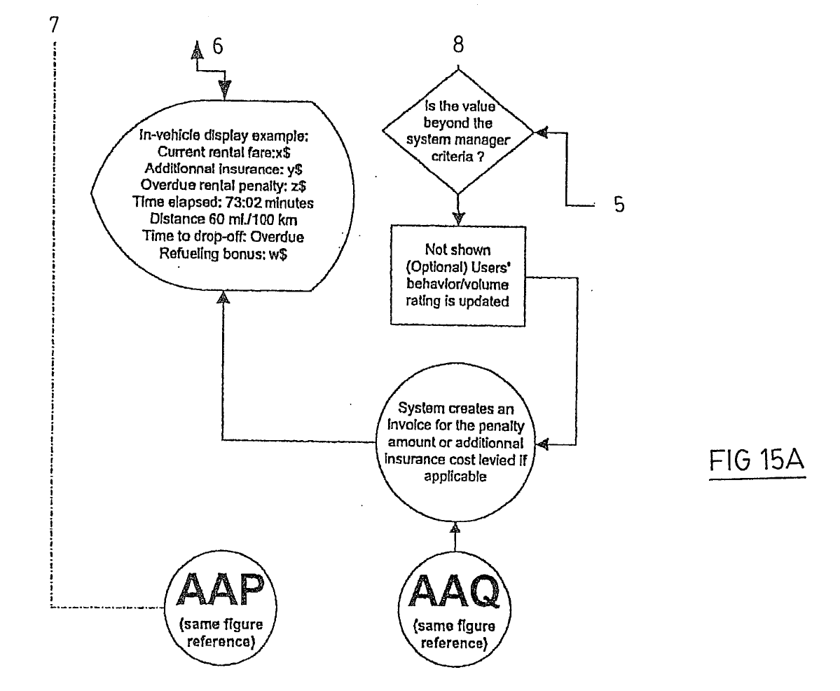

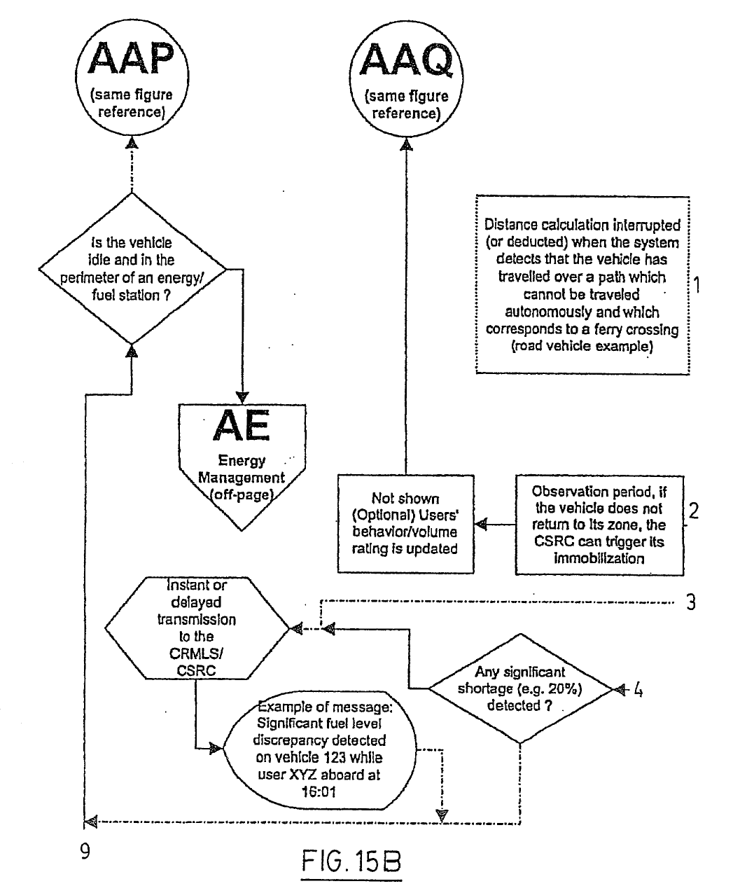

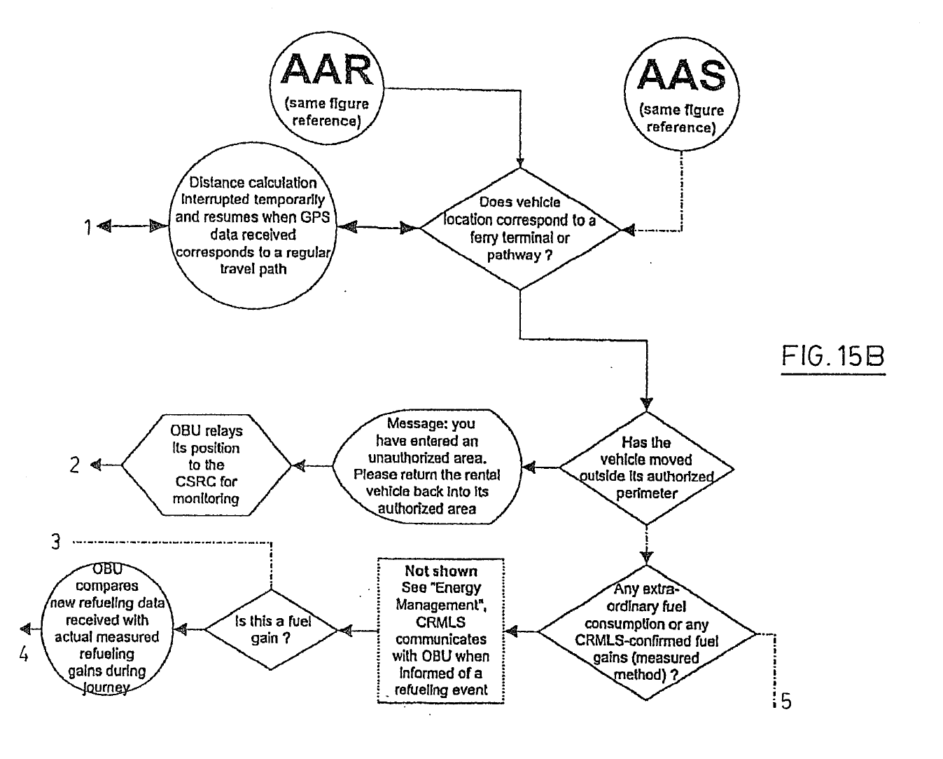

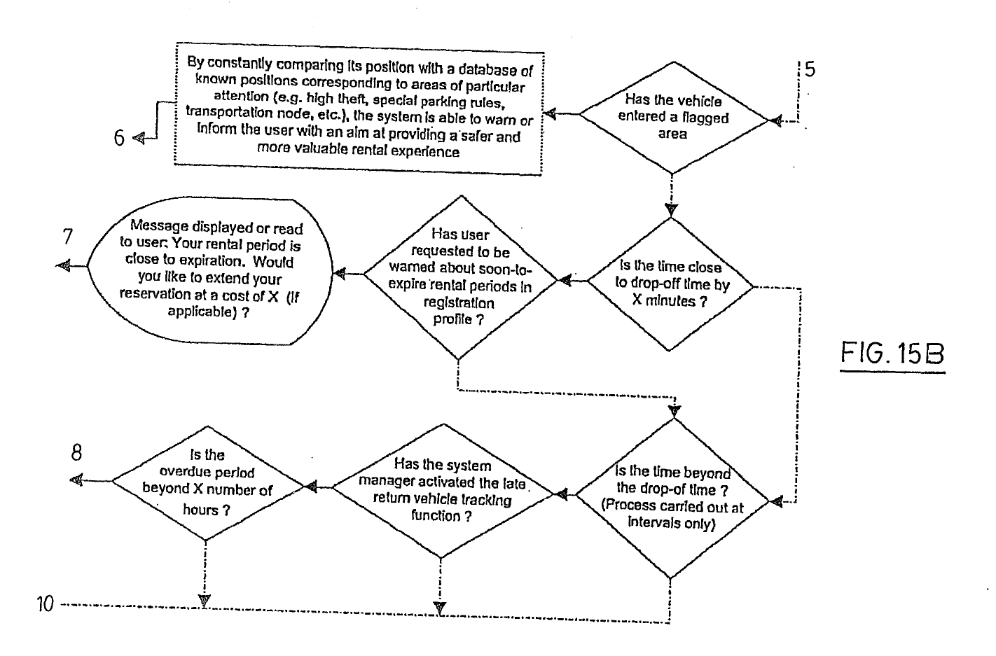

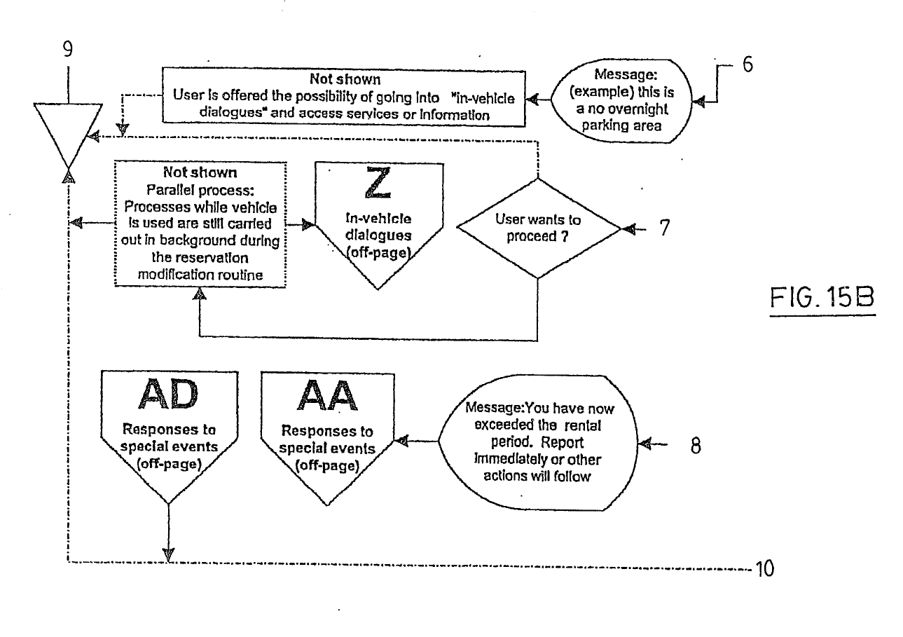

As can be seen in FIG. 15A, the OBU constantly monitors the distance, elapsed time, energy consumption and miscellaneous costs to constantly provide the user with real-time information on the rental transaction.

6.7.22 BSS Independence from the Network

In order for transactions to proceed swiftly and since most users will usually request vehicle rentals within the same geographical area. It is provided that all BSS's within a given area will be loaded with basic information on the users most likely to request services within said area. Thus, in the case of a network failure, it is provided that dramatic system shut down can be avoided and that basic rental operations can be carried out between users and service providers.

6.7.23 Real-time Monitoring of User Compliance with Schedule

It is important to ensure that users comply with their scheduled rental periods in order to optimize the use of the rental fleet and to provide for the early detection of stolen or abandoned vehicles. As can be seen from FIG. 15B the system provides for automated electronic or voice messages to be communicated on board a rental vehicle to inform users of the expiration or imminent expiration of the reserved rental period and to offer them the option of extending their rental period.

As can be seen from FIGS. 13D, 15B and 17A, the system can also be programmed to levy a penalty, update the behavior/volume rating and verify a user's credit card upon detection of an overdue rental vehicle.

Additionally and in the case of an overdue rental where the user is not communicating with the CSRC, the system locates the vehicle for the relevant authorities to intervene. As can be seen in FIG. 17A, it is provided that the OBU can immobilize the vehicle based on its own system manager's criteria and on a CSRC or CRMLS command when said vehicle is idle.

6.7.24 Requesting Time Extension or other Modifications

As can be seen from FIG. 15B, the invention also provides for users to avoid any penalty, notification or immobilization of the vehicle by reporting delays and changing their rental period. Said changes can generate a fee.

6.7.25 Geo-fencing and Tracking Unauthorized Operation

When the OBU detects an unauthorized movement corresponding to a vehicle theft, it initiates a tracking process much similar to the one described in section 6.7.23 for the service provider and relevant authorities to locate and retrieve the stolen vehicle.

Additionally, the system provides for system managers to program a perimeter within which vehicles are allowed to operate. The OBU warns users when they are exiting the authorized rental zone such as when crossing a border into a territory where the vehicle is not authorized (28). As can be seen in FIG. 15B, said action to bring a rental vehicle out-of-bound generates a monitoring from the CSRC as well as optional billing and user behavior/volume updating.

6.7.26 Geo-referenced Traveler Information

As can be seen in FIG. 15B, it is provided that the system can deliver system manager defined messages to users when entering an area of particular interest. As an example, the geographic locations corresponding to areas of high theft risk, parking restrictions, construction delays, special tourist attractions or transportation nodes can be entered in the OBU's memory and trigger said messages. As another example, a rental vehicle's OBU entering an airport perimeter could automatically display or read information to the user such as a terminal-referenced airline directory.

6.7.27 Customizing the Vehicle to Users

In a preferred embodiment and in specially equipped vehicles, it is provided that the OBU can recognize a user's preferred adjustments for vehicle accessories such as seats, mirrors and radio stations and then instruct the vehicle to adapt to those automatically. Such user-specific data can be read either from the smart card if applicable or from the user register in the CRMLS.

6.7.28 Rental Vehicle on a Ferry Boat

In order to prevent the OBU from calculating and generating a charge for the distance traveled by a rental vehicle when it is carried by a ferry boat or other transportation means, it is provided for the OBU to monitor its position in relation to such transportation means. As can be seen in FIG. 15B, the OBU continuously compares its location with its database and stops adding to the traveled distance when it recognizes that the vehicle is travelling over a corridor which corresponds to a waterborne segment or, more generally, that does not correspond to a road.

The positions corresponding to said corridors could be entered by the system manager using methods that are well known to those who are familiar with the art of digital mapping.

6.7.29 Vehicle Speeding and Suspected Accidents

Although there is a general privacy protection provided by the system to ensure that users' information is not used inappropriately, there may be circumstances and vehicle types (e.g. freight vehicles with special content) where it is justified for service providers to control the speed at which rental vehicles are operated. Furthermore, a brutal variation in speed can also be an indicator of an accident and there may be a need to associate such variations with the location where they occurred for future reference. There is also a greater consumption of energy at higher speeds and the vehicle rental service provider being responsible for the payment of said energy, there is an interest on its part to optimize the energy utilization.

As can be seen in FIG. 15A, the speed control function can be activated by the system manager and be correlated to a digital map database to determine if a vehicle is exceeding the speed limit on a given segment. If and when speed excess or a brutal deceleration is detected, the position and speed corresponding to the event will be logged and communicated to the user register at the time of return.

Additionally, a real time message can be notified to speeding users, an insurance surcharge can be levied and a modification of the user's behavior/volume rating can be performed as well.

6.7.30 Requesting and Encouraging Users to Refuel/Energize

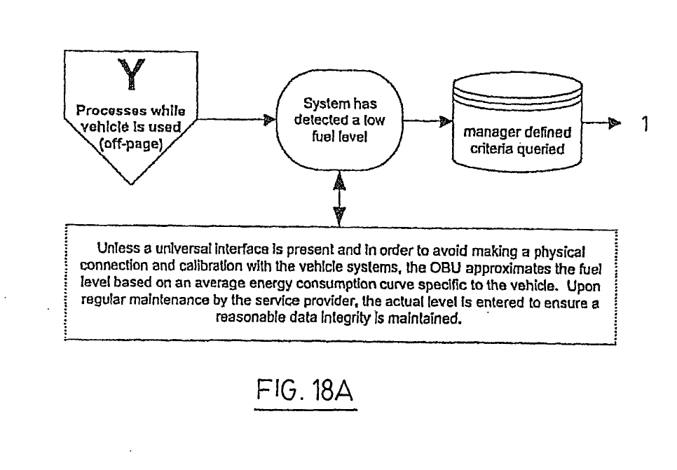

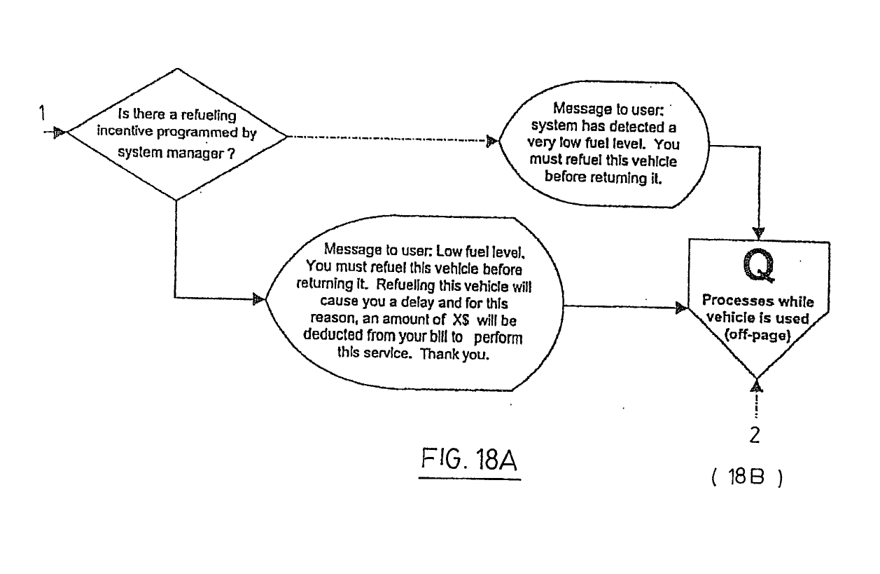

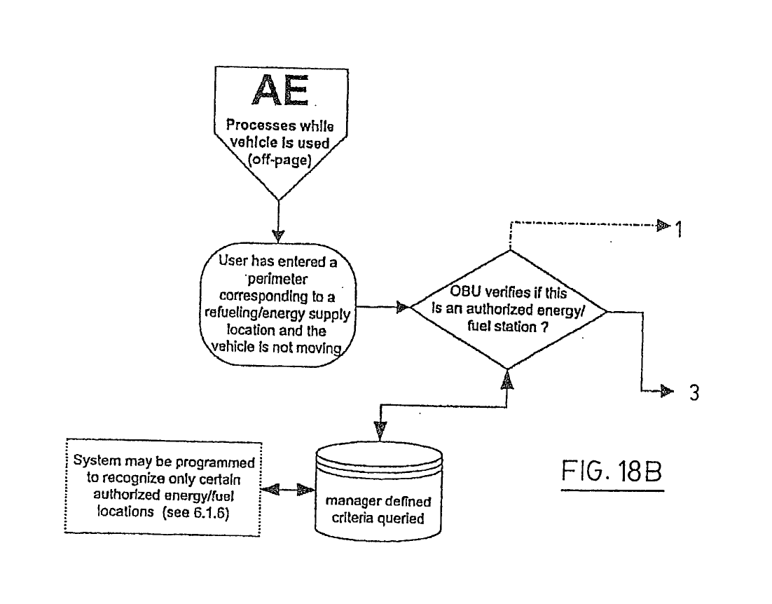

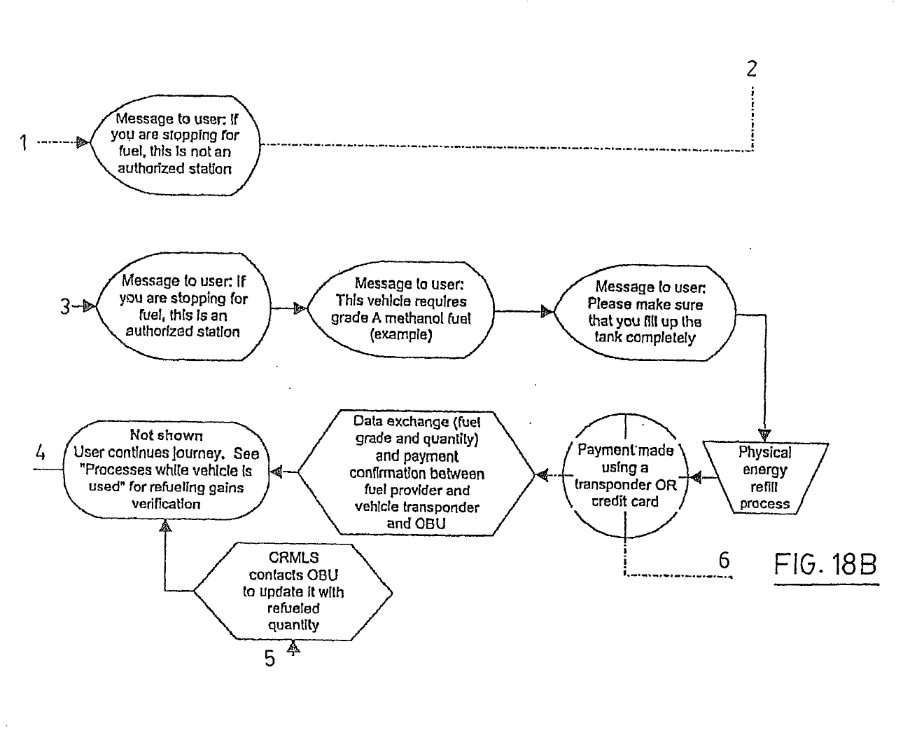

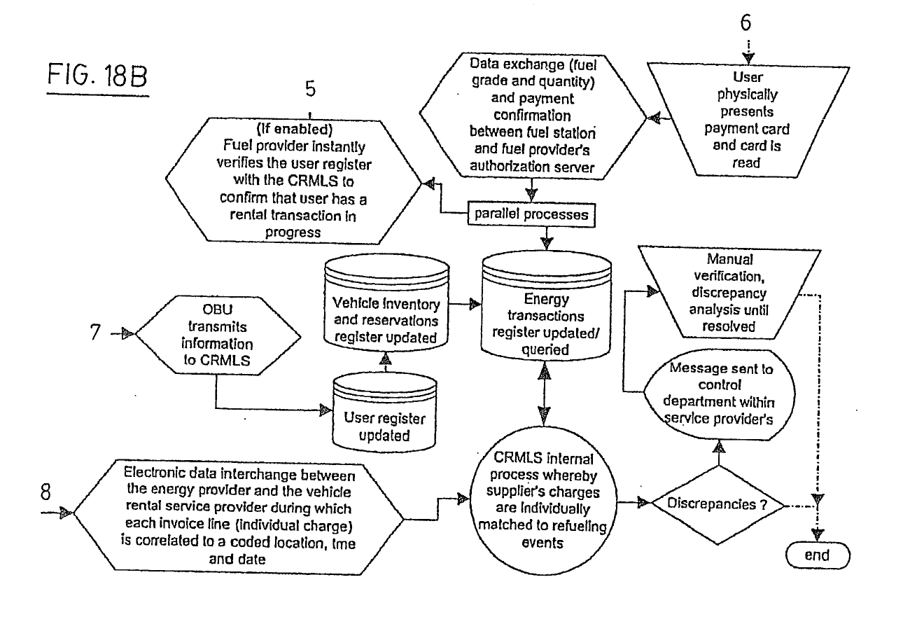

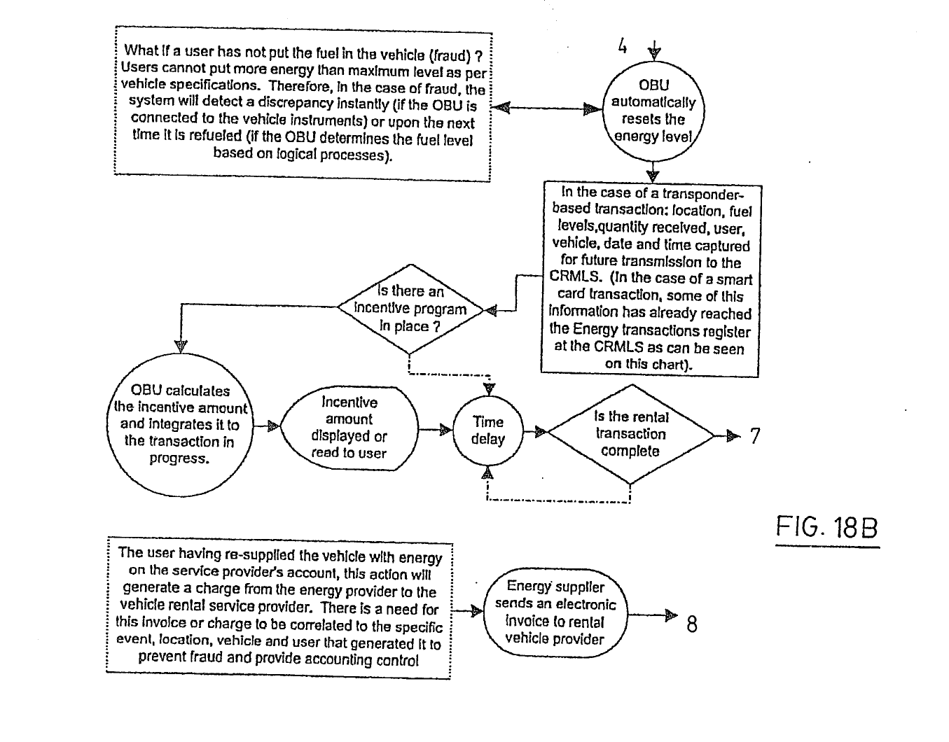

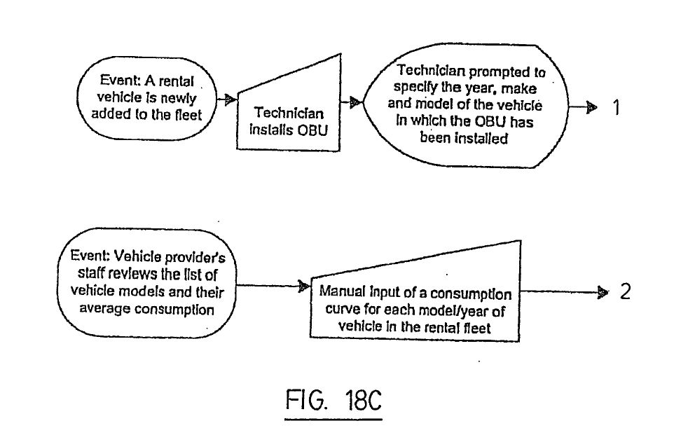

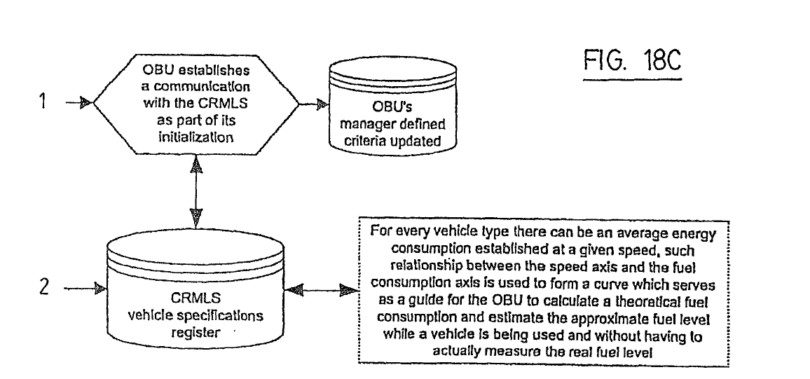

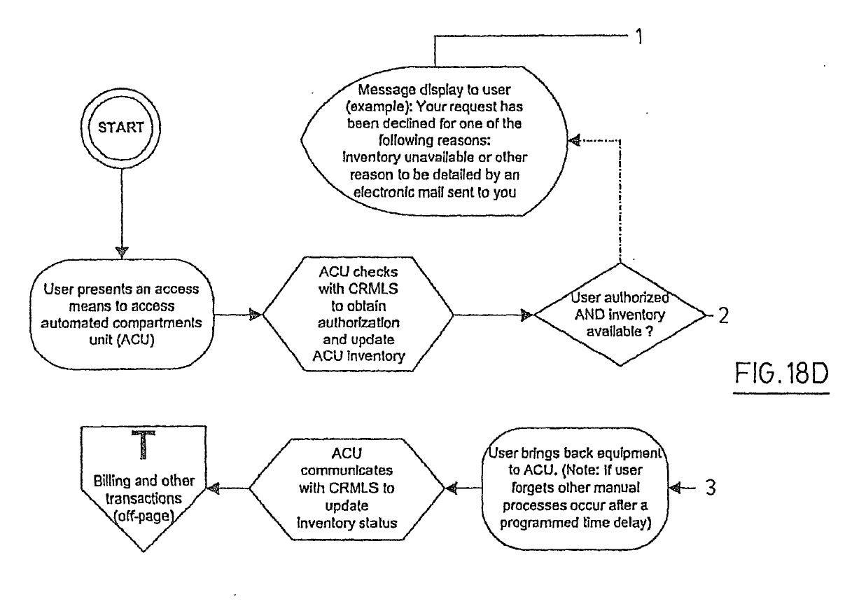

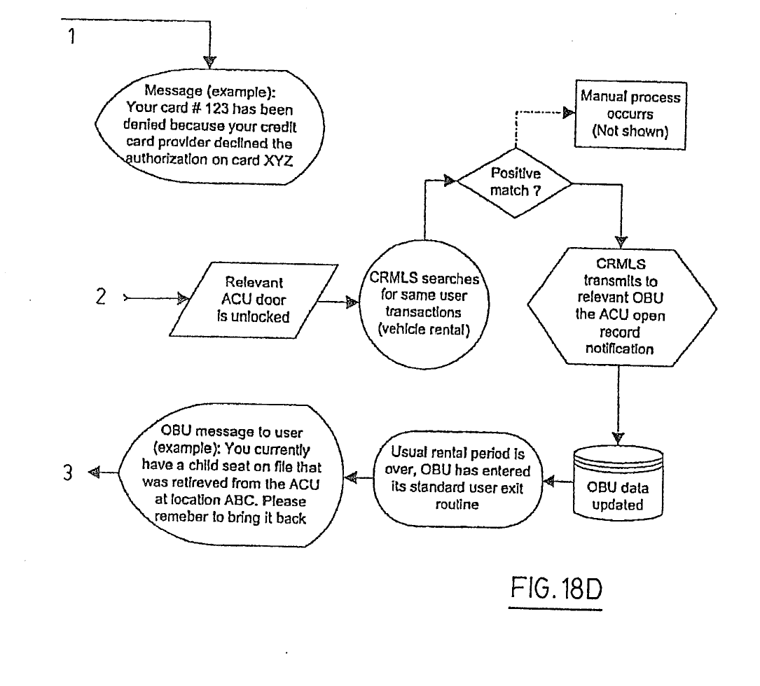

As can be seen in FIGS. 15A and 18A, the OBU constantly monitors the energy level in the rental vehicle. In the case of a vehicle equipment where the energy level can be read from the vehicle instruments (e.g. through open specifications and protocols such as AMI-C, IDB, MOST, LIN), it is provided for the OBU to obtain the exact energy/fuel level at all times. In the case where a universal interface is not available and to avoid costly calibrations, it is provided for the OBU to reckon the energy level through a logical process which computes the energy consumption at various speed levels, the energy/fuel tank capacity) and the refueling gains. It should be noted that in the case where reckoning methods are used and if the last user has defrauded the system, there is a possibility for the OBU to operate with a false fuel level measure temporarily. As will be seen further, such errors become immediately apparent and are corrected when the following user enters the accurate fuel level. Indeed, where the reckoning method is used, it is provided for the user to enter the fuel level or confirm an OBU-suggested fuel level upon retrieving a vehicle in order to track down defrauding users and defend the system integrity. In the case where perfect accuracy is needed and if the fuel level is read from the vehicle instruments, then there is no such opportunity for error but calibration or universal interface connections with the specific vehicle are required. When comparing the 2 methods, it should be remembered that absolute accuracy in fuel levels measurement is not desirable at any cost. In fact, even with direct measurements of a fuel tank, there is still a significant variance between readings depending on the inclination of the vehicle for instance. In practice, it should only be required if a rental vehicle provider wishes to invoice for fuel separately as opposed to factoring its average cost into distance and time charges.

As can be seen from FIG. 18A, when the OBU detects that the energy level is below the system-manager defined criteria in a rental vehicle, it sends a message requesting that the energy reserve be refilled. If the incentive function is in place, the OBU will display the advantage (e.g. monetary) which will be granted to the user for performing the task of refueling the vehicle to other users' benefit. Upon confirmation that the user has supplied the vehicle with energy, the OBU then deducts the applicable rebate from the rental transaction in progress to materialize the offered incentive. Such method is required because users have little incentive to refuel vehicles when they are only using them for a short period. In fact, they will have a tendency to pass this responsibility onto the next user as long as there is energy left, often returning vehicles with a desperately low energy level.

6.7.31 Entering a Refueling/Energy Station

As can be seen in FIGS. 15B and 18A, the OBU can detect when a rental vehicle is entering a geo-location corresponding to an energy/refueling station if it is programmed to do so. If the OBU recognizes that said station is an authorized service point, it can send a message to the user requesting that the vehicle be filled up completely and specifying the appropriate grade or type of energy. If said station is not authorized, the OBU will indicate to the user that it is not possible to re-supply at that service point. If desired, the OBU can also enter into a dialogue with the user to confirm the quantity of fuel and the completion of the refueling process.

6.7.32 Paying for the Energy/Fuel

In the prior art model, it is customary for users to retrieve vehicles when they are full of energy using one refueling/payment method or another. However, such methods generate one refueling action per rental, which is often an inconvenient, costly and inefficient use of time for short-distance rental customers and rental vehicle providers. The invention can also function within the prior art model but in a preferred embodiment, it is provided for the system to bill users on the basis of any distance, time or fuel combination without the need to begin each rental with a full fuel reserve. The system can either factor the cost of energy into the distance and time rental costs or, alternatively, measure the exact amount of energy used and separately charge for it. Thus enabling several users to use a rental vehicle for short distances without having to refuel said vehicle every single time.

In order to do that without burdening users with reimbursement claims, it is provided for the rental vehicle provider to be directly responsible for the energy costs and to pass those onto users through the rental transaction. As for the actual payment, there are 2 methods favored to execute it depending on the available infrastructure and the development of open standards and technology. In one embodiment, each rental vehicle is equipped with a vehicle-specific transponder (31) that can directly communicate with the energy supplier using a radio-frequency identification communication RFID for instance. In such embodiment and within the refueling operation, the vehicle and the energy station exchange payment information, fuel grade and quantity data and authorization codes between themselves. Thus, users who have been requested to refuel vehicles do not have to manipulate any document or card and the bill is sent directly from the energy supplier to the rental vehicle provider (See FIG. 18B). In a second embodiment, every single user is given a card upon registration which can be used to charge energy payments directly onto the rental vehicle provider's account (4), in a much similar way then fuel-related corporate credit cards are used by employees on behalf of their employers. Upon re-supplying rental vehicles with energy, users are authorized to present said cards for energy-related payments on behalf of rental vehicle providers.

6.7.33 One Single Card for Access and Fuel

Since users want to carry as few cards or other access means with them as possible, there is an interest in having the access card and the fuel card merged into one. It is provided for the entire rental process to be enabled from one single user card (e.g. a contact-less smart card that can trigger the doors to unlock (4) and also serve as a payment instrument using the magnetic stripe or the card's electronic chip.

6.7.34 Preventing Energy-related Fraud

Transponders and fuel credit cards are in effect credit instruments at the disposal of users to pay for items on behalf of the rental vehicle provider. Consequently, there is a significant opportunity for fraud if their use is not controlled:

List of main risks:

User putting all or portion of the acquired fuel into an illegitimate tank

User getting unauthorized items added to the energy bill such as food items.

User scheming with a fraudulent merchant to get a kickback on overpriced energy or falsified quantities.

User siphoning fuel from a rental vehicle while engaged in a rental transaction.

Credit card falsely reported lost or stolen with an intentional delay.

For this reason, a series of methods are used to make it unattractive for users to defraud the rental vehicle provider. Said methods are as follows:

Daily limits enforcement: Each card in circulation can only be used a certain number of times per day and for a limited monetary amount.

Product category enforcement: Cards can only generate charges for relevant items (e.g. Grade A fuel is authorized while food items are not).

Linking open rental contracts with energy payments: See 6.7.35.

Impossible or highly unlikely fuel consumption detection: See 6.7.36

Prolonging the credit card reserve for fuel charges: See 6.7.37

Verifying re-supply patterns against statistics: See 6.7.38

Read/write capability on the smart card: See 6.7.39

Associating users with suspicious fuel events: See 6.7.40

6.7.35 Linking Open Rental Contracts with Energy Payments

Instant method: When a user presents the fuel card for payment at an authorized merchant, it is a standard practice for said merchant to electronically verify the validity of said card and obtain a number confirming its creditworthiness for the requested amount and the type of product being acquired.

Thus, it is provided for the CRMLS to be linked to the server of the Energy Supplier or its sub-contracted financial organization responsible for such authorizations. As can be seen in FIG. 18B and upon receiving such request, the Energy Supplier's server than interrogates the CRMLS to verify that the user is currently engaged in a rental transaction and can logically be authorized to use the payment instrument. Should the user corresponding to the credit card being verified not be engaged in a rental transaction at the time or should it have acquired unauthorized products, then the authorization would be automatically denied and the attempted fraud detected.

Delayed method: If such an instant link is not possible between the Energy Supplier and the CRMLS, the Energy Supplier will still transmit the various charges regularly (e.g. weekly) and those transmissions can be made using EDI (Electronic Data Interchange) supported methods (e.g. ANSI X12 standards). It is customary for each charge to be associated with a time, date and a coded location on such electronic statements. Using a logical comparison method, the CRMLS can then compare its register of transactions with the charge and single out any transaction that is not positively matched. Through a manual action, the rental vehicle provider can then investigate and take appropriate action in case of fraud or coding error.

6.7.36 Impossible or Highly Unlikely Fuel Consumption Detection

As was seen previously, fuel theft can occur when a user siphons energy out of a rental vehicle or when the fuel acquired on behalf of the vehicle provider is not fully re-supplied into the rental vehicle. An example of this is provided by a user normally engaged in a rental transaction who would acquire fuel on the rental vehicle provider's account and physically put some of the fuel in a personal jerrican or in a friend's vehicle.

Although such fraud has limited consequences and also requires a certain amount of planning, handling and storage on the part of users, the risk is there for systematic abuse of an unmanned system if minimal control methods are not in place.

Fuel level measured from the vehicle instruments: As can be seen in FIG. 15B, it is provided for the system to detect a sudden variation in the fuel level as measured directly from the instruments. If the fuel variation corresponds to a brutal reduction, it would logically indicate a theft by siphoning and trigger a warning message to the CSRC. Likewise, if the fuel variation corresponds to a gain, it would logically indicate that the vehicle has been refueled, thus enabling a highly accurate comparison between the energy provider's stated quantity and the measured fuel gains and again contacting the CSRC in case of significant discrepancy.

Fuel level reckoned from logical processes: However, in the case where reckoning methods are used to avoid cabling and calibration, it is provided for other methods to be used to prevent blatant fuel theft.

A returning vehicle's fuel level should logically correspond to the initial level when the journey began, minus the actual or estimated quantity of fuel consumed during the journey plus the refueled quantities (losses such as evaporation notwithstanding). As the fuel consumption during a rental transaction can be estimated fairly accurately and as users provide a confirmation of the fuel level reading when beginning a rental transaction (see 6.7.7), the OBU can easily compare the stated fuel levels against the expected fuel level and signal any significant discrepancy.

Although it is known that road surface, traffic conditions, vehicle payload, terrain, weather, use of accessories such as air conditioning and aggressive driving behavior do have a significant impact on consumption, the order of magnitude of such variance is still relatively limited. For instance, in the case of light-duty vehicles such as automobiles, there is credible evidence that the combined impact of aggressive driving behavior and air conditioning on fuel consumption does not exceed 30%¹ even in the worst scenarios and is generally in the 10% range of variance². Thus, the OBU could be programmed to report variances in excess of 50% to the CRMLS, providing plenty of room for varying conditions of use. Now it should be noted that although such tolerance margin may seem easy to abuse, it is in fact quite effective when related to the actual quantity of fuel that could be stolen without detection. First of all, one should bear in mind that in order to steal fuel without detection, a user needs to open a rental contract and pay for it (as opposed to a simple break-in crime against which there is no more protection than for any other vehicle in circulation). Secondly, fuel/energy theft is a relatively cumbersome and petty enterprise and a significant quantity must be stolen for fraudulent users to gain from it or for the vehicle provider to suffer material consequences. Using the example of a vehicle with a fuel reserve of 17 US gallons or 65 liters and a consumption of 23 miles per gallon or 10-liters/100 km, the average autonomy of the vehicle would be 400 miles or 650 km. Should a user wish to steal a mere 4 gallons or 16 liters of fuel from a vehicle, he would need to pay for a rental vehicle over a distance of 200 miles or 325 km in standard conditions for the theft to go unreported³. Thus, such approximate method based ¹ See United States Environmental Protection Agency, Air and radiation, EPA420-D-99-002a, March 1999, pp. 20-22. ² See European Conference Of Ministers of Transport (ECMT) Workshop on In-Car technology, Delft, 1996 Dr. J. Vancke: Techniques for Influencing Driving—The Driver's view. pp.2-4. ³ At 50% of the vehicle's autonomy, the standard consumption is 8.5 gallons or 32.5 liters. A 50% tolerance level would enable the fraudulent user to “show” a 12.75 gallons or 48.75 consumption at that point, providing an opportunity to steal approximately 4 gallons or 16 liters without being detected if the vehicle has been driven in standard conditions. on reckoning still provides for effective deterrent against most forms of systematic and significant fuel theft.

6.7.37 Prolonging the Credit Card Reserve for Fuel Charges

As an additional fraud prevention method, it is provided for the system to maintain the credit card reserve on a given user's credit card (see section 6.7.11) until the fuel charges authorized by said user have been reconciled and approved as legitimate.

6.7.38 Verifying Re-supply Pattern against Statistics

As can be seen in FIG. 18A, users should normally refuel vehicles when prompted to do so by the system (See section 6.7.30). There may be cases where users will volunteer to refuel vehicles without incentive, for example users that are particularly prudent and like to have a full fuel reserve before a long trip. However, frequent refueling may be a sign of fraud and the system detects abnormal re-supply patterns such as refueling vehicles much more often per traveled distance than the average user (ex: 50% of rentals result in a refueling operation for a given user Vs a 10% average). Although a rare occurrence, the opportunity for merchants to collude with users to exploit an automated system must also be controlled. Thus, the system can also signal suspicious same location refueling patterns as defined by the system manager to assist in fraud prevention activities.

6.7.39 Read/Write Capability on the Smart Card

Smart cards have the ability to be read from and written onto as a result of a dialogue through an electronic antenna and it is possible for the rental process to require users to present their smart cards both upon entry and exit to complete a rental transaction. As a substitution to the methods described in section 6.7.32, it is possible for an OBU to activate the fuel charge function on a smart card upon the beginning of the rental transaction. Similarly, the OBU can deactivate said smart card's fuel charge function when the user is signing off electronically at the end of a rental transaction, thus ensuring that users only charge fuel on the providers account when they are engaged in a rental transaction. Furthermore, it is also possible for smart cards to be uploaded with electronic money provided the necessary protocols and administrative agreement exist between the vehicle provider and the Energy supplier.

6.7.40 Associating Users with Suspicious Fuel Events

As was seen in sections from 6.7.34 to 6.7.38, fraud prevention methods signal suspicious events or discrepancies and said suspicions may be unfounded or merely the result of coincidence. However, the probability of fraud significantly increases when said suspicious events are repeated. Thus, it is provided for the system to register each event in the relevant user file and to trigger a warning when the number of events reaches a certain manager-defined level (e.g. 3 suspicious events within 25 rental transactions).

6.7.41 Complaint Management

Users can forward a complaint, comment or suggestion to the rental vehicle provider at all times using the OBU (FIG. 14C) or the Internet. Such complaint mechanism can be used to report mechanical problems or untidy vehicles for instance. As can be understood from FIG. 17B, the complaint mechanism's main purposes are to:

provide faster reactions to dangerous or unsatisfactory conditions

compensate users for degraded service conditions

channel users' comments constructively in a multilingual environment

discourage delinquent behaviors through peer-conducted verifications

guide and structure the field personnel's maintenance interventions

6.7.42 Live Communications in case of Emergency or Mechanical Problems

As can be seen in FIG. 17B, it is provided for the system to automatically establish a voice communication between the user and a live operator in the CSRC in order to provide a near-instantaneous response to incidents that are coded as a high-priority such as accidents, major damages or unsafe vehicles.

6.7.43 Removal from Inventory

As can be seen in FIG. 17B, vehicles that are the subject of a complaint are automatically removed from the pool of available vehicles.

6.7.44 Automatically Directing Users towards the Nearest Replacement Vehicle

In the case where a user encounters sub-standard conditions upon or during a rental transaction, it is important from a customer service standpoint to offer said user alternatives as quickly and reliably as possible. For instance, if a user has unfortunately rented a malfunctioning vehicle, it is important to provide said user with a replacement vehicle as soon and as near as possible. As was seen in section 6.7.15, the system is equipped with an automated vehicle location function or AVL. Thus, it is provided for the CRMLS to compare the position where a relevant complaint comes from with a digital map of locations and the Vehicle Inventory and Reservations Register in order to find the nearest available vehicle. Upon, completion of such process, the information is sent directly into the vehicle for the user to review and accept or reject. Upon acceptance, the CRMLS automatically sets a vehicle aside at the selected location and provides directions to the user through the OBU.

6.7.45 Coded Field Reports Delivered through the Internet

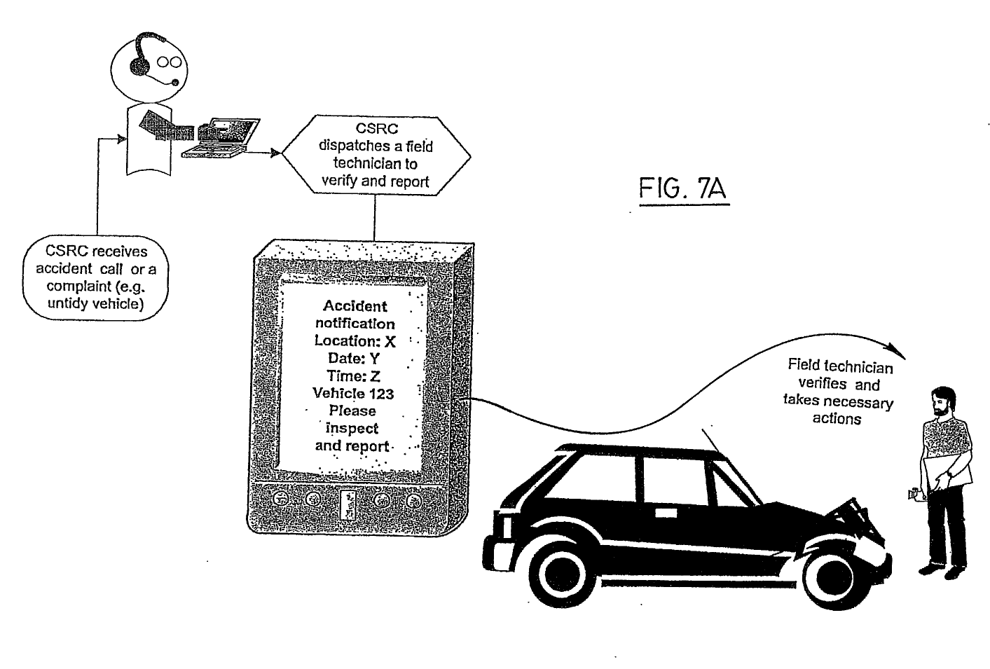

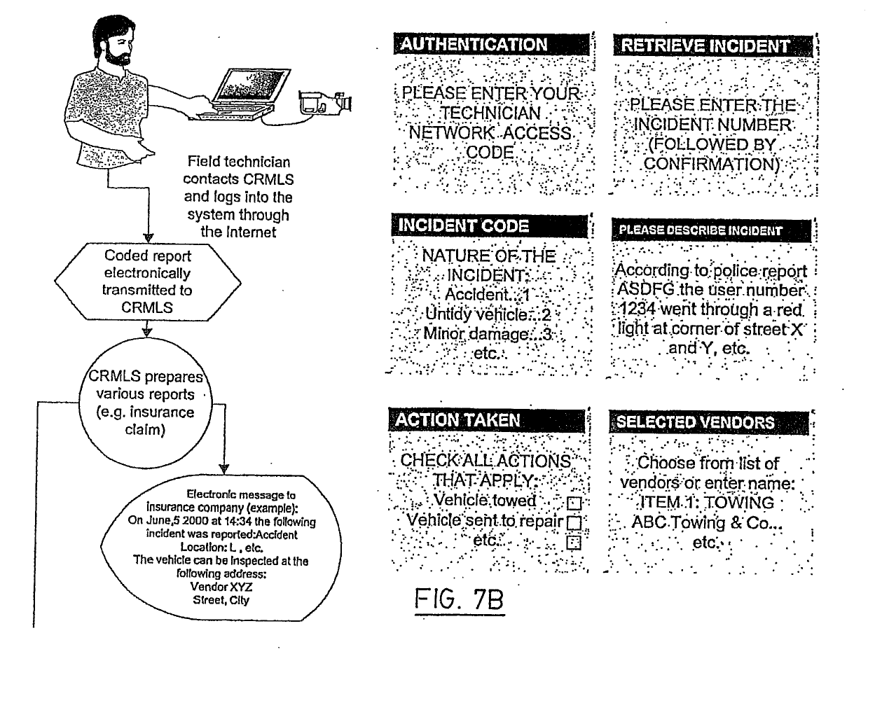

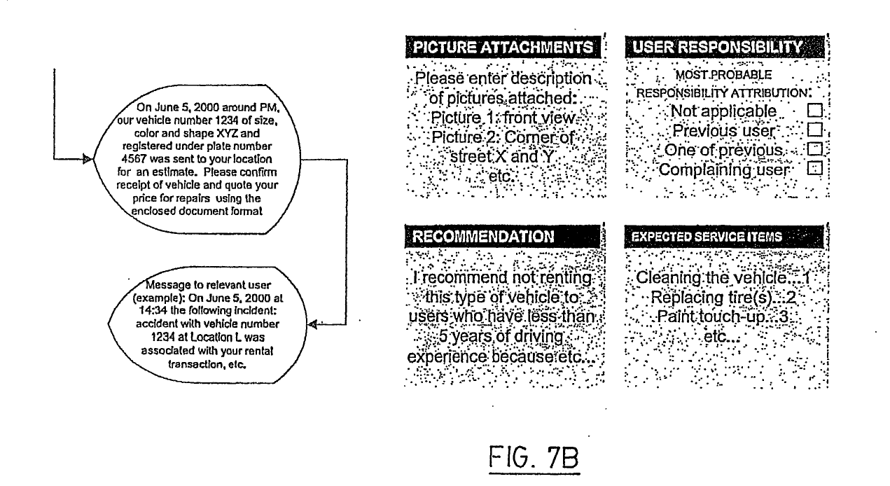

As soon as a complaint is filed, it is provided for the CRMLS to automatically generate a message or a service request to the field department of the rental vehicle operator or a third-party service organization. Such message includes the precise location of the vehicle and complaint code as well as other relevant information (FIG. 7A). The message is either sent to the nearest geographical service center (e.g. an affiliated repair center) or, as will be seen further, it can be sent to the nearest service vehicle in the area using AVL equipped service vehicles. The service personnel can then inspect the affected vehicle, prepare a field report and take the necessary actions to resolve the issue. To ensure that said field reports are efficiently handled at later stages, it is provided for the field technicians to electronically record pictures, comments and codify the incident (FIG. 7B).

The field reports are then filed electronically through a standardized Internet dialogue between the field staff and the CRMLS. As will be seen further, the field reports can then be automatically reused and transmitted for other purposes.

6.7.46 Sorting Incident by Code

As can be seen in FIGS. 7A, 7B and 14C, the codification of complaints and field reports enables complex information to be processed automatically to the relevant department within a rental vehicle provider's organization and for human interventions to be targeted where they are most valuable. For instance, it is provided for the system to sort incidents between various categories such as:

Purely mechanical and technical issues such as an engine malfunction

Complex issues that require human judgement such as a road accident

Trivial issues that do not justify a contact with users (e.g. untidiness)

6.7.47 Compensating Users for Degraded Service Conditions

In the case where a user has been forced to use or return a sub-standard vehicle and after the related complaint has been verified by the field personnel, the system can automatically issue a credit in favor of the affected user if applicable and based on the incident code (FIG. 17B).

6.7.48 Discouraging Delinquency through Messaging and Probability Analysis

As there is no inspection of returned vehicles, unmanned rental systems can be subject to increased user negligence. However and as was seen in section 6.7.6, it is provided for users to take a limited responsibility and confirm the prior inspection of a rental vehicle upon initiating a transaction. Thus, users become de facto vehicle inspectors. Because such process is subject to mistakes or malicious complaints and as there can be no certain proof that a complaint should be linked to a specific user, it is provided for the system to only allocate a probable responsibility and to inform users of such incidents. Thus and as can be seen in FIGS. 7A, 7B and 17B when an incident is reported and the field technician confirms the strong presumption against a particular user (e.g. the previous user) or group of users (e.g. all users that have rented the vehicle since the last field technician inspection), a message is sent to the relevant user(s). The complaint is then associated to each relevant user in the User Register only to monitor the frequency of occurrence and show the trend for a given user. Such messaging serves as a deterrent insofar as it communicates the fact that although apparently unmanned, the automated rental system is still subject to regular human supervision by peer-users and staff.

As can be seen in FIG. 17B and if the incident is coded as serious or if a given user has been subject to more incidents than the system-manager allowed threshold based on a probability calculation, it is provided for a manual intervention to occur.

However, if the incident is coded as minor, it is provided for the system to automatically generate warning messages and to log the incident into the relevant user files. Additionally, users are informed of the fact that a complaint has been logged into their file and are provided with an opportunity to file an opposition to the complaint. In this manner, it is not possible to strictly enforce good user behavior on every single rental but when the complaints against a specific user are repeated, the probability becomes sufficiently high to justify a special investigation on the part of the vehicle provider. If desired, the behavior/volume rating can also be modified, a message sent and a charge levied as a result. It should be noted that in the case of user opposition to a complaint, there is no human reading of such response until the specific user is subject to an investigation but an automated acknowledgement is sent electronically.

6.7.49 Prolonging the Credit Card Reserve in Case of Incident

As can be seen in FIG. 17B and in the case of a reported incident, it is provided for the system to automatically maintain the reserve on the credit cards of all relevant users (e.g. past 5 users or users in the past 24 hours, see section 6.7.10). This is done as soon as the incident code is received by the CRMLS to minimize the risk of collection problems and provide the vehicle provider enough time to proceed to a field investigation. Upon a condemning inspection, the system automatically debits a responsible user's credit card to collect the insurance deductible franchise if this is allowed by the general rental agreement (section 6.1.7).

6.7.50 Notifying Insurers (FIG. 17B)

As the treatment of vehicle damages represents a substantial activity for vehicle rental providers, there is a substantial benefit to be gained in managing insurance claims more efficiently. Moreover, a damaged vehicle does not generate revenues until it is returned to the active fleet and any reduction in vehicle downtime produces substantial gains. Thus, once the fundamental facts surrounding an incident have been acquired from the field technician and the relevant user and coded with sufficient details, it is provided for the system to automatically inform the insurer of the precise incident circumstances and of the location of the vehicle for inspection.

6.7.51 Notifying Service Organizations and Keeping Track of Service Orders

As was explained previously, it is crucial for a damaged vehicle to return to the fleet as quickly as possible. In a preferred embodiment and as can be seen in FIG. 7B, the field technician (or contracted third-party) is empowered to take the necessary actions with a sub-standard or damaged vehicle and then transmits a coded account of such actions to the CRMLS. For instance, in the case where the vehicle has been sent to Repair Shop ABC using Towing Co. XYZ, the CRMLS will create a manifest of such actions for the subsequent incident management and accounting of vendor invoices.

The CRMLS then transmits a repair or purchase order or any other desired message to the relevant parties (e.g. Repair Shop ABC) reusing the field report information without additional data manipulation as can be seen in FIG. 17B.

6.7.52 Exceptional Circumstances and System Problems

In the case of exceptional circumstances such as a forgotten smart card access means or a wrong distance measurement reported by the user, the CSRC can remotely take over the OBU and manually command it to execute all the basic functions that should normally be automated (e.g. door unlock). Thus, it is provided for OBU to give precedence to any incoming CRMLS data transmission over most other OBU processes.

6.7.53 Reducing Operator Distraction as a Safety Precaution

There is evidence that an OBU's visual, tactile or voice interface can distract a rental vehicle operator and create a safety hazard. Thus, it is provided for the OBU system to monitor the vehicle speed throughout most processes and for its display to be automatically shut down or for the voice commands to be limited to simple operations when the vehicle is in motion (FIG. 14C).

6.7.54 Measuring the Traveled Distance without Cabling or Calibration

As indicated in section 6.2.2, the distance traveled by a vehicle can be directly measured from the vehicle instruments, especially when the data bus carrying such information is accessible by universal means and provides a standardized signal that can be read without the need for costly calibration. However, in the present state of car manufacturing technology, such common standards are not the norm and there are no signs that this standardization will occur in a near future with other vehicles such as boats, trucks or airplanes. Thus, another method is used to obtain the distance measurement quickly and with a reasonable accuracy when cabling. As can be seen in FIG. 15A, the OBU constantly receives a data stream from the GPS antenna and receiver. By frequently sampling such GPS coordinates (e.g. 3 times per second) and processing it further, the OBU is able to determine with good accuracy the distance traveled by the vehicle. To further guarantee the integrity of the positioning data, it is also provided for the OBU to frequently reference (dead reckon) sampled GPS coordinates against another measuring system such as a digital road map featuring actual distances.

6.7.55 Returning Vehicles

As can be seen in FIG. 15A, it is provided for the system to constantly compare its position to the rental locations' geographical coordinates in its memory.

As can be seen in FIG. 15A and as soon as the OBU detects that the vehicle is idle within a rental location perimeter, it prompts the user to confirm whether or not the vehicle is being returned (as opposed to being temporarily parked at the location for later use). Upon confirmation, the OBU transmits the rental transaction data to the CRMLS for further treatment and billing.

6.7.56 Locking Doors Automatically

As users can forget to confirm the end of a rental transaction or to lock the doors of a rental vehicle, it is provided for the OBU to initiate a time countdown when it detects that the vehicle has entered a rental location (FIG. 14B). On failure to respond after the countdown has elapsed, the OBU automatically orders the doors locked.

6.8 Involving Users in the Redistribution of Vehicles

As was seen before, planning and optimizing the distribution of vehicles within a rental system is a complex and dynamic process, especially when spontaneous one-way rentals are allowed. In section 6.6.3, several methods to modify the demand curve for rental vehicles were proposed to prevent or reduce vehicle imbalances between locations. The concept behind such demand-side measures is to redistribute users to match a given vehicle distribution without incurring the cost of physically relocating vehicles. However, demand-side measures only provide part of the solution and it is normally required to physically redistribute vehicles to match the user distribution and through the use of offer-side measures.

Traditionally, vehicle operators either pay employees to move vehicles between stations or simply refuse reservations or spontaneous rentals when a location is sold out, even if other locations have a surplus.

However, such methods greatly impact fleet costs, user satisfaction and parking space management. Moreover, in the case where several hundred vehicles are rented on an hourly basis and allowed for one-way trips between dozens of locations in a city, the cost of not optimizing the fleet or of balancing it through employees becomes prohibitive and parking issues can become unmanageable.

Thus and according to the present invention, most of the responsibility to move vehicles between locations is passed on to users as a result of system-prompted measures. If all demand-side and offer-side measures are still insufficient, only then does the system turn to field technicians to execute vehicle movements.

In a preferred embodiment, the CRMLS constantly compares the most probable demand curve against the most probable offer curve for a system-manager defined set of vehicles, locations and time range (see FIG. 16A for an example).

As can be seen in FIGS. 12B and 16B, as soon as the CRMLS detects an imbalance in the making, it progressively adopts one or several of the following corrective measures to reduce the gap between offer and demand:

a) Launch demand-side measures (already seen in 6.6.3)

b) Restrict one-way rentals out of the affected locations (6.8.1)

c) Offer incentives for users to move vehicles on behalf of the provider (6.8.2)

d) Order field technicians to move vehicles (6.8.3)

It should be noted that the order of the above-listed measures can be changed and that the measurement of the total demand curve refers to all the demand components as can be seen in FIG. 16C. This would include for instance the anticipated spontaneous rentals at the out-of-balance location based on historical trends. Thus, an anticipated shortage of vehicles is not necessarily certain to materialize and the system takes into account the severity of the shortage in the adoption of the following countermeasures.

6.8.1 Restrict One-way Rentals out of the Affected Locations

As can be seen in FIG. 16B, when the CRMLS detects that the risk for a forecasted imbalance to materialize is greater than a system-manager defined threshold (e.g. risk factor 1), it then ceases to accept spontaneous or reserved one-way rentals out of the affected location.

6.8.2 Offer Incentives for Users to Move Vehicles on behalf of the Provider

As can be seen in FIG. 16B, when the CRMLS detects that a particular station is facing possible shortages (e.g. risk factor 2), it automatically sends an incentive offer to selected vehicles travelling within or in the direction of the location group (30). The selection of vehicles is made on the basis of various logical criteria and group broadcasts, for instance the offer is initially sent to vehicles for which the programmed drop-off location is within a certain radius of the rental station affected by the shortage. Such gradual and narrowly targeted transmission method is intended at reducing telecommunications costs and unnecessary disturbance of users engaged in a rental transaction. Relocation incentives are also published on the Internet site of the provider for other “shopping users” to see even when they are not engaged in a rental transaction.

Users who respond to such offer receive a confirmation from the CRMLS that their reservation has been updated to reflect the new drop-off location. The monetary incentive is then deducted from their invoice in progress. It should also be noted that such offers do not require a response from uninterested users and are not sent to users who have chosen not to receive said offers in their profile (e.g. upon registration FIG. 8A). To avoid an “over-correction” of the shortage that would create a new imbalance somewhere else in the location group and generate unnecessary incentive payments, the CRMLS only accepts the amount of favorable responses that it needs from users on a first in, first accepted basis.

Beyond such amount, users who have responded favorably to the incentive offer are sent a message informing them that enough relocations are already in progress and that there routing need not be changed (FIG. 16B).

It should be noted that the above-described user-incentive approach is particularly applicable where rental stations are connected between each other by alternative transportation means, e.g. public transit. The underlying theory being that the lesser the inconvenience to users, the more inclined they will be to trade the time lost in the fleet relocation process for incentive payments.

It should also be noted that relocation offers are reissued when a vehicle is rented again. In fact, the OBU always verifies if relocation incentives are available as part of the normal CRMLS query when initiating a new rental transaction.

6.8.3 Order Field Technicians to Move Vehicles

It has been said previously that when demand-side and offer-side measures have been insufficient to correct a problem, that the vehicle movements are then conducted by employees as in the prior art. However, it should be noted that even in the case of employee-conducted movements, it is provided for the CRMLS to dispatch its fleet balancing instructions automatically and much faster and more reliably than what is known today. As can be seen in FIG. 16B, as soon as a vehicle imbalance exceeds the system-manager defined tolerance threshold, a request is sent to the relevant field technicians with no human intervention.

6.8.4 Billing Users who Drop-off Vehicles at the Wrong Location

The failure for a user to bring the vehicle back to the chosen drop-off location can trigger a chain reaction in the system and impact several users. Thus and as can be seen in FIGS. 13A and 16B, the return of a vehicle at a location different then the programmed one is a coded event which generates a notification of the delinquent user and, optionally, a surcharge to the account or credit card.

6.8.5 Returning Foreign Vehicles and Managing Split Revenue

There is a well-known vehicle inventory category within the vehicle rental industry that is often referred to as “foreign vehicles”. This category represents vehicles that have entered the vehicle fleet of Service Provider A but in fact belong to Service Provider B. The main reason for such “foreign vehicles” to enter the fleet of another operator is related to one-way rental movements. Quite typically said one-way movements occur on inter-city traffic between different service providers trading under the same national franchise banner. It is also customary for said foreign vehicles to be rented in turn by the host operator (e.g. Service provider A) and for a compensation to be paid to the legal vehicle owner (e.g. Service Provider B). This compensation is often referred to as split revenue.

Some real limitations arise from the above-described practices and are well exemplified by the high price that is currently charged for one-way car rentals in most parts of the world. For example:

A significant administrative and transactional workload is generated to administer split revenue schemes, especially when providers use different information systems or do not belong to the same national franchise.

One-way rentals between unaffiliated entities require piecemeal negotiations between parties and are uncommon, thus preventing small or medium-size operators from easily forming a national network with their peers.

Returning foreign vehicles back to their origin generally requires employees to perform a manual vehicle allocation after receiving a system notification.

Vehicle owners may wait for a long period of time for their vehicles to be returned from a foreign location and have little control over the timing of such returns unless they incur the cost of moving the wanted vehicles themselves.

Different vehicle providers have different maintenance procedures and it is difficult to keep track of damages, maintenance and transactions conducted by others on behalf of the owner in a fair, accurate and defensible manner.

In order to overcome such limitations, it is provided for the system to:

Automatically administer and distribute split revenues (6.8.6).

Facilitate the free flow of vehicles between unaffiliated locations (6.8.7).

Automatically allocate foreign vehicles for return to origin (6.8.8).

Automatically promote one-way rentals between locations (6.8.9).

Promote one-way rentals to locations where vehicles are sold (6.8.10)

Enable automated Dutch auctions (6.8.11)

Enable automated foreign vehicle recall or expulsion (6.8.12).

However, it should be noted that for some of the above-mentioned functions to be enabled between unaffiliated providers and locations, it is preferable for a third party to operate the CRMLS and act as an access gateway and clearinghouse between each said providers. As the formation and operation of a CRMLS is a substantial undertaking, it is expected that such third party providers will become common as the invention is deployed.

6.8.6 Automatically Administering and Distributing Split Revenues

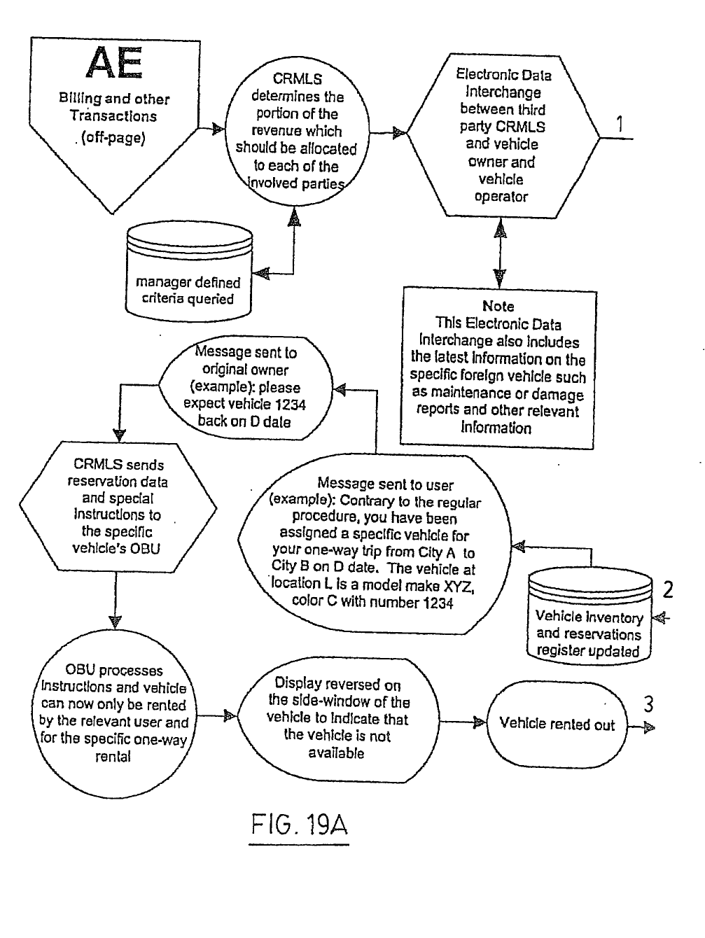

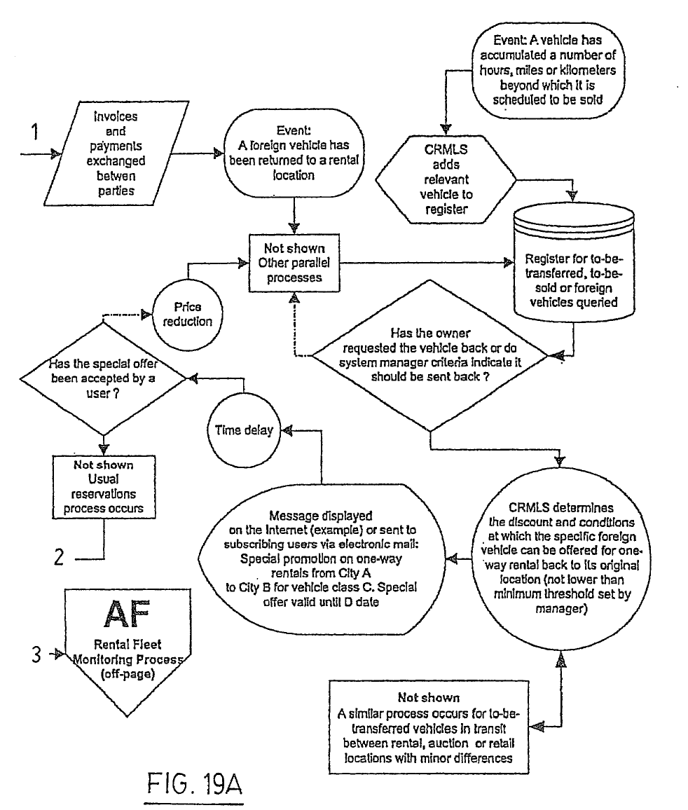

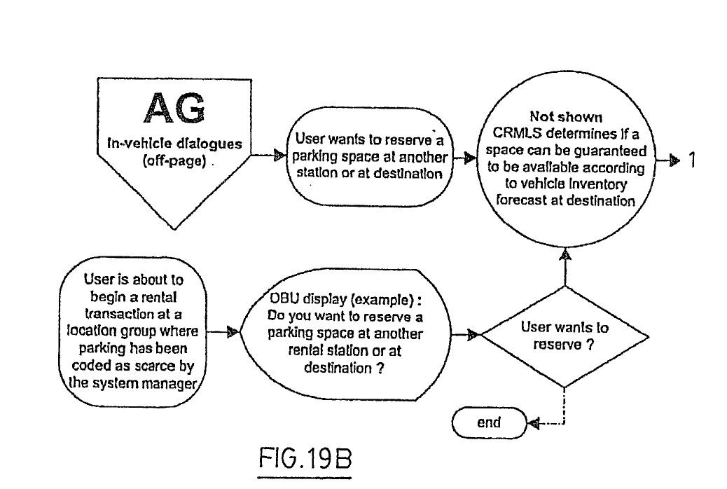

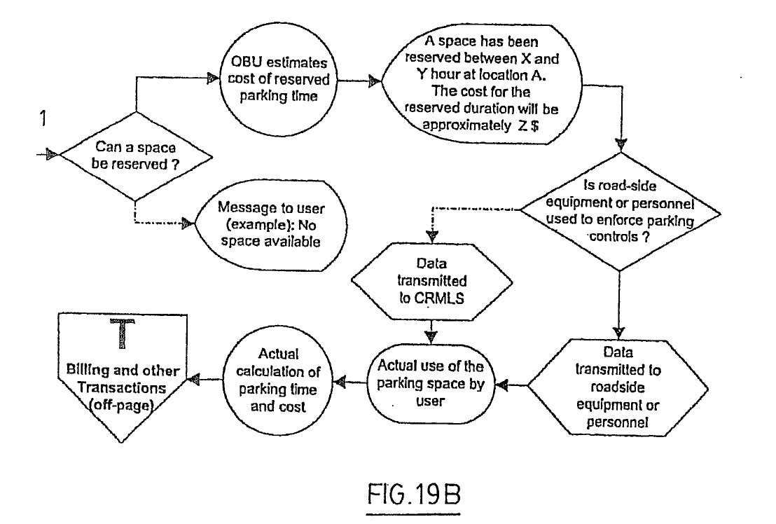

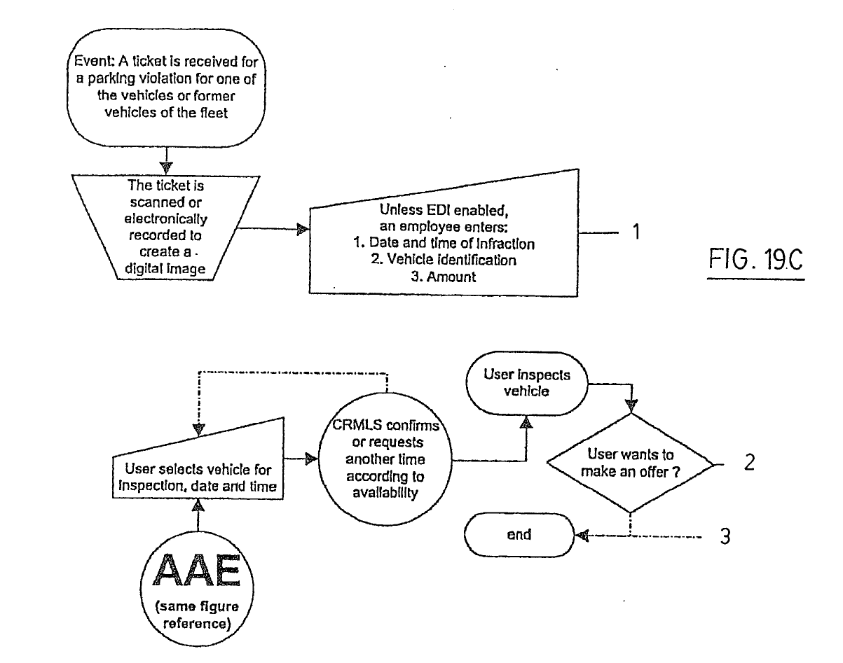

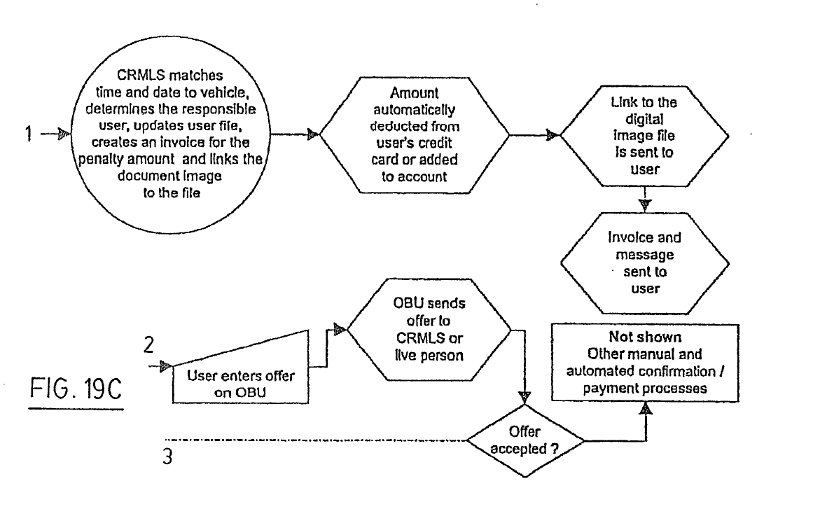

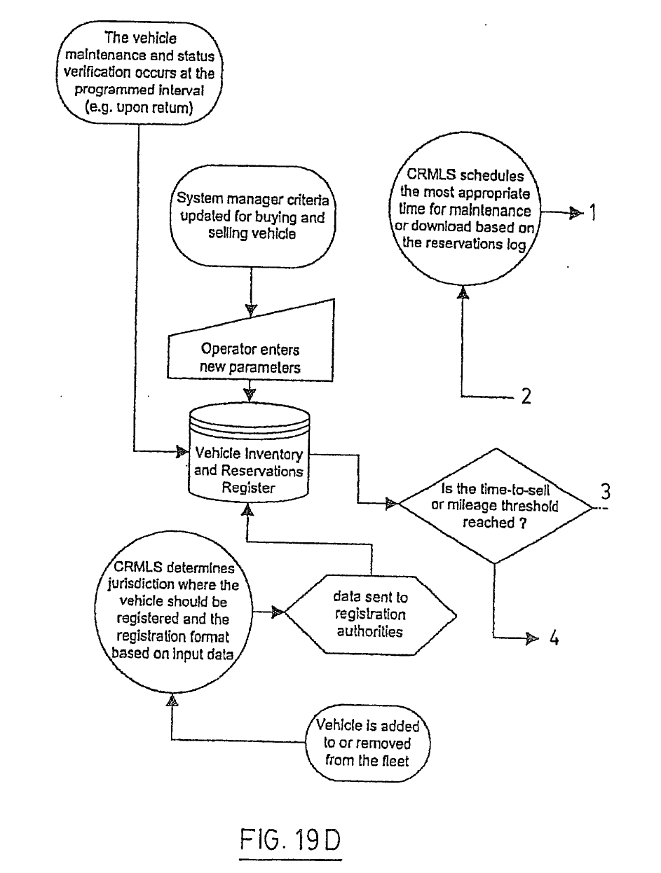

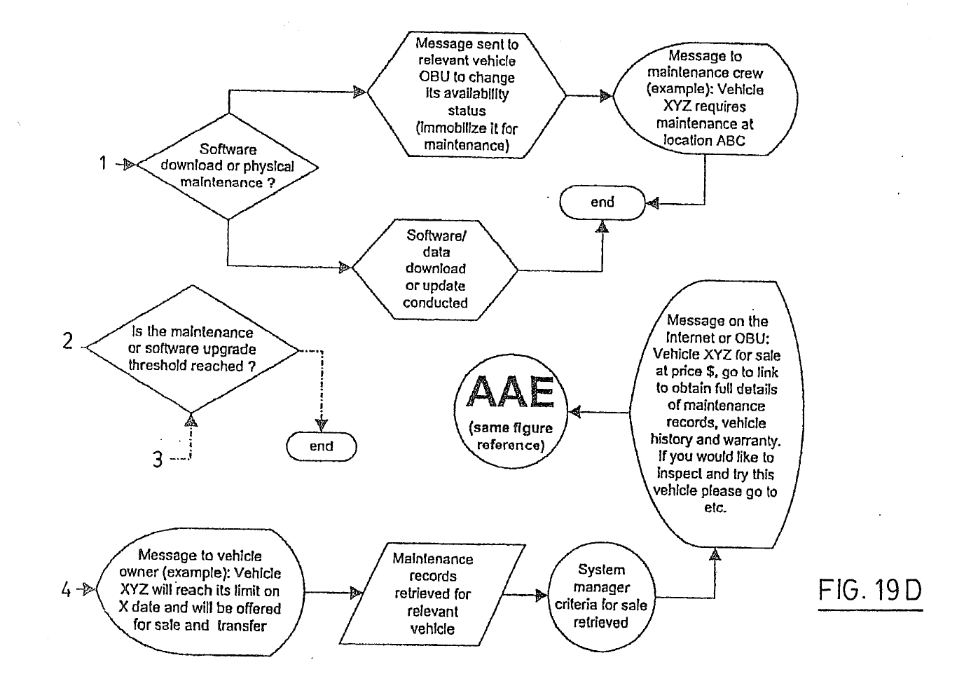

As can be seen in FIG. 13E, it is provided for the CRMLS to verify the ownership of a vehicle upon closing a rental transaction. As can be seen in FIG. 19A, once the CRMLS has detected that a charge has been generated by a foreign vehicle, it automatically interchanges relevant electronic invoices and payments with the owner (EDI).

6.8.7 Facilitating the Free Flow of Vehicles between Unaffiliated Locations

As can be seen in FIG. 19A and in circumstances where a third party is operating the CRMLS, it is provided for the system to act as a neutral observer, an access gateway and a clearinghouse between vehicle rental providers. Thus, vehicles' OBUs and CRMLS automatically report the relevant information such as traveled distance, damages, complaints, maintenance entries, generated charges and other relevant information both to the acting operator and owner of the vehicle. Vehicle owners can then keep track of their fleet in real time, depend on a reliable audit trail without unnecessary labor or effort even when part of their fleet is mixed and dispersed in foreign locations.

6.8.8 Automatically Allocating Foreign Vehicles for Return to Origin

As can be seen in FIG. 19A, the system can direct a user towards a specific vehicle when it has detected an opportunity to return a foreign vehicle to its origin or to a location group that is close to its origin. It should be noted that this specific allocation of a rental vehicle goes against the allocation method of section 6.6.1 and is only applicable to one-way rentals with foreign vehicles.

6.8.9 Automatically Promoting One-way Rentals between Locations

It is known from the current vehicle rental industry that a significant category of users react to special promotions. Said users are often willing to modify their time of travel and destination in order to save money.

In order to take advantage of such factor it is provided for the CRMLS to automatically publish a list of vehicles that the provider is interested in moving from one location to another. These vehicles can either be foreign vehicles that need to be returned (FIG. 19A) or inventory surpluses that the provider wishes to transfer to another location group. Whenever the CRMLS recognizes a foreign vehicle or a to-be-transferred vehicle in a fleet, it automatically posts a customized promotion for a one-way rental with the specific vehicle and to a specific location or location group. Such promotions are priced automatically by the CRMLS in accordance with the system manager criteria.

6.8.10 One-way Rentals to Locations where Vehicles are Sold

A large proportion of rental vehicles end their duty cycle in specialized vehicle auctions or retail locations designed to sell a high volume of vehicles rapidly. Since such final movements to the auction or to the retail location often require a freight carrier to haul the vehicles at great cost, it is provided for the system to promote a final one-way rental when disposing of a vehicle.

Thus, the system manager is able to code the auction or retail location as a station within a location group and as can be seen in FIG. 19A, the system can automatically trigger the promotion of a one-way rental to the nearest auction or retail location when a vehicle has reached the end of its duty cycle.

6.8.11 Automated Dutch Auctions

Since inventories of available-for-rent vehicles are comparable to time-sensitive goods, there is an interest in correcting a fleet unbalance as quickly as possible and it may be preferable to relocate a vehicle at a financial loss rather than maintaining it in a location that has a surplus. Unlike common auctions where the price is pushed up from below, the auction method known as the “Dutch auction” starts with a high price set by the auctioneer, in this case the rental vehicle provider. The price then drops until a buyer accepts to rent the vehicle from the advertised location to the location where it is most needed. Thus, it is provided for the system to actively promote the rental of foreign or to-be-transferred vehicles by regularly reducing the fare until it finds a user willing to bring it where it is most needed. As can be seen in FIG. 19A, said fare reduction is executed by the CRMLS within system-manager defined monetary increments and time cycles until a minimum threshold is met. The fare reduction is automatically advertised on the Internet and/or sent electronically to users who have subscribed to this service.

An example where such automated auctioning may be used is found in inter-city travel where a one-way automobile rental could be competing with airline service. By instantly and automatically advertising one-way rentals (FIG. 19A) and by reducing the price at regular intervals, the rental vehicle provider improves his chances of quickly finding a user willing to rent a vehicle for a one-way trip to the desired destination.

6.8.12 Automated Foreign Vehicle Recall or Expulsion

There are circumstances where vehicle owners require their vehicles back from a foreign location. By logging into the CRMLS from their location and via the Internet (not shown), owners or host operators are able to activate the vehicle recall or expulsion function. According to the invention, each time a foreign vehicle is returned from a rental transaction the CRMLS verifies if the owner has recalled the vehicle or if the host operator has requested for the foreign vehicle to be expulsed from its fleet. In both cases and as can be seen in FIG. 19A, the system then triggers the Dutch auction to expedite its return if the function has been activated and in accordance with system manager criteria.

6.9 Automated Parking Assistance

6.9.1 Informing Users of Parking Conditions at Destination

In road applications, the availability of parking space is a critical element in inner-city vehicle usage, especially for users initiating a one-way rental.

As the CRMLS constantly projects the vehicle inventory through time at all stations (See FIG. 16A), it is able to determine if a parking space will be available at destination at a given time. Thus and upon initiating a rental transaction in relevant areas, the OBU can be programmed to ask the user (27A) if a parking space will be needed at another rental station or at destination. As can be seen in FIG. 19B, the user can also trigger such parking reservation process.

It should be noted that the display can show a specific location's parking availability at a given time or a location group could be displayed on a digital map for a user to select the nearest available space.

6.9.2 Remote Parking Control

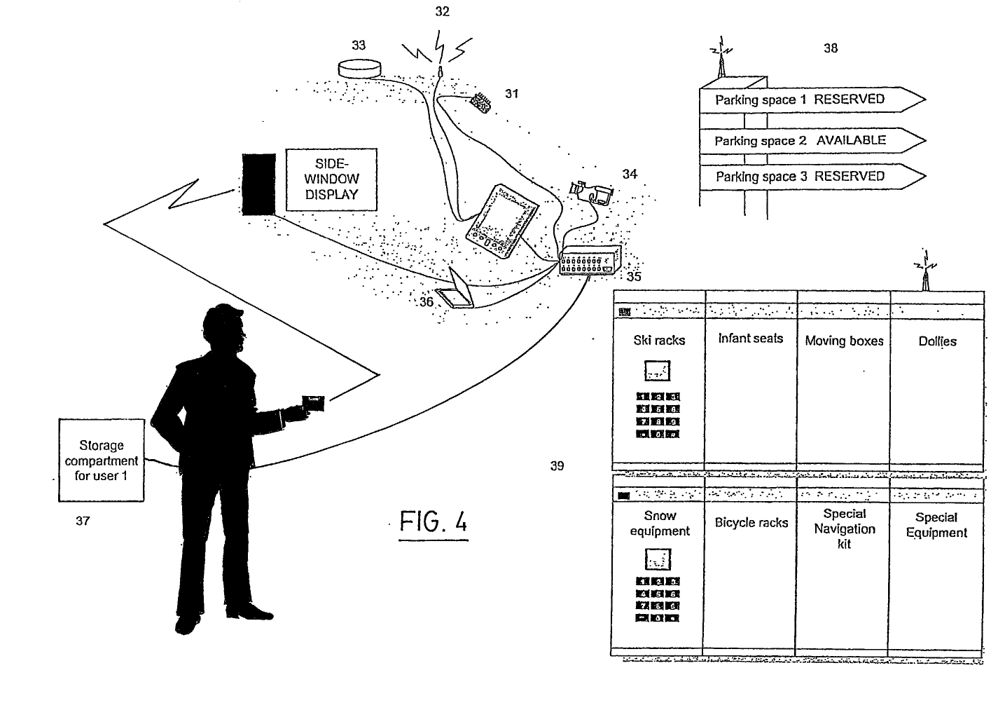

As can be seen in FIG. 19B and in the case where roadside equipment or parking enforcement staff are used, it is provided for the OBU to transmit the reservation request to the relevant station equipment or staff. If used, the roadside equipment can then automatically display the parking allocation pattern as can be seen in FIG. 4.

6.9.3 Obtaining a Fee for Parking Reservations

As can be seen in same FIGS. 19B and 13C, the process provides for the OBU to calculate a fee for parking reservations and actual parking usage time. Thus, it is possible for users to rent a vehicle, reserve a parking space before getting to a station and pay for said space without handling any coins or apparatus.

7.0 Other Processes

7.1 Fleet Management

7.1.1 Automatically Triggered Buy and Sell Decisions

Buying and selling vehicles at the right time and with the right usage is a critical success factor within the entire vehicle rental process. In fact, vehicles are often acquired or leased on some form or another of program and must be sold or returned within specific mileage and time parameters. As can be seen in FIG. 19D and in order to optimize the administration of such activities, it is provided for the CRMLS to check each vehicle against the system manager parameters at specific intervals (e.g. on return from a rental transaction). The CRMLS then checks whether a vehicle should be sold or not. In the affirmative, a message is automatically sent for the relevant parties to activate the sale of the vehicle and the one-way rental promotion to the retail location can be initiated as was seen in section 6.8.10.

7.1.2 Automatic Registration of Vehicles

As can be seen in same FIG. 19D, the CRMLS automatically registers new vehicles with the relevant entitlement authorities (e.g. Department of Motor Vehicles) where system compatibility and remote connections allow it.

7.1.3 Automatically Triggered Vehicle Maintenance

As can be seen in same FIG. 19D, the CRMLS automatically notifies the maintenance crew when a vehicle has reached a certain threshold of time or mileage to optimize and facilitate reliable maintenance. Along with the service request, the position of the vehicle is sent and the relevant vehicle becomes unavailable to users. In a preferred embodiment, the availability status is communicated to users through the side-window display (15) and reversed after the maintenance is completed.

7.1.4 Automated Promotion and Documentation

A substantial portion of rental vehicle providers' profits is typically made or lost on selling vehicles. At times, said providers will sell vehicles at reduced prices and in large auctions volumes while at other times they will seek to get the most value out of a vehicle by selling it at retail conditions. In the current art, the process is almost entirely conducted in a manual fashion and it is quite a task for rental vehicle providers to dispose of vehicles by themselves. According to the invention and as can be seen in FIGS. 19C and 19D, the system enables rental vehicle providers to offer their vehicles for retail sale prior to sending vehicles to the auction and in order to maximize the selling price. In a preferred embodiment, such offers are communicated to users mostly through the Internet or other similar diffusion mode including the OBUs. Users also have access to the full vehicle maintenance history as it is automatically made available by the CRMLS to prospective buyers.

7.1.5 Automated Inspection Scheduling of Vehicles on Sale

In a manner similar to the specific allocation of vehicles described in section 6.8.8 and contrary to the general allocation method described in section 6.6.1, buyers interested in testing and inspecting the vehicles offered for sale can reserve the use of a specific vehicle through simplified registration and reservation processes. Following such reservation, users can then inspect and test the vehicle by simply booking it online in a similar manner then they would to place a normal reservation as can be seen in FIG. 19C.

7.1.6 Making an Offer through the OBU or the Internet

Once a user is satisfied with a vehicle for sale and wants to acquire it, the OBU allows said user to make an offer immediately from the vehicle's OBU (16). As can be seen in FIG. 19C, the offer is then transmitted to the CRMLS for manual or automated treatment.

Upon manual or automated acceptance of the offer, other processes such as automated credit card billing for the deposit and manual/verbal confirmations then take place.

7.2 Billing and other Transactions

7.2.1 Dealing with Fines

Upon agreeing to the rules of the general rental agreement, users typically accept responsibility for fines that result from parking or other traffic-related charges. However, in practice, it is often cost ineffective or difficult to properly enforce said rules and administer the related claims. According to the invention, it is provided for said administration to be greatly simplified and expedited through automation. As can be seen in FIG. 19C, it is only required for an operator to enter the date, time and vehicle license plate related to an infraction ticket and the user's credit card is then automatically debited and the registers updated.

7.2.2 Paying Commissions to Agents

It is frequent for vehicle rentals to be booked through travel agents or other similar intermediaries. As can be seen in FIG. 13E, the system automatically recognizes a commission to the relevant agents when applicable. Furthermore, it automatically prepares the credit memo for the payment of said commissions to enable batch processing of a large volume of small transactions.

7.2.3 Paying Commissions to Landholders

One of the benefits of the invention is to allow rental vehicles to be easily deployed on any property that is within cellular radio coverage. The value of such land can be recognized through commission payments to the landholder in a similar manner to section 7.2.2. As can be seen in same FIG. 13E, the CRMLS always verifies if a commission should be paid to a landholder upon completing the billing process. In the affirmative, it automatically issues a commission credit memo to the landholder for batch processing.

7.2.4 Automated Processing of Insurance Replacement Transactions

One of the largest rental vehicle markets is often referred to as the insurance replacement market. This market is essentially composed of policy holders who have sustained damages to their own vehicles, rental vehicle providers and insurers who accept to pay for replacement vehicles during a given period of time and within certain guidelines. Considering the high transactional cost of processing insurance claims and the benefit for insurers to direct the policy holder towards an approved rental vehicle supplier, there is a benefit in making the entire process as easy as possible from the initial authorization to the payment of the replacement costs.

Since policyholders (system users) can rent vehicles only when they need them and from small and widely dispersed locations, the present invention provides insurers with additional cost saving opportunities and better suited vehicle replacement options for their policyholders. Thus and as can be seen in FIG. 8B, it is provided for the CRMLS to establish an automated link with insurers' databases before turning a policy holder into a system user. Depending on its preference, an insurer can then issue an authorization number for the CRMLS to verify against the insurer's parameters if a policy holder has indeed the permission to rent a vehicle on said insurer's account. Alternatively, insurers may simply grant access to their database for the CRMLS to check the policy number against a certain policy holder profile. As can be seen in FIG. 13E, the CRMLS can automatically bill insurers for pre-approved rentals upon completion of a transaction or a series of transactions and send the resulting invoices through EDI.

7.2.5 Automated Invoice Distribution

As can be seen in same FIG. 13E, the system automatically distributes invoices and statements through EDI, fax, email or other comparable electronic means. In so doing, the system greatly reduces the amount of human and material resources required to complete the billing process.

7.3 Special Storage Functions

7.3.1 In-vehicle Storage Compartment

In some applications, it is believed that the present invention may be used advantageously in carsharing, shared-leasing or shared-ownership applications. As an example of said shared-usage applications, one can imagine a situation where a given user has the responsibility of a vehicle in his/her morning and evening commute and during weekends while other users, work colleagues for instance, may use the vehicle during the day. Another example may be provided by a group of 5 users living in the same building and sharing the same specific vehicle for a prolonged period of time.

In these types of applications, users may find it cumbersome to always carry certain personal effects in and out of vehicles especially since they always use the same assigned vehicle. As a remedy to this inconvenience, the present invention provides for one or several special locking compartment(s) (37) to be installed within vehicles and to be connected to the OBU. Upon recognizing a given user through the authentication process, the OBU then unlocks the reserved compartment for the appropriate user, allowing him/her to store personal effects in the vehicle in a private and secure manner.

7.3.2 Automated Compartments Unit (ACU) for on Site Storage (39)

It is common for rental vehicle providers to offer ancillary services and equipment such as infant seats, ski and bicycle racks, furniture dollies, boxes and so on. Normally, such special equipment is not stored in vehicles permanently and needs to be handled on a case by case basis.

In the case of an unmanned system open 24 hours a day, there is a need to find alternative methods to reduce costs and maintain the service. According to the present invention, it is provided that some rental locations will be supplied with locked compartments on the rental premises and for said compartments to be accessible automatically. Using the same access means required to enter a vehicle (6.1.2), users are then able to obtain the required equipment directly from the premises and without human intervention (FIG. 18D). In an alternative method, users may request special equipment from the vehicle's OBU and the OBU then contacts the ACU through the CRMLS.

7.3.3 Reminding Users of the Presence of Special Equipment

Since users who retrieve special equipment such as infant seats may forget to bring them back, it is provided for the system to remind users of the presence of special equipment when they return a vehicle. As can be seen in FIG. 18D, once a user has retrieved an equipment from an ACU, said ACU (39) communicates with the CRMLS to associate the equipment rental to the vehicle rental as well as to trigger other monitoring and billing functions. The CRMLS in turn communicates with the rented vehicle to notify its OBU that there is an open ACU record on file. Once the user completes the related vehicle rental transaction, the OBU automatically reminds said user to bring back the equipment to the automated compartment (27).

7.3.4 Automatically Billing Users for the Use of Special Equipment

As can be seen in FIGS. 13C and 18D, as soon as an ACU compartment is activated by a user and the equipment return process is completed, the ACU communicates with the CRMLS and triggers the automated billing of the service.

7.4 System Upgrades, Software Downloads and Manual Verifications

7.4.1 Information Downloads

As can be seen in FIG. 14C, users may request services from the OBU such as downloading a map, obtaining weather forecasts or find hotel locations. Upon receiving such requests, it is provided for the OBU to contact the CRMLS and download the necessary data over wireless networks.

7.4.2 Software Upgrades

As can be seen in FIG. 19D, the CRMLS verifies if a specific vehicle's OBU need to be updated with more recent software or data at specific intervals (for instance, a new digital map or communication protocol could be added to the OBU). If the answer is yes, it automatically sends a message to the relevant maintenance crew or it triggers a wireless download (not shown).

7.4.3 CRMLS Precedence Over the OBU

In some circumstances, it is possible that the OBU may not be able to perform some of its programmed tasks for various reasons (e.g. electronic antenna unable to read a user's card). In order to resolve such situations expeditiously, it is provided for the CRMLS to have precedence over the OBU in all communications in order to reset it or command it to perform a task.

7.4.4 Manual Confirmation of the OBU Information

In order to prevent the OBU from becoming out of true, it is provided for the maintenance crew to enter a master code on the OBU and to confirm the odometer and fuel gauge reading in rental vehicles upon regular maintenance or washing of vehicles. In this manner, the CRMLS and the system manager can have recorded confirmations of the vehicles' reading and have a defensible reference in case of dispute or erroneous billing for instance.

8.0 Manual Processes and Reduced Automation Options

In the previously described embodiments, there are a number of applications and circumstances where the automated processes would be advantageously supported by personal interactions between people, especially in the case of dealings with users that are not familiar with technology.

Throughout the description of the preferred embodiments and in the accompanying drawings, it should be understood that most of the described processes can be replaced, supported or complemented by manual or person-to-person interactions. In the case of smart cards deliverance for instance, they obviously have to be physically manipulated in order to be mailed to users or made available for retrieval at physical retail counters.

Obviously, the use of any automated function previously described is entirely optional and the invention provides for the system to operate without it if such functionality is not required. This is especially the case when incentive mechanisms or monitoring functions are used in circumstances and applications that may raise unacceptable ethical issues.

9.0 Other Information

The previous description, of preferred embodiments relates to the main functions of the system taken in its entirety. It should be understood that most modules or functions previously described are not essential to the functioning of the system and that there are as many embodiments as there are combinations of said modules and functions.

Although the system is designed for complex vehicle rental applications, some of its functions can also be used in much simpler fleet management applications.

1. An automated vehicle rental system for a fleet of rental vehicles, said vehicles being geographically distributed, each of said vehicles being normally locked when not rented, at least one of said vehicles, when not in use, being parked in an unguarded location; said system comprising:
vehicle communications means for enabling communication to and from the vehicle, user-carried electronic devices, or other readers, and for interfacing with said user;
an on-board unit (OBU) located on each of said vehicles for interfacing with said vehicle communications means, and with a door unlocking mechanism; a central reservations, management and location system (CRMLS) in communication through a communications network with each of said OBU, said CRMLS performing all reservations and management functions, said CRMLS being linked to a database containing a location and availability of each of said vehicles and a rate for rental, said CRMLS also being provided with an allocation manager system for geographically allocating vehicles; and
a key for accessing said vehicle, said key being borne by said user.

2. A system according to claim 1, wherein said key is an electronic microchip equipped card, a smart card, a mobile phone, an internet-enabled phone, a personal digital assistant, a password, a biometric indicia, or a combination thereof.

3. A system according to claim 1, wherein said key is a password or a biometric indicia, and said password or biometric indicia is inputted into an appropriate reader which is operatively connected to said OBU.

4. A system according to claim 1, wherein said CRMLS is provided with an interface for interfacing with a credit-verifying agency.

5. A system according to claim 1, wherein said vehicle communications and positioning means include an in-vehicle data and voice communication system; an RF modem; an infrared device; a keyboard and display; a smart card reader; a transponder; a dedicated short range communication device; an antenna and GPS receiver; or a combination thereof.

6. A system according to claim 1, wherein said OBU includes an anti-theft device; a control device to activate the engine starter; an alarm system; a back-up power supply; a camera for scanning a face of a user; a scanner; a speech recognition module; a voice synthesizer module; a printer; movement detectors; or a combination thereof.

7. A system according to claim 1, wherein said CRMLS is operatively linked with a credit verification service provider; with authorities responsible for issuing and controlling entitlement means; with providers of insurance records; with providers of content to mobile customers; with referring organizations; with a global distribution system; or a combination thereof.

8. A system according to claim 7, wherein said referring organizations include insurance organizations, vehicle repair organizations, fee-for-service providers in the travel industry and fuel stations.

9. A system according to claim 1, wherein said CRMLS communicates directly with said OBU.

10. A system according to claim 1, wherein said CRMLS communicates with said OBU through a local base station system which is installed within radio frequency range of a rental location,

11. A system according to claim 1, wherein said CRMLS includes a database of all registered users including information related to said user.

12. A system according to claim 11, wherein said information related to said user includes a behaviour/volume profile, and wherein a rate for rental charged to said user is based on said behaviour/volume profile.

13. A system according to claim 12, wherein said behaviour/volume profile is based upon punctuality; vehicles returned in damaged or untidy conditions; vehicles returned in a location other than that originally booked; unreported traffic violations; failure to crystallize a reservation or to cancel an active reservation; using the vehicle outside an authorized area; or a combination thereof.

14. A system according to claim 1, wherein said CRMLS further includes an interface for permitting a user to reserve a vehicle.

15. A system according to claim 14, wherein said interface includes an interactive voice response system; a touch tone system; a web page; or a combination thereof.

16. A system according to claim 1, wherein each of said vehicles further include a display that is visible from the outside of the vehicle, said display being operatively connected to said vehicle communications and positioning system, said display displaying information related to rental conditions, available services, maximum rental period allowed, one-way trip availability, equipment on board, or a combination thereof.

17. A system according to claim 16, wherein said information that is displayed is displayed in conjunction with pictograms.

18. A system according to claim 1, wherein said allocation manager system geographically allocates vehicles dynamically in response to user demand, punctuality of returns, returns at the predetermined location, as well as providing incentives to users to distribute vehicles on behalf of a system operator.

19. A system according to claim 1, wherein upon a reservation being performed by a user, information related to said reservation is transmitted to the OBU of the reserved vehicle.

20. A system according to claim 1, wherein at least one of said OBU is connected to at an internal bus of a vehicle of said fleet of vehicles in order to mine information related to an odometer and a fuel gauge.

21. A system according to claim 1, wherein said system authenticates a user prior to releasing a vehicle by requiring entry of a password; answers to personal questions; a biometric sample; or a combination thereof.

22. A system according to claim 1, wherein said reservation information includes a geographic perimeter within which a vehicle is usable, and wherein said OBU monitors a position of said vehicle while in use, and takes corrective action if said vehicle is used outside said geographic perimeter.

23. A system according to claim 1, wherein said OBU monitors a speed of said vehicle, and wherein said OBU takes corrective action is said speed of said vehicle exceeds a speed limit, or decreases brutally, signifying an accident.

24. A system according to claim 1, wherein said system further includes a complaint management module for receiving user's complaint and for providing a reaction to a dangerous or unsatisfactory situation; compensating a user for degraded service conditions; discouraging delinquent behaviour through peer-conducted verifications; guiding and structuring field personnel's maintenance interventions; or a combination thereof.

25. A system according to claim 1, wherein said CRMLS is adapted to project based on vehicle inventory whether a parking space will be available at the end of a rental; and wherein said OBU is adapted to prompt a user for the desirability of a parking space at destination.

26. A system according to claim 25, wherein said system further includes a module for making a parking reservation at destination.

27. A system according to claim 1, wherein at least one of said vehicles is further provided with at least one locked in-vehicle storage compartment, said compartment being operatively connected to said at least one vehicle's OBU, so that when an authorized user of said at least one locked in-vehicle storage compartment takes possession of said at least one vehicle, said at least one storage compartment is unlocked.

28. A system according to claim 1, wherein said system includes at least one rental location, and wherein an automated compartment unit is located at said at least one location, said automated compartment unit storing ancillary equipment for use by a user.

29. A system according to claim 1, wherein a rate of rental is based on an insurance profile of said user.

30. A system according to claim 1, wherein said OBU is provided with a fuel consumption calculator for calculating a fuel level in a fuel tank, and wherein said user is provided with an incentive to refuel said vehicle when a fuel level of said tank falls below a predetermined level.

31. A system according to claim 1, wherein at least one foreign vehicle belonging to another operator is introduced into said system, and wherein said system is adapted to administer and distribute split revenues; facilitate the flow of foreign vehicles; allocate foreign vehicles for return to origin; promote one-way rentals between locations; promote one-way rentals to locations where vehicles are sold; enable Dutch auction; enable automated foreign vehicle recall or expulsion; or a combination thereof.

32. A system according to claim 1, wherein said system monitors in real-time a user's compliance with a target return time.

33. A system according to claim 1, wherein said system is adapted to permit a user to request an extension of time; and wherein said CRMLS is updated with said request.

34. A system according to claim 1, wherein said OBU further includes a vehicle activity log.

35. A system according to claim 34, wherein said vehicle activity log includes maintenance information; incident information; location information, including an identification of the user, the user's behaviour/volume profile, duration and frequency of rental; or a combination thereof.

36. A system according to claim 1, wherein said CRMLS is adapted to monitor occurrences of payment of commissions to landholders.

37. A system according to claim 1, wherein said CRMLS is adapted to perform random allocation of vehicles.

38. A system according to claim 1, wherein said vehicle communications means further includes vehicle positioning means, for obtaining or deducing a position of said vehicle.
